(19) United States
(12) Patent Application Publication
(10) Pub. No.: US 2012/0109686 A1
(43) Pub. Date: May 3, 2012

(54) ELECTRONIC MEDICAL RECORD SYSTEM AND METHOD

(75) Inventors: Colin Higbie, Middletown, VA (US); Neil Graham Corbett, Ashburn, VA (US); Shawn Scott Moyer, Dover, PA (US); Mattew Abner Hahn, Berkely Springs, WV (US); Nicholas Spagnola, York, PA (US)

(73) Assignee: Oxbow Intellectual Property, LLC, Laramie, WY (US)

(21) Appl. No.: 12/916,752

(22) Filed: Nov. 1, 2010

(51) Int. Cl. G06Q 50/00; G06Q 10/00

(52) U.S. Cl. 705/3

(57) ABSTRACT

An electronic medical record system and method that enables easy entry and use of patient and other information. The system and method provides improvements in terms of features, speed, and ease of use. It includes the following steps: inputting patient information into an EMR system utilizing customizable templates; cross-referencing the information input with information databases, e.g., publicly available demographic-based information on the standards of care; and generating information from cross-referencing to provide user with recommendations for the patient (e.g., prescribe medication, order procedures, give immunization), if such a recommendation exists in the standards of care or is added by the user. The system and method utilize a computer. The present invention can be used to help practitioners avoid mistakes (e.g., forgetting standards of care), deliver a higher quality of care, measure performance, and proactively identify and contact patients who need a particular type of care.

### FIELD OF INVENTION

The present invention relates to entry and use of patient electronic medical records (EMR) or electronic health records (EHR). Referred to herein as a system, EMR system, EMR program or electronic medical record system and method (EMRSAM).

### BACKGROUND OF THE INVENTION

Prior to the present invention, EMR systems were slow to be able to enter information when speaking with a patient, decreasing available time for practitioners to spend with patients and thereby harming the quality of care, or requiring additional time spent entering data and reducing the quality of life for the practitioner. There was no way for users to create their own queries for patients based on conditions (a search). Multiple complaints, referred to in the field as an “oh by the way”, could not be handled efficiently. Other EMR systems were rigid. Templates could not be altered. These EMR systems did little to nothing to improve the quality of medical care. The present invention has the capability to include patient-specific quality reminders to walk the user/doctor through or present to the user/doctor all the standards of care for each patient. It is believed that forgetting to follow the standards of care is the number one malpractice complaint against family physicians. Prior EMR systems did not support proactive care very well, with little to nothing to prevent patient problems from failure to follow-up. Previous EMR systems do not provide information and reminders in real-time based on information available at that time.

The present invention can be used, for example, to help practitioners avoid mistakes (e.g., forgetting standards of care), deliver a higher quality of care, measure performance against others, and proactively identify which subset of patients need a particular type of care, e.g., a limited availability swine flu shot or to have a medication change because of a new drug-drug interaction.

### SUMMARY OF THE INVENTION

An electronic medical record system and method of the invention enables easy entry and use of patient and other information, e.g., general medical. The system and method include the following steps of inputting patient information into an EMR system utilizing either standard or customizable templates; cross-referencing the information input with databases of information, e.g., publicly available information on the standards of care for certain demographics; and generating information from cross-referencing to provide a user with an actionable recommendation (e.g., prescribe a medication, order a procedure, given an immunization), if such a recommendation exists in the standards of care or is added by the user. The system and method utilize a computer.

The present invention can be used, to help practitioners avoid mistakes (e.g., forgetting standards of care), deliver a higher quality of care, measure performance against others, and proactively identify which patients need a particular type of care, e.g., a flu shot.

### BRIEF DESCRIPTION OF THE DRAWINGS

The present invention will be more readily understandable from a consideration of the accompanying drawings/flow charts and computer screen images in which:

FIG. 1 depicts a hardware arrangement to enable the system to carry out the electronic medical record system and method of the invention;

FIG. 2 depicts the flow of program initiation to run program, or program start up;

FIG. 3 depicts the flow of Creating a New Patient Record;

FIG. 4 depicts the flow of Editing a Patient's Registration Information;

FIG. 5 depicts the flow of Searching for a Patient Record;

FIG. 6 depicts the flow of Patient Summary Screen;

FIG. 7 depicts a flow of Prescriptions: New Prescriptions;

FIGS. 8A and 8B depict a flow of Prescriptions: Editing or Deleting a Prescription;

FIG. 9 depicts a flow of ordering prescriptions by printing prescriptions, e-prescribing, or faxing in a prescription to the pharmacy;

FIG. 10 depicts a flow of refills;

FIGS. 11A and 11B depict a flow of ordering labs and/or procedures;

FIG. 12 depicts a flow of ordering consultations and/or referrals;

FIG. 13 depicts a flow of Outstanding Work Lists (OWLS);

FIGS. 14 A-WW are computer screen snapshot photos that depict and/or capture various stages of the EMR system and method in progress. See below for description of each of the FIGS. 14 A-WW; and

FIGS. 15A and 15B depict a “MY MEDICAL FACTS REPORT”.

### DETAILED DESCRIPTION OF THE INVENTION

A computer-based system and method is described for constructing present and past medical histories, as well as generating patient-specific reminders for meeting the standards of care, automatic reminders for medical procedures and other important medical issues, and/or manually or system-generated communications (e.g., messages, alarms). The medical histories are constructed using information obtained from a patient and/or other sources according to standard or customizable template forms and include record attachment availability. This computer-based system and method is designed for ease of operation to be used by doctors, other medical professionals and their respective staff, for example, it can be used in the field or in doctor's offices, as well as, any other facilities, including but not limited to hospitals and clinics.

Once created, the facts of the patient's medical history, including family history, social history, and immunizations (“patient information”) can be cross referenced by the invention with standard of care databases to generate a set of patient-specific reminders. These are quality reminders and are updated in real-time based on information specific to the patient, e.g., age, gender, diagnosis, etc. For example, if the patient is over 50 years old at the time of the visit and has not had a colonoscopy in over 10 years, the system will prompt the user to schedule a colonoscopy. For diabetics who meet other specific criteria and who are not already taking a statin, the system provides the user with a quality reminder to prescribe a statin.

Additionally, the patient information can be used to automatically generate real-time drug-drug interaction and drug-allergy alerts regarding the medication(s) the patient is taking or when medication(s) is being prescribed.

Further, the patient information and/or any information entered or generated from or in the system can be used to manually create outstanding work lists or “OWL” notes. These OWL notes serve as an internal communication, alert and reminder system. Where a lab or procedure is ordered, then the OWL can be a reminder to review the lab. The system also automatically generates OWLs for users based on outside events like drug refill requests, incoming labs, or to follow-up if a lab result has not arrived after the specified time has elapsed.

It is estimated that for family practice physicians every 1 minute saved per patient translates to potentially at least $18,000 worth of time per year (a typical family physician sees 24 or more patients per day with each patient taking about 20 minutes, 1 minute data entry time saved per patient translates to at least 1 more patient per day with no adverse impact to time interacting with each patient or hours worked, that translates to at least 5 additional patients per week and at least 240 additional patients per year, and at a typical minimal reimbursement value of $75 per patient, that's a minimum $18,000 saved per year). It is estimated that this invention saves approximately 2 hours per day per physician user with a value of over $100,000 per year compared with other EMR systems.

Several components of the present invention represent advances in the industry, many concern the speed and ease of use. These are essential differentiators for private practice physicians. If features such as those described as part of this invention require material effort to learn how to use or add time to any of the practitioner's tasks, or require additional support staff, they will not be widely used by private practice physicians.

The system and method described herein has significant power advantages which for our purposes are herein referred to as the “Pillars” as follows:
1. Quality reminders that are patient specific and in real time, so each new diagnosis will immediately trigger updates to the Quality Reminders for that patient. For example, if an adult patient is diagnosed with Type 2 diabetes, the system may immediately prompt the practitioner to prescribe a statin. If the patient is a male smoker, between 65 and 75 years old, the system will prompt the practitioner to perform abdominal aortic aneurism screening. The quality reminders cross reference information specific to the patient, e.g., age, gender, diagnosis, family history, and information pertinent to the standards of care to automatically generate patient-specific real-time reminders. So whatever information is current on the patient, then the reminder is current as well. Typical reminders include health maintenance items (tetanus vaccination, smoking cessation counseling) or standard-of-care items (cancer screening, prescriptions). As each reminder is executed, it is removed from the list. By clearing all items from the Quality Reminder list with each patient, the practitioner is assured of properly having followed all standards of care. As these standards change over time, the user or the service provider can easily update them.
2. Real time aggregate patient reporting can be used to automatically advise a practice on its performance in terms of quality of care, i.e., % patient population of particular trait and % which are properly treated according to the standards of care. By measuring quality of care in both absolute and relative (both over time and compared with other practices) terms, the practice can work to improve it. It can also be used to automate the process of reporting on standards of care and it is the only system that automates this process for doctors. Patient and database information are used to automatically or on request generate real-time aggregate patient reports about all or select groups of the patient population. The database compares like information from the pool of patients. Automation eliminates the need for additional admin or data entry staffing. The inventive automated data aggregation and analysis can operate as a system of quality improvement.
3. Real-time drug-drug interaction and allergy alerts can be included in the inventive system. Patient and database information is used to automatically generate real-time drug-drug interaction and allergy alerts. It happens while the physician is using the EMR system and method (EMRSAM) and it's automatic.
4. Dynamic encounter templates allow for complaints to be entered individually without having to switch templates from, e.g., a diabetes issue to something else. The user can just keep stacking complaints. The templates are dynamic so there is no hesitation when entering complaints. The templates can be viewed as stacking up the multiple complaints in boxes. Typically a patient has a chronic issue (diabetes) or comes in for an acute issue (migraine) and will ask about some other unrelated issue (“oh by the way”—unusually-shaped mole or a sore elbow). These templates permit a user to record information on various symptoms and complaints, whether related or unrelated and without slowing down the practitioner to move between different templates.
5. Easy query system allows a user to search practice data proactively to help patients. It allows the user to build powerful queries with no computer experience and find patients based on any criteria. For example, a limited number of doses of the H1N1 vaccines become available and in seconds the user can ask the system to identify all of the high-risk patients across age and those already diagnosed with weakened immune systems.
6. The template builder is easy for the practitioner to use directly, with no computer experience required. For example, with patient vitals, e.g., height, weight, temperature, pulse, the user can add vitals pertinent to the practice, e.g., add # number of toes and teeth. For example with a skin exam, the user can customize a template to add additional tests, such as those common to that practice or new to the market. The template can be formed or altered at up to three or more levels. This ability and ease of customization is unique to the present invention. Generally, templates in these systems have a set structure. For example, in a template on social history, choose which items to enter, e.g., exercise, work, living arrangement. For family history, add data fields for cousins, aunts, or uncles. Create single-tap dictionary terms that can be unique for every item and define even type of data used in the template. The template builder is accessed from the manager portion of the EMR program where the user can customize a template that already exists, or create a new one.
7. The Outstanding Work List (OWL) is the invention's internal communication and alert system. Never miss follow-up with a patient or forget to order a study. Send notes to staff or to yourself that appear on the date you specify. For example, a female patient has an indeterminate abnormality on a mammogram, so you request a repeat study in 6 months. You attach a reminder OWL to the mammogram and set it to appear in 6 months to follow-up with patient. OWLs can also be assigned or forwarded to any user on the system. Also, the user can set a rule by which OWLs will automatically be generated. For example, the user can set up a rule that if lab results are not back within 1 week for requested blood work, the system will generate an automatic OWL to follow-up with both the patient and the lab.

Any of the screens, templates, values and other data to be entered in the EMR system can be customized.

In the electronic medical record system and method of the invention, the following steps can be employed:
a. inputting patient information into an EMR system utilizing either standard or customizable templates;
b. cross-referencing the information input in step (a) with databases of information, e.g., publicly available information on the standards of care for certain demographics; and
c. generating information from cross-referencing step (b) to provide a user with a recommendation for the patient.

Exemplary recommendations include, prescribe a medication, order a procedure, give an immunization, etc.

These steps, and any additional or different steps used in the system, can be repeated, whereby inputting additional information can result in the provision of additional reminders, such as recommendations. Such recommendations may include prescriptions, orders (e.g., for lab tests or surgery), referrals (e.g., for tests or surgery), and patient anticipatory guidance instructions.

Patient information includes any information pertinent to the patient, such as past, present and family medical history and additional patient information, including social history, which includes various information, such as drug, alcohol and tobacco use, exercise regimens, dietary issues, job, living arrangement, etc.

The patient information is compared with or cross-referenced with other data, e.g., data that is publicly available, data on standards of care, new medications, discontinued medications, etc. This comparison provides information on what is available for the patient at that time, based on the information available at that time. If a practitioner diagnoses an adult patient with Type 2 diabetes and meets other conditions, the system will immediately remind to prescribe that patient a Statin. The results of the comparison generate the quality reminders, patient aggregate information, OWLs, drug-drug interaction and allergy alerts, which are different aspects of the present invention.

It is a particular advantage of the invention that the templates used for inputting the patient information can be customized so that entire new categories can be added. The inventive EMR system even permits the user to create new templates without any computer programming experience.

In the electronic medical record system and method of the invention, the following steps can be employed:
a. inputting patient information into an EMR system utilizing standard or customizable templates;
b. cross-referencing the information input in step (a) with databases of information;
c. generating standards of care information from cross-referencing step (b) to provide a user with a reminder of the standards of care for the patient; and
d. using the information from cross-referencing step (b) to automatically generate real-time drug-drug interactions and drug-allergy alerts based on the information in the EMR system at the time of generation.

These steps can be repeated as well. The drug-drug interactions and drug-allergy alerts are in real time because they are based on the information as input by the user at a particular time and the information available to the system at that same time.

Information entered into the system can be highlighted such as by using color, a flag or a colored flag for ease of reference. Also, comments can be added to the patient information to better guide the user in the future based on what was known in the past. Additionally, patient reports can be attached to the patient information and comments can be added to those attachments.

One aspect of the EMR system is that it automatically generates the reminders in step (c), above. The invention also makes it possible for the user to create a reminder for himself or for another user as well.

In the electronic medical record system and method of the invention, the following steps can be employed:
a. inputting patient information into an EMR system utilizing standard or customizable templates;
b. cross-referencing the information input in step (a) with databases of information; and
c. obtaining information from cross-referencing step (b) to automatically generate patient-specific reminders based on the patient information and the database information at that time.

These steps can be repeated as well.

In the electronic medical record system and method of the invention, the following steps can be employed:
a. inputting patient information into an EMR system utilizing standard or customizable templates;
b. cross-referencing the information input in step (a) with databases of information, such databases including information on other patients; and
c. obtaining information from cross-referencing step (b) to generate aggregate patient reporting information about select groups of the patient population based on the information in the EMR system at the time of generation.

These steps can be repeated and additional steps can be added, such as: (d) automatically generating aggregate patient reporting information and/or (e) automatically sending the information generated in step (d) to a third party recipient at a time interval designated by the user. This can be very helpful for meeting proposed government guidelines for aggregate patient reporting to measure, for example, how often the standards of care are met for a particular pool of patients. Aggregate patient data can be measured against publicly available data, or data from physicians and/or other users of the system, for example.

In the electronic medical record system and method of the invention, the following steps can be employed:
a. inputting primary patient information into an EMR system utilizing standard or customizable templates;
b. inputting secondary patient information into an EMR system utilizing standard and customizable templates, said secondary patient information being at least initially medically unrelated to said primary information, said secondary information being displayed together with said primary information to permit comparison and ease of reference of said primary and secondary information;
c. cross-referencing the information input in step (a) with databases of information; and
d. generating information from cross-referencing step (b) to provide a reminder for the user of the recommended standards of care for the patient.

These steps can be repeated and are likely to be repeated several times over in the course of a normal visit with a patient where the patient comes in for a particular complaint and then adds one or more “oh by the way's”. The present invention easily allows for this by permitting information on additional complaints to be added at the same time and viewed on the display along with the chief complaint. Also, any information about a prior complaint that is applicable to a subsequent complaint, e.g., body temperature, is automatically populated in the subsequent complaint.

In the electronic medical record system and method of the invention, the following steps can be employed:
a. inputting patient information into an EMR system utilizing standard or customizable templates;
b. cross-referencing the information input in step (a) with databases of information;
c. obtaining information from cross-referencing step (b);
d. searching the information obtained in step (c) based on clinical or demographic data to generate, respectively, clinical or demographic information; and
e. providing a user with the search results from step (d) to remind the user of the recommended standards of care for the patient.

These steps can be repeated. The inputting of additional patient information operates to update the search results from step (d) in real-time based on the information in the EMR system at the time of updating.

In the electronic medical record system and method of the invention, the following steps can be employed:
a. inputting patient information into an EMR system utilizing customizable templates;
b. cross-referencing the information input in step (a) with databases of information;
c. generating information from cross-referencing step (b) to provide a reminder for the user of the recommended standards of care for the patient; and
d. creating a reminder by the user to be sent to the user or another at a future date.

These steps can be repeated. An example of the reminder created in (d), is for the user to review a patient's history. Such reminders can be displayed on the OWLs screen.

In the electronic medical record system and method of the invention, the following steps can be employed:
a. inputting patient information into an EMR system utilizing standard or customizable templates;
b. cross-referencing the information input in step (a) with databases of information;
c. generating information from cross-referencing step (b) to provide a reminder for the user of the recommended standards of care for the patient; and
d. automatically creating a reminder to be sent to the user or another at a future date.

These steps can be repeated. An example of the reminder created in (d), is for the user to review a patient's lab report. The user can program the system to include a rule for the reviewing of a patient's lab report within a specified interval of time from the ordering of the lab report. Such reminders can be displayed on the OWLs screen.

The electronic medical record system and method of the invention can include one or more computers having a display and access to software for the inventive EMR system. The computer can obtain information from at least one database to cross-reference with patient information that has been entered to compare it with the information on the at least one database. One advantage of the present invention is that it minimizes the need to change screens and can generate a display including a simultaneous view of at least one screen from each of groups A, B, C, D and E, where group A includes the following different screens: problems, family history, immunizations, social history, and health screenings, group B includes the following different screens: labs, hospitalizations/surgeries, consultations and referrals, group C includes the following different screens: prescriptions and allergies, group D includes the following different screens: notes/documents and reminders, and group E includes the following screen: list of encounters/visits. The computer can be a desk top, lap top, tablet, PDA or in any form that can input and process data in accordance with the principles of computing. The data can be entered in any fashion, e.g., keyboard, hand writing, finger (or other body part or appropriate pointer for any touch sensitive screens), stylus and voice recognition. In addition to the one or more computers, the invention can include at least one server which is connected to the computer in some fashion (e.g., physically or wirelessly) to enable communication between the computer and the server. Information entered on the computer can be saved on the server using an encryption code to safeguard the patient's information and for compliance the Health Insurance Portability and Accountability Act (HIPAA). The inventive EMR system can also provide an automatic failover to a HIPAA-compliant off-site server if the local server ever goes down.

In the electronic medical record system and method of the invention, the following steps can be employed:
a. inputting patient information into an EMR system utilizing standard or customizable templates;
b. cross-referencing the information input in step (a) with databases of information;
c. generating information from cross-referencing step (b) to provide a reminder for the user of the recommended standards of care for the patient; and
d. creating a new customizable template having the following steps:
   i. setting template properties including providing a name for the template and linking the template with other templates;
   ii. defining a template panel by providing a name for the template panel and a number of columns for the template; and
   iii. defining fields or line items in the template by adding, modifying or deleting items; defining the type of data in the fields or items, and adding dictionary terms to select for one or more items.

These steps, as in all embodiments of the invention, can be repeated. One particular advantage of the invention is that once a new customizable template has been created and used, the information it contains can be searched along with the information in standard templates.

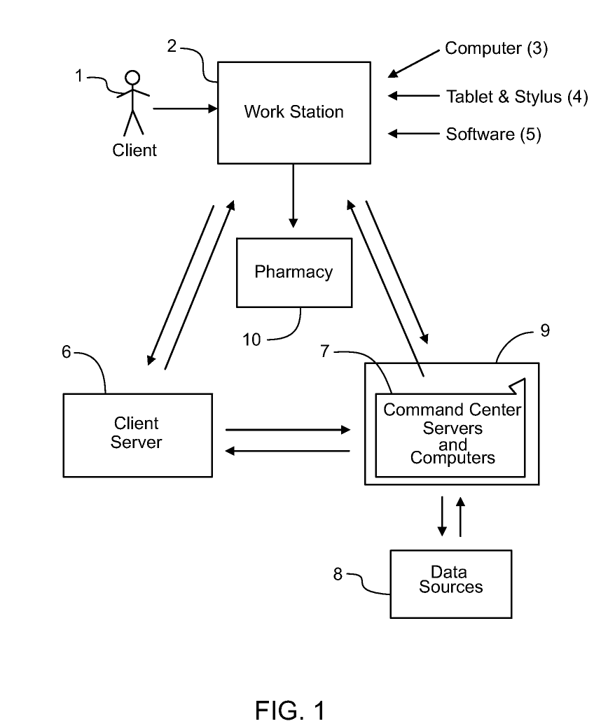

1) FIG. 1 depicts an example of a hardware arrangement to enable the system to carry out the electronic medical record system and method of the invention. The client or user (1), usually a professional such as a doctor and/or his/her staff, receives from the Provider and Support Company (9), materials for enabling use of the system and method including workstation(s) (2), which workstation(s) (2) include computer(s) (3), and/or tablet(s) and Stylus(es) (4), and the method software package (5), a local server (6) to be located on client premises, the server (6) communicates back and fourth with the workstation (2) and also communicates back and fourth sending and receiving data and receiving updates from the command center (7) located at the provider and support company premises (9), and also off site backing up data to command center (7), the command center (7) also communicates back and forth sending and receiving data and backing up data from outside resources and data services (8). The command center (7) also communicates directly with the workstations (2) sending updates. Data sent to and from workstations (2), Server (6) and command center (7) are often sent encrypted for patient information protection. Workstation (2) also communicates directly with third party Pharmacy Network (10).

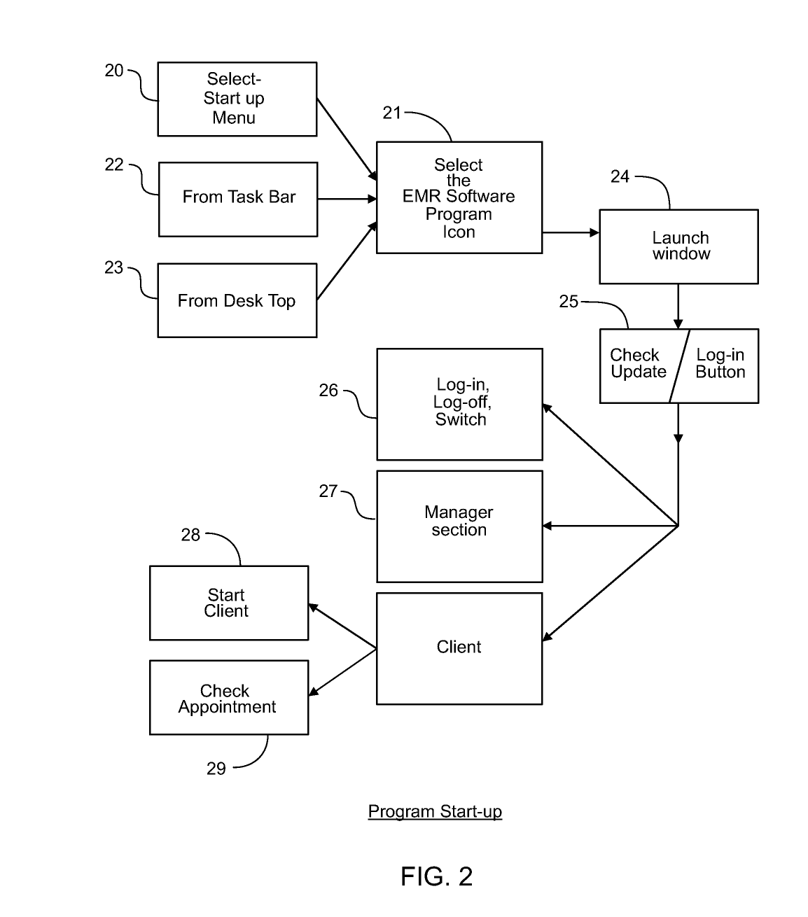

2) FIG. 2 depicts an example of the flow of program initiation to run program, or program start up.

To start the EMR program of the present invention, first select Startup menu (20), and then selecting the EMR program Icon (21), or from the Task Bar (22) selecting the EMR Program Icon or from the computer's desktop (23) to link to the EMR program Icon (21), any of which will start the EMR program, and open the EMR Launch Window (24). At the Launch Window the User/Client (1) can select either “Check update” or “Log in Button” (25), select Log in. To Log In, input a User Name and Password. Then either click Enter on the keyboard, or click the Login button. Once logged in, there is full access to the EMR Launch Window, from where it is possible to:
1. Log off, or Change User(s) (26)
2. Access the EMR Manager (27), to customize system settings, screen appearances, templates, queries, and data entry shortcuts (referred to herein as “dictionary terms”); download software updates; create data Reports; or, depending on the specific configuration, schedule patient visits and/or conduct billing operations.
3. Start the Client (28) (or, the clinical portion of the EMR program) or check an Appointment list (29).

To Log Off the EMR program, re-open the Launch Window by clicking on the appropriate EMR icon, which is the Paper Airplane, in the task bar. To log off, simply click on Log Off.

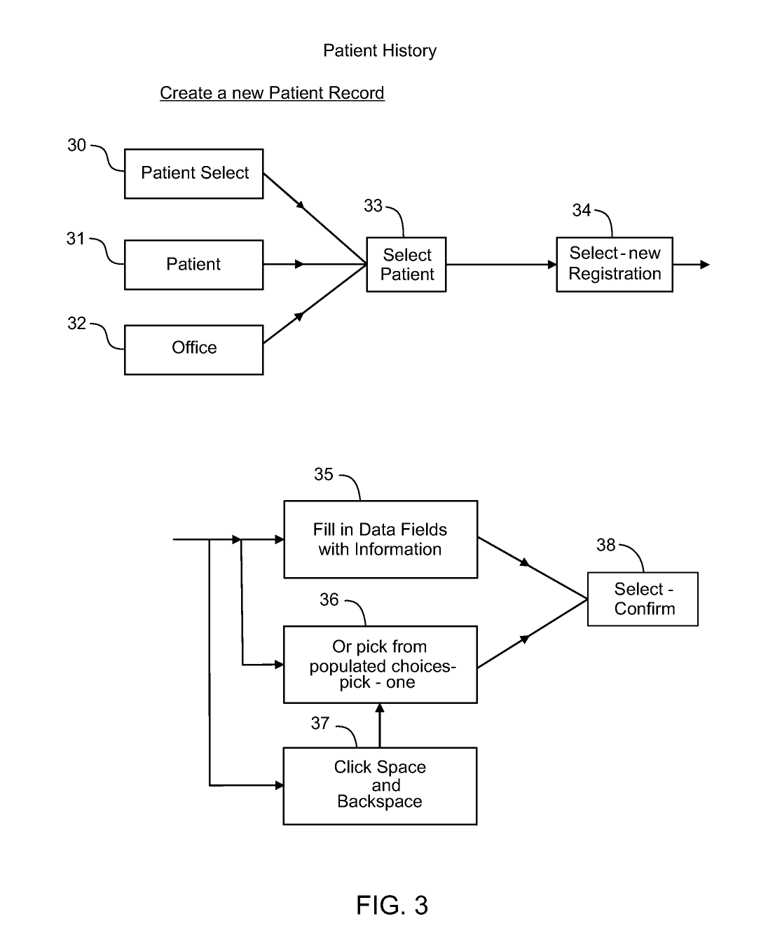

3. FIG. 3 depicts an example of the flow of Creating a New Patient Record.

This can be created by the patient or any of the medical staff or professionals.

In the upper left there are three tabs: Patient Select (30), Patient (31), and Office (32). Click Patient (33). And then click New Registration (34).

This is the Patient Registration screen. Fill-in Data Fields with information (35), or pick from populated choices (36), or sometimes to get populated choices you must click space then backspace, the field populates (37), then you pick from those choices (36),

Now, click Confirm Changes (38).

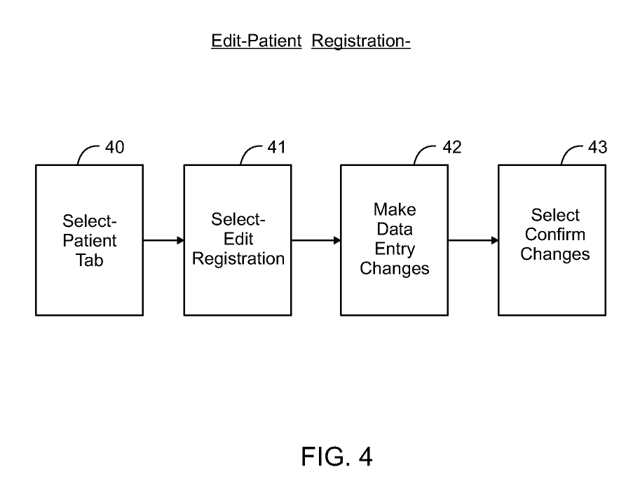

4. FIG. 4 depicts an example of the flow of Editing a Patient's Registration Information.

To edit a patient's registration information, or re-open the Patient Registration screen for any other reason, click the Patient tab (40), and then click, Edit Registration (41).

Then make any appropriate changes the same way data was entered to Create a New Patient record, above (42).

Click Confirm Changes (43).

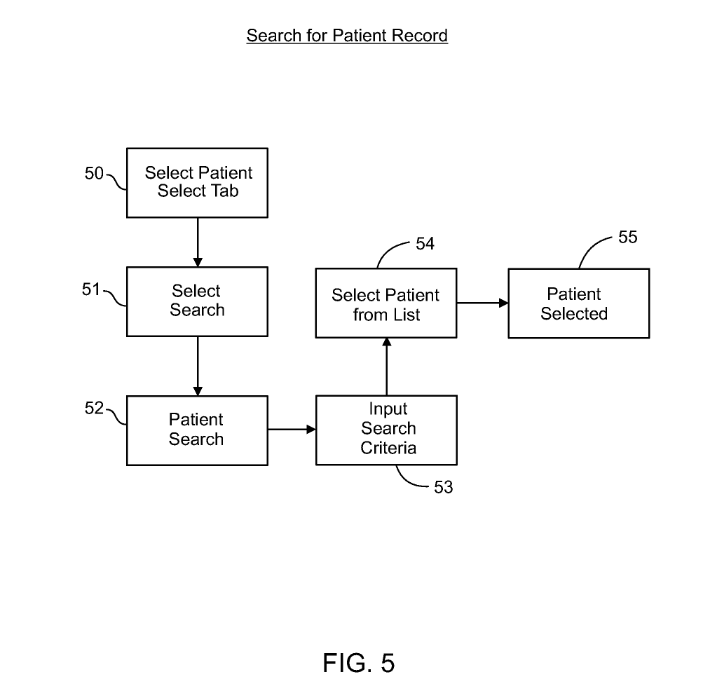

5. FIG. 5 depicts an example of the flow of Searching for a Patient Record.

There are a number of convenient options to locate a patient record.

Search options are all located within the Patient Select tab (50). Click on that tab.

The second option is Recent. When we click on Recent, we get a list of the most recent patient records that have been accessed. To access a patient record, we merely click on the listing.

And finally, we can Search for a patient record. Select Search (51), select Patient Search (52), input search criteria (53), select a patient from the list (54), patient is selected (55).

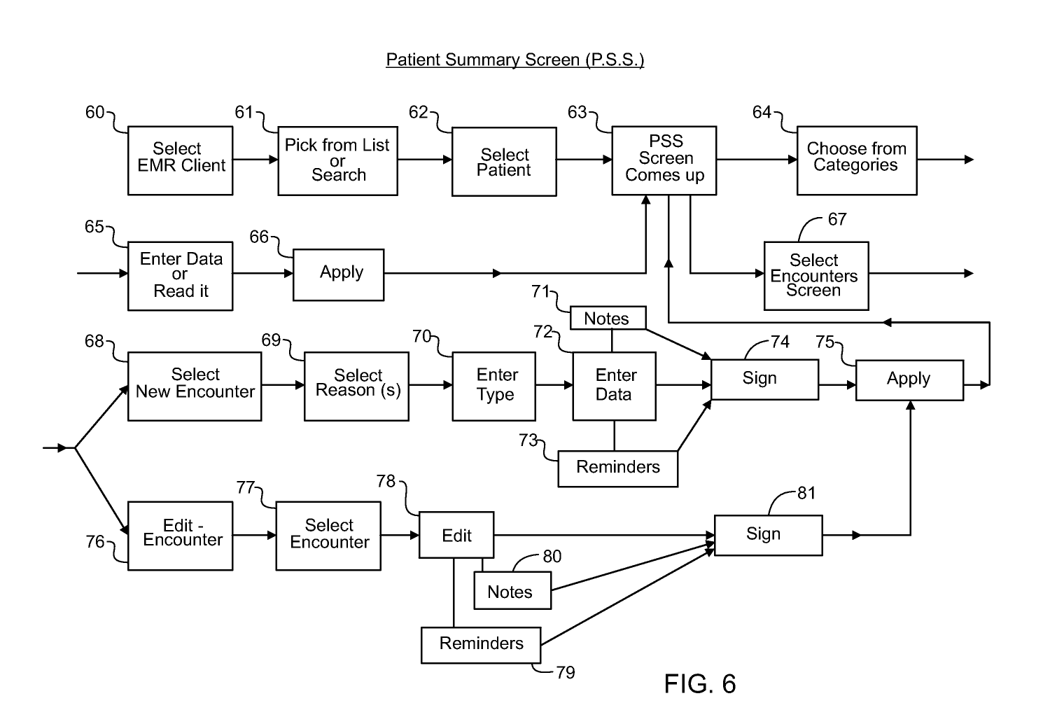

6. FIG. 6 depicts an example of the flow of the Patient Summary Screen.

FIG. 6 depicts an example of the flow of Patient Summary Screen. First select EMR Client (60), then pick from the populated list of clients or search for one (61), then Select Client from the choices (62), then the Patient summary Screen (PSS) comes up (63), then choose from the Categories (64) in the PSS (63), which include Problems, Family History, Immunizations, Social History, Health Screening, Labs, Hosps/Surg, Consult/Referrals, Prescriptions, Allergies, Quality Reminders, Notes/Documents, and Encounters, enter data and/or read it (65), Apply (which means the data is being saved and applied or updated wherever this information is required) (66), then go back to PSS screen (63).

Or the user can choose to select an Encounter by selecting Encounters Screen (67) from the PSS (63), then select either New Encounter (68) or Edit Encounter (76), if you choose New Encounter then after Selecting New Encounter (68) then select reason's (69) such as Acute, Review, Wellness, combo, or all, and note the type (70) like in person, phone, email, text, correspondence, lab results, procedure results, user or doctor review, then enter data (72) and either go straight, or first enter notes (71), or first set up reminders (73), then go to signature (74) (which can be hand signature or other choices, then apply (75), then return to PSS screen (63). If you chose to edit an encounter from the PSS screen (63) then select encounters screen (67), then select edit encounter (76), then select encounter to edit (77), then edit it (78), and either first enter notes (80), or first set up reminders (79), then go to signature (81) (which can be hand signature or other choices, then apply (75), then return to PSS screen (63).

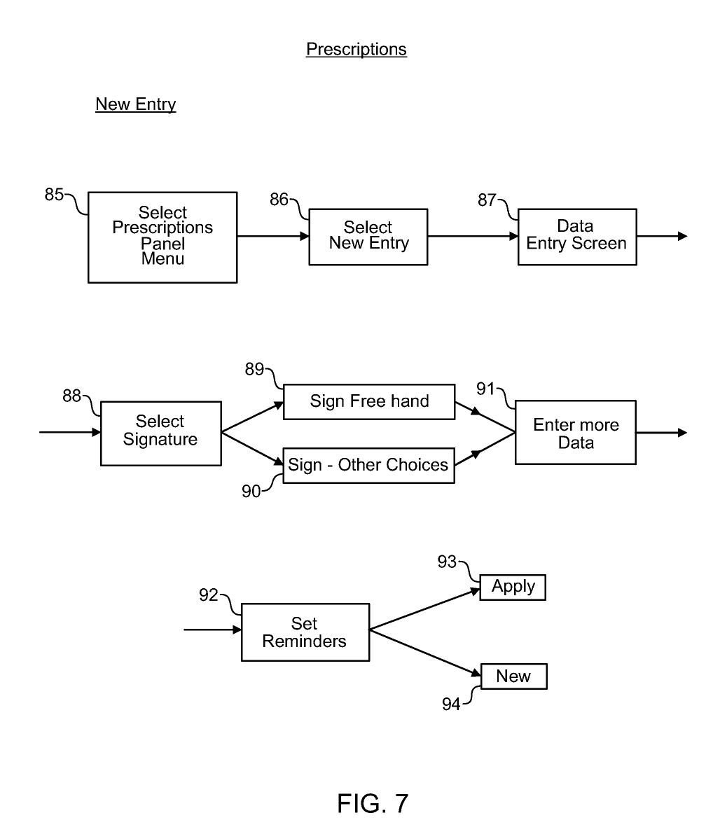

7. FIG. 7 depicts an example of a flow of Prescriptions: New Prescriptions

The EMR program offers a full spectrum of electronic and traditional prescribing options, as well as automated allergy and drug-drug interaction alerts.

To enter a new prescription, first open the Prescriptions panel menu, by clicking on the Prescriptions panel heading (85), and then clicking New Entry (86).

The Prescriptions Entry/Edit screen will display (86).
1. Searching/Selecting Drug/Dose: To enter a prescription product, enter the product from a database, which we search by name, and then by strength or appropriate formulation.
   1. With the cursor on Search Drug, type the name of the prescription, either the brand name or the generic will work, and after 3 characters have been entered, products that match the search will begin to display. Lisinopril is an example. Enter “lis,” and products begin to display. Add more letters, and the search results refine.
   2. Select the strength or formulation by clicking on the desired one that we want. This can be displayed on the right of the screen, for example. Select Lisinopril 10 mg by clicking on it. And now, the medication name and strength are displayed in Drug/Dose.
2. Signature (88): Now, to enter the signature (“Sig”), just place the cursor within the Sig field and enter the Sig using free text and/or the very nice dictionary terms (which can be added to or modified). Here are a few examples on how to do this.
   1. Enter free text, type: “take it however you want”,
   2. Or, use the dictionary terms, e.g., “enter 1 by mouth every day”,
   3. Or, select “1 t/d/m,” which is a short cut for the same thing.

Enter more data (91) and set reminders (92)—
3. Dispense Number, Refills: Next, we tab to Dispense number, and enter 90, by clicking on it. And then tab over to refills, and click on 3.
4. Pharmacy Comment: Pharmacy message is an optional field to create a message that will go only to the pharmacist, such as “No child safety top please.” This message can automatically display on subsequent prescriptions for this patient, or be deleted.
5. Internal Comment: Internal comment is an optional feature. Here, add a message for the patient, that will display on the prescription. When the cursor is placed in Internal Comment, automatically, below, we get dictionary terms that list each of the patient's diagnoses, and this comment here, “This is for your,” and the intention is that you can let the patient know why they use this medication, so we can enter, “This is for your,” by clicking here, and then, click on, Hypertension, so that we now have “This is for your Hypertension,” and this will display on the prescription, or any med list that we give the patient.
6. Display Group: Next, another optional feature, the Display Group. This displays the patient's medications by group, just so that a lengthy medication list is easier to view. So, if we place the cursor in Display group, this drop down menu displays, and we can select an appropriate group. Click on blood pressure. Now the medication will be listed within a grouping, which can be quite helpful for patients with long lists of medications.
7. Allergies: On the screen, e.g., in the middle for prominent viewing, is a display of any of the patient's recorded allergies, as a reminder when writing a prescription, of any issues to be careful about.
   1. There are a number of ways to be reminded about any possible interactions. For example, an icon will change to yellow/red and flash if an issue exists. The icon can be located, for example, In the upper right corner. Or, click on “Interactions,” to actively look for any allergy or drug-drug interactions.
8. Activity: we can have an Activity button. Click on Activity and a history of the prescription's activity, such as when it was last refilled, will display.
9. Monograph: A nice optional feature is the Monograph button. This provides access to a full informational monograph, that reviews dosing, indications, interactions, side effects, etc. Additionally, from this button, we can access a patient education leaflet regarding the medication.
10. Extra Tab:
   1. Expiration Date: this tab can provide the Expiration Date. With this we can set an expiration date for a temporary prescription, such as an antibiotic or pain medication. After the expiration date, the medication will automatically be removed from the Active list, to the Inactive Prescriptions list.
   2. Interactions Comment: the program can include an Interactions Comment field with an option to explain why the physician might be ignoring an interaction warning that the system provides, for instance, if an interaction is only a mild one.
11. Coming back to the main screen, after entering a prescription either click Apply (93), or click on NEW (94), if there are more medications to enter.

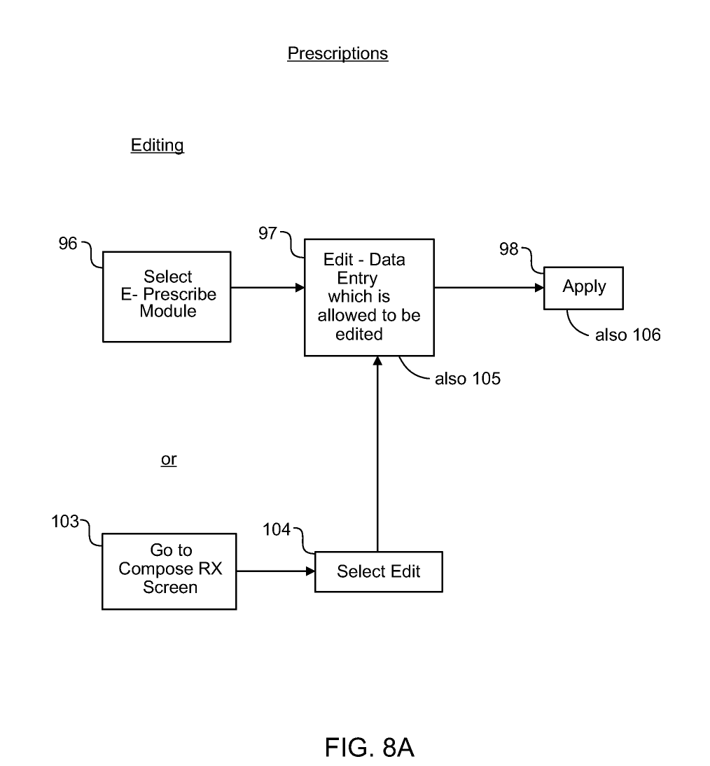

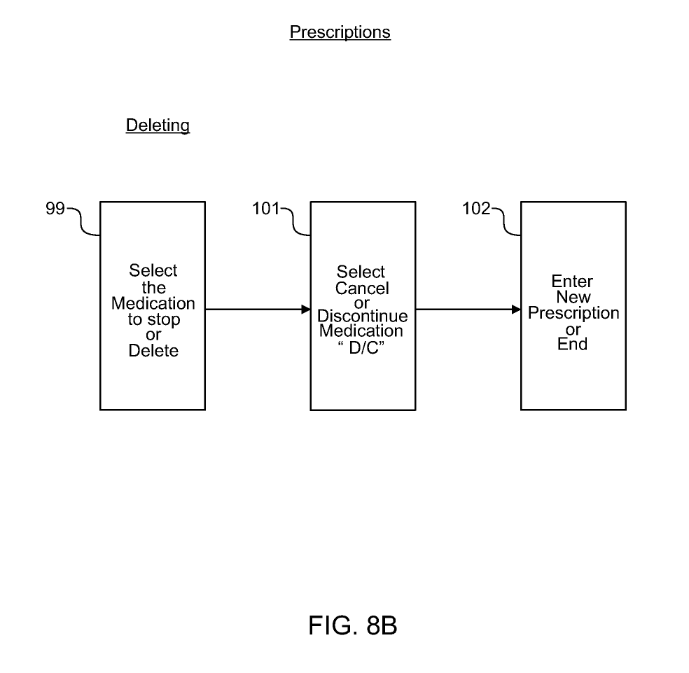

8. FIGS. 8A and 8B depict an example of a flow of Prescriptions: Editing or Deleting a Prescription.

For a prescription-related function besides entering a new medication, it is helpful to access the E-prescribing module (96), EITHER by clicking on the Prescriptions panel heading, and then E-prescribing or access this same screen by clicking ePrescribing, which opens up the same screens.

We can edit the prescription sig, as well as the dispense and refill numbers. On the other hand, if we need to change the pill strength, then we discontinue the medication, and enter a new prescription.

Editing is straightforward. Edit from the Compose Rx screen (103).

Merely click EDIT (104) next to the medication, and then you have the ability to alter the Sig, the Pharmacist's message, the dispense number, and refills (105).

When done, click SAVE (106).

Now, to discontinue a medication, all we need to do is click adjacent to the prescription we want to stop (99), and then click here on D/C (101). Select new prescription (102) to enter a new prescription.

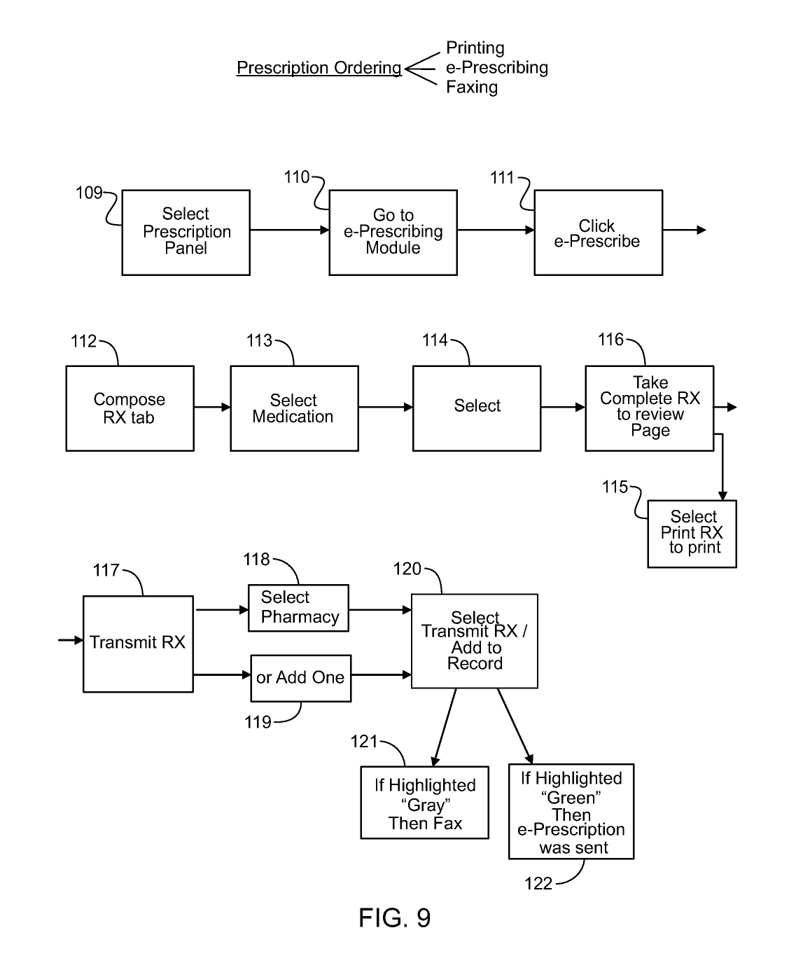

9. FIG. 9 depicts an example of a flow of ordering prescriptions by printing prescriptions, e-prescribing, or faxing in prescription to the pharmacy

### Prescriptions: Printing a Prescription:

To print a prescription, go to the E-prescribing module (110) by clicking on the Prescriptions panel (109), to open the Prescriptions Panel Menu, and then clicking E-prescribing (110).

Work under the Compose Rx tab (112)

To print or to send a prescription (or prescriptions) by Email or Fax, first Select the desired prescriptions (113), either by clicking directly on the medication, or by clicking the corresponding box, which can be found, for example, on the left, and then Select (114).

If the prescription appears as you want it, then click Take Complete Rx (116) to Review Page. To print the prescription, click on Print Rx/Add to Current Meds (115).

The Prescriptions list will automatically update.

### Prescriptions: E-Prescribing New Prescriptions or Refills

To E-prescribe, be in the E-prescribing module. Click on E-prescribing (110). Start out under the Compose Rx tab (112).

This process can be used for new prescriptions or refills alike, although there are a number of ways to do refills more quickly.

To E-prescribe a prescription to a pharmacy, first Select the desired prescription (or prescriptions) by clicking directly on the medication (113).

If the prescription appears as desired, then click Take Complete Rx to Review Page (116). Then click on Transmit Rx (117).

From this next screen, select a Pharmacy (118), either by selecting from an existing pharmacy list (scroll through, “these are pharmacies to which we have already sent prescriptions”), or, if the pharmacy isn't already on the list, add a pharmacy, by clicking on Add Pharmacy (119), and then searching for the pharmacy by filling some of the pharmacy information, e.g., by entering the pharmacy name and the city/state.

Any of the pharmacies that display a green dot are capable of E-prescribing. Select a pharmacy just by clicking on the name.

This green color indicates that this is an E-Prescription (122). Then click on Transmit Rx/Add to Record (120).

This E-record here can be printed, if a patient requests, but this is not necessary. Then Close to finish.

### Prescriptions: Faxing a Prescription

Faxing a prescription to a pharmacy is almost exactly like E-prescribing.

Begin in the E-prescribing module by clicking on E-prescribing (110). Start out under the Compose Rx tab (112).

This process can be used for new prescriptions or refills alike, although there are a number of ways to do refills more quickly.

First, Select the desired prescription (or prescriptions by clicking directly on the medication. (113)

If the prescription appears as desired, then click Take Complete Rx to Review Page (116). Then click on Transmit Rx (117).

From this next screen, select a Pharmacy (118), either by selecting from an existing pharmacy list, or, if the pharmacy isn't already on the list, add a pharmacy, by clicking on Add Pharmacy (119), and then searching for the pharmacy by filling some of the pharmacy information, e.g., entering the pharmacy name and the city/state.

Pharmacies that DO NOT display a green dot are likely incapable of E-prescribing, but typically, we can alternatively just send the prescription as a FAX, which is almost exactly the same with this program, since we still are sending the prescription electronically.

Select a pharmacy just by clicking on the name.

The gray color indicates that this is a FAX Prescription (121). Just to note, if necessary, you do have the option to edit this FAX number, if you ever need to. Now, to send the FAX, we click here on Transmit Rx/Add to Record (120).

This FAX record here can be printed, if your patient requests, but this is not necessary. We then Close, and we're finished.

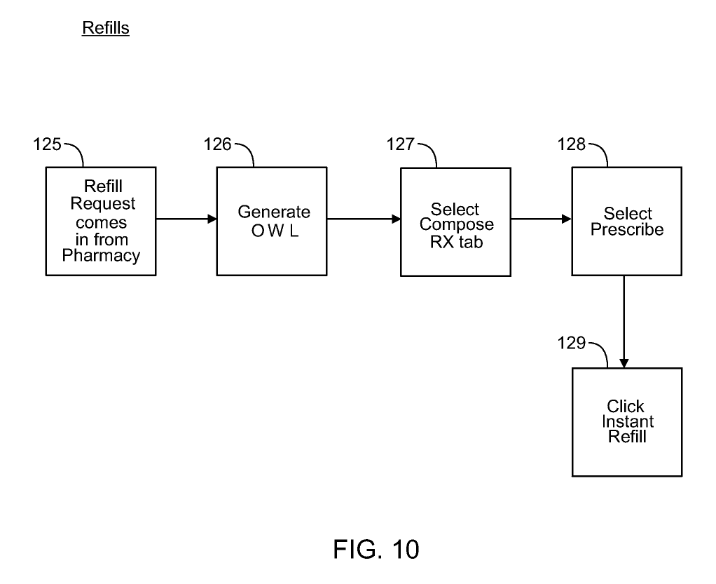

10. FIG. 10 depicts an example of a flow of refills

### Instant Refills

This next function, Instant Refills, allows a refill to be sent very quickly. Instant Refills can be used if you have already sent a Patient's prescription successfully to the pharmacy. The next time you send any prescription, to the same pharmacy, you can use the Instant Refills function.

Refills request comes in from pharmacy (125), generates an OWL (126), user can access the E-prescribing module by clicking on it and starting out from the Compose Rx tab (127).

Select the prescribe (128) then click instant refill (129)

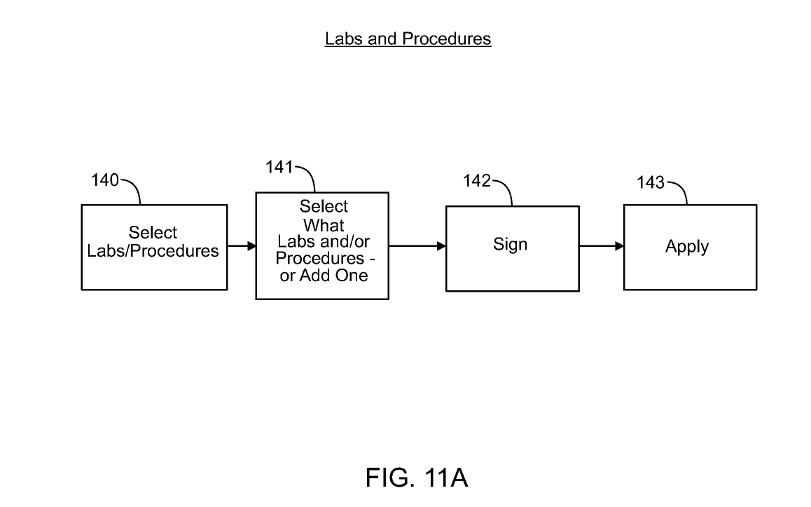

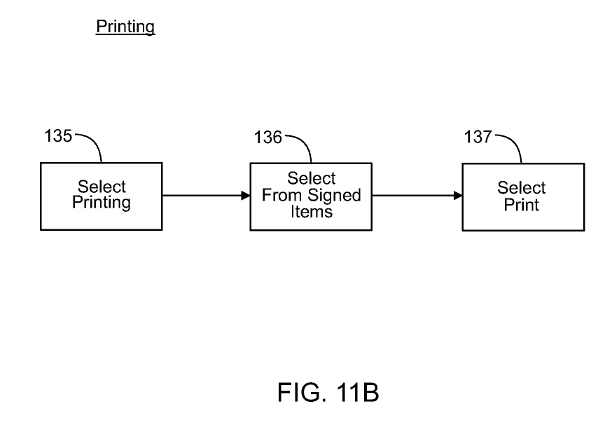

11. FIGS. 11A and 11B depict an example of a flow of ordering labs and/or procedures

Select labs/procedures (140), then select what procedure or labs you want to order (141), then sign (142), then Apply (143).

FIG. 11B Printing—Select Printing (135), Select from the signed Items (136), Select Print (137).

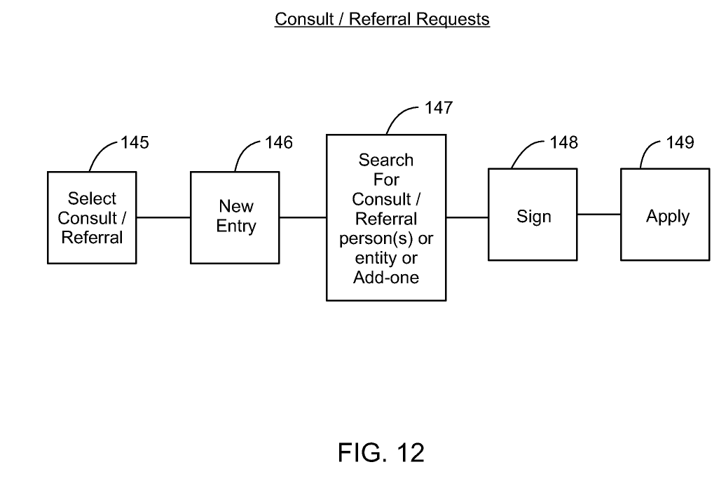

12. FIG. 12 depicts an example of a flow of ordering consultations and/or referrals

Select consult/referrals (145), then select new entry (146), then select what doctor or facility you are referring or requesting a consultation (147), then sign (148), then apply (149).

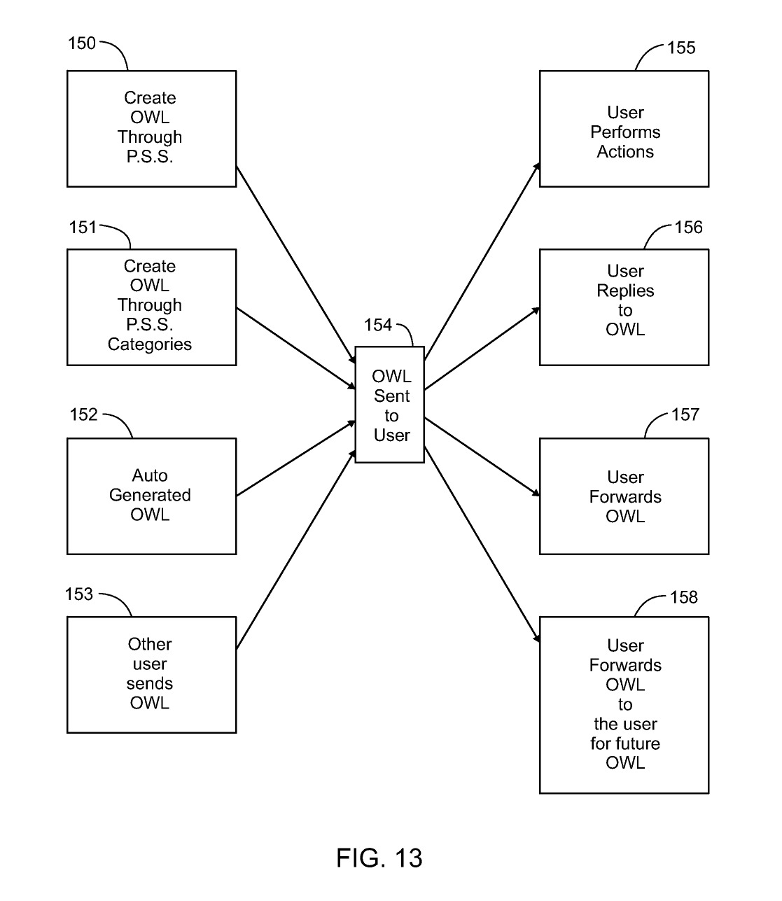

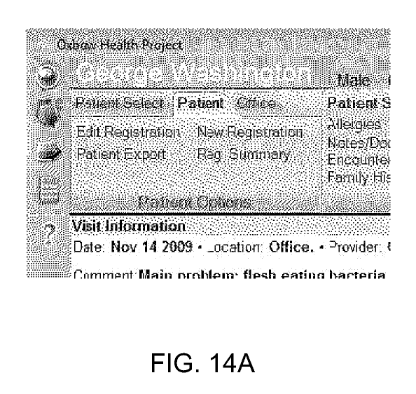

13. FIG. 13 depicts an example of a flow of Outstanding Work Lists (OWLS)

OWLS are sent to the user in 4 different ways, created on PSS Screen (155), Created on screen from the categories available from PSS screen (151), automatically generated (152), created by other users (153), they are sent to user (154), who can then either perform some action (155), and/or reply (156), and/or forward the OWL (157), and/or Forward the OWL to him/her self for the future (158), or to Delete the OWL (also included in 155).

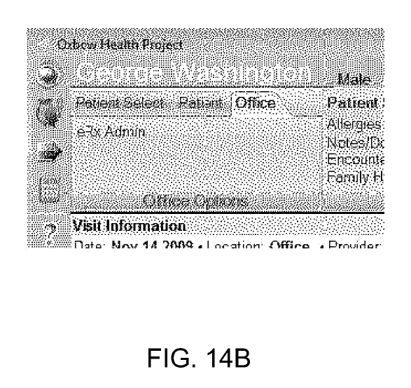

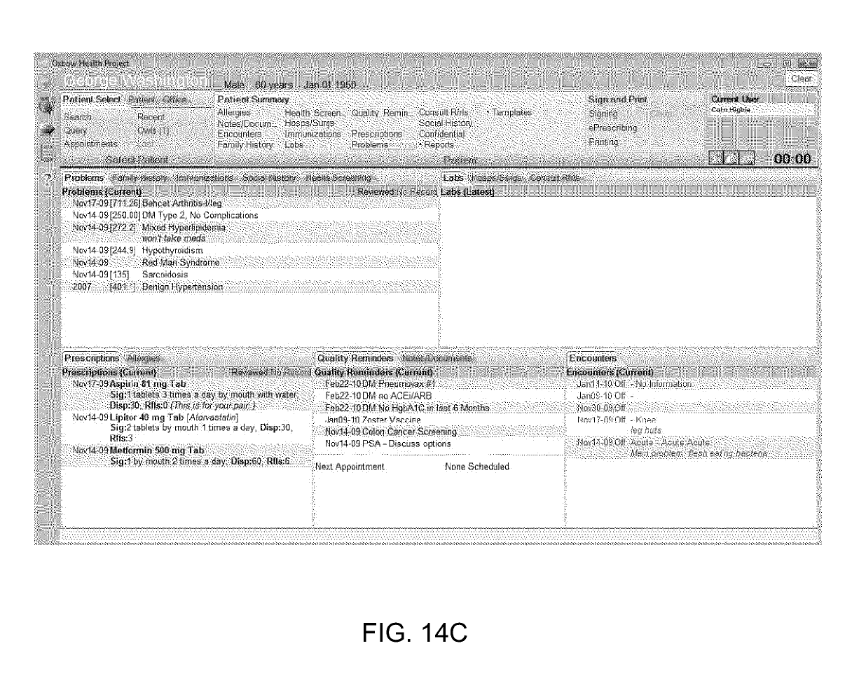

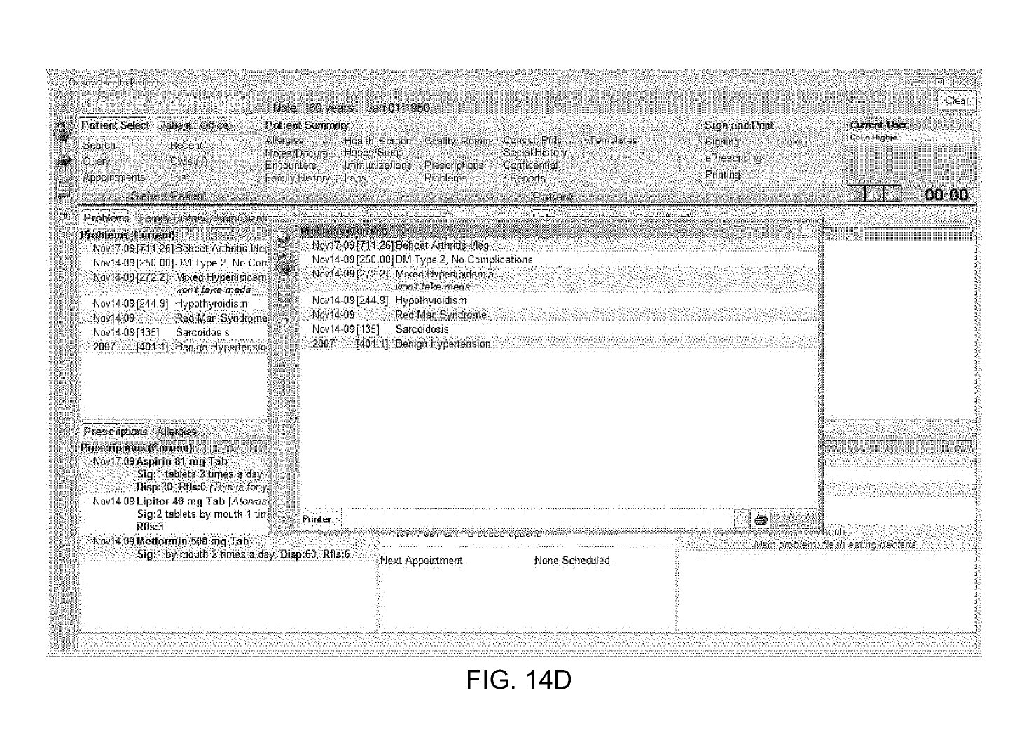

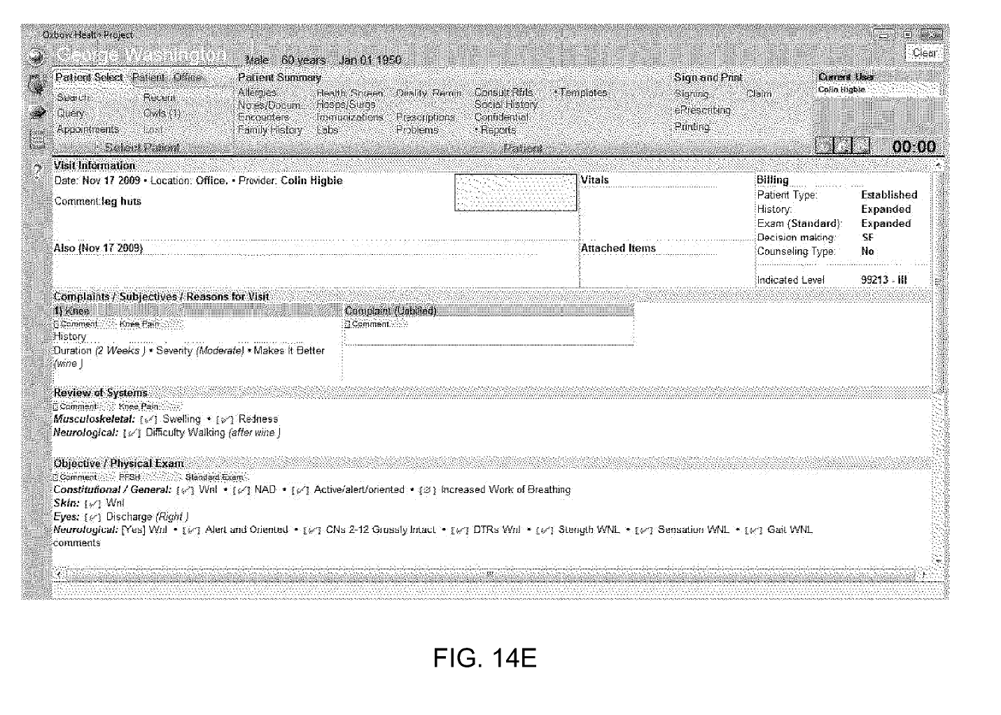

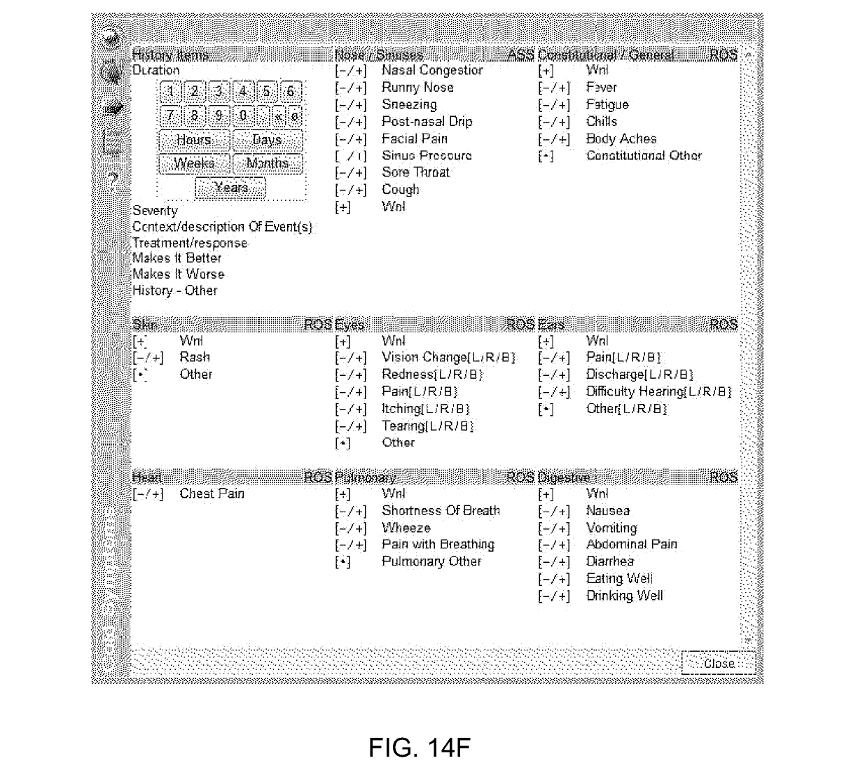

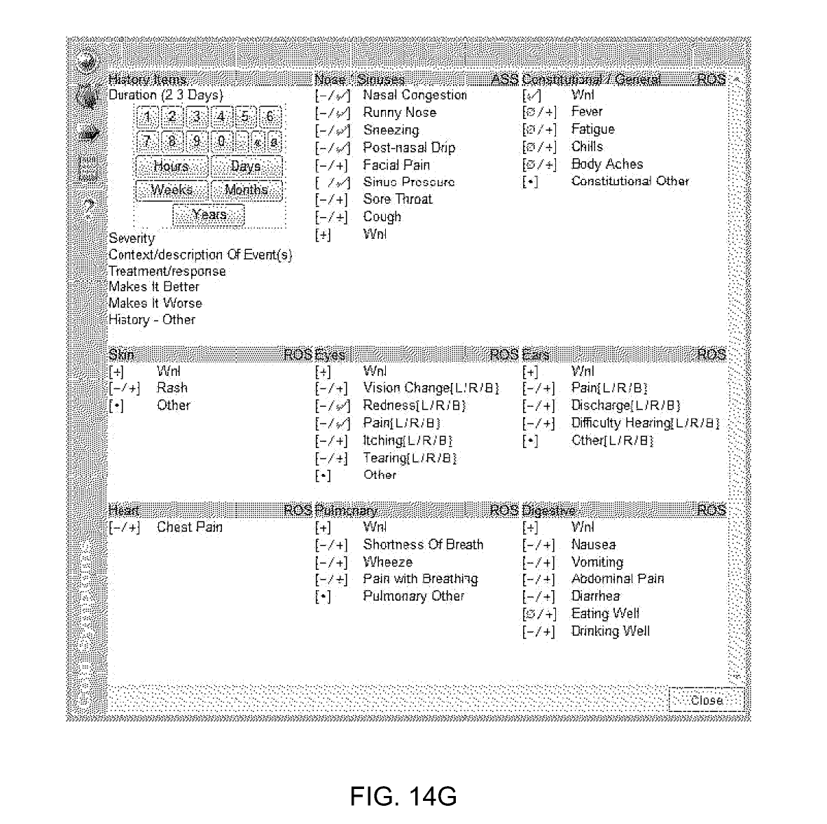

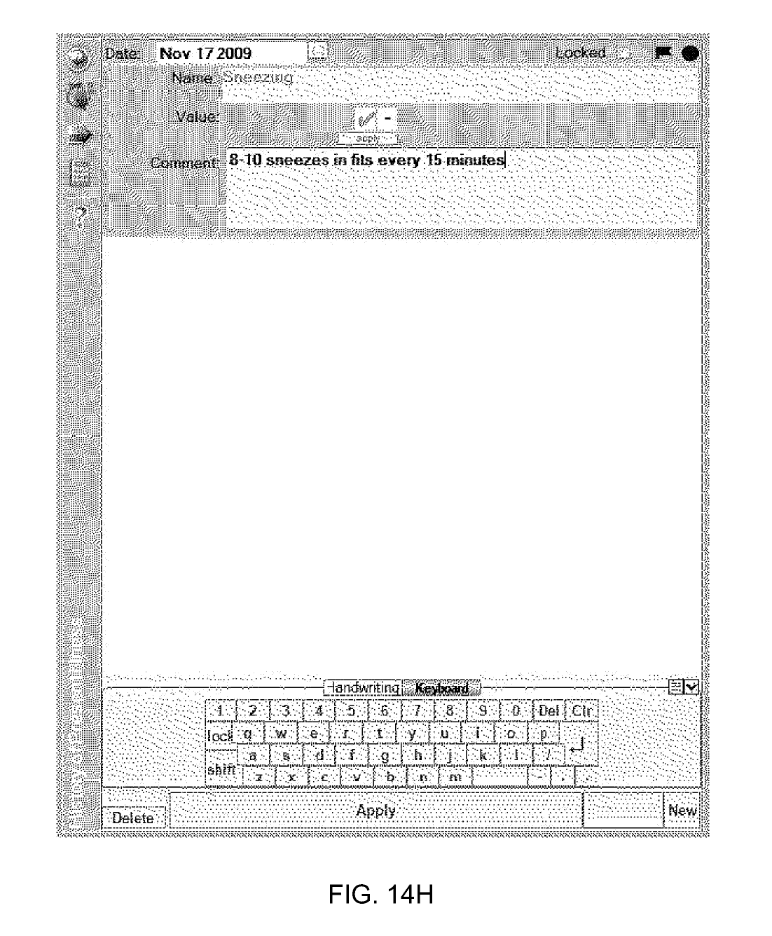

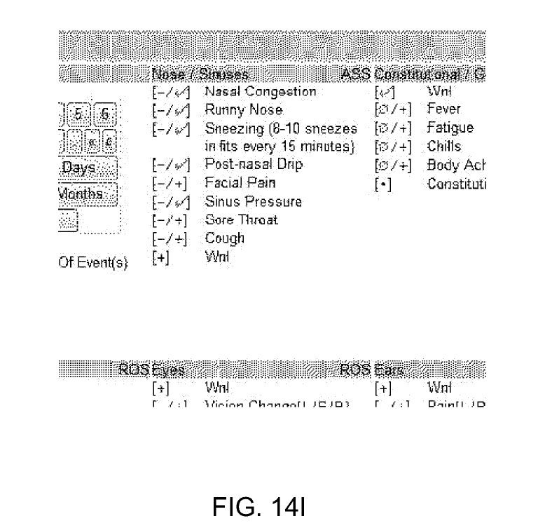

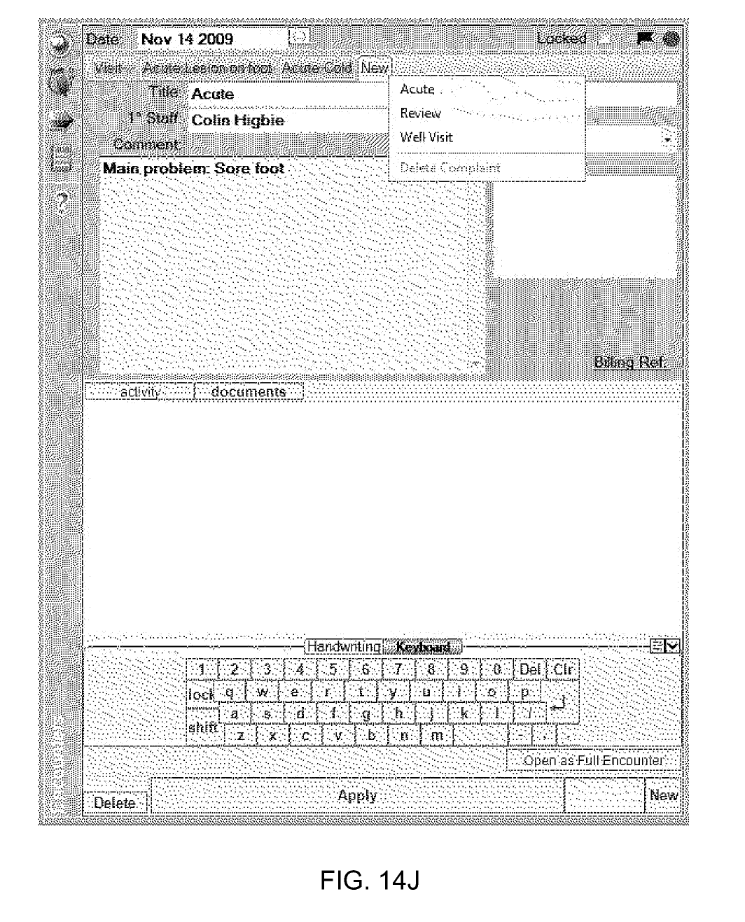

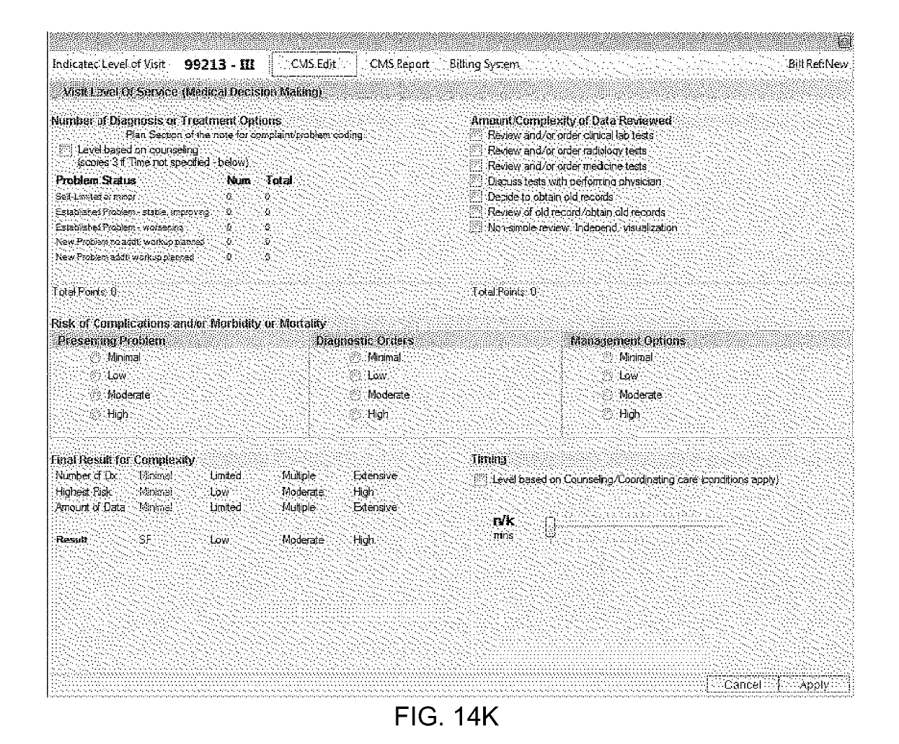

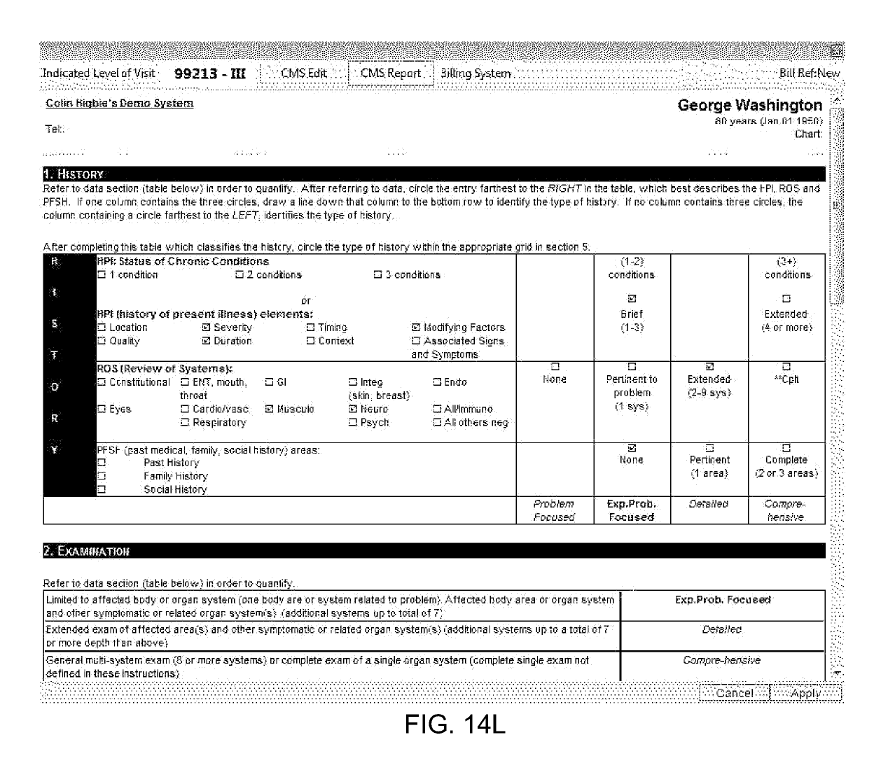

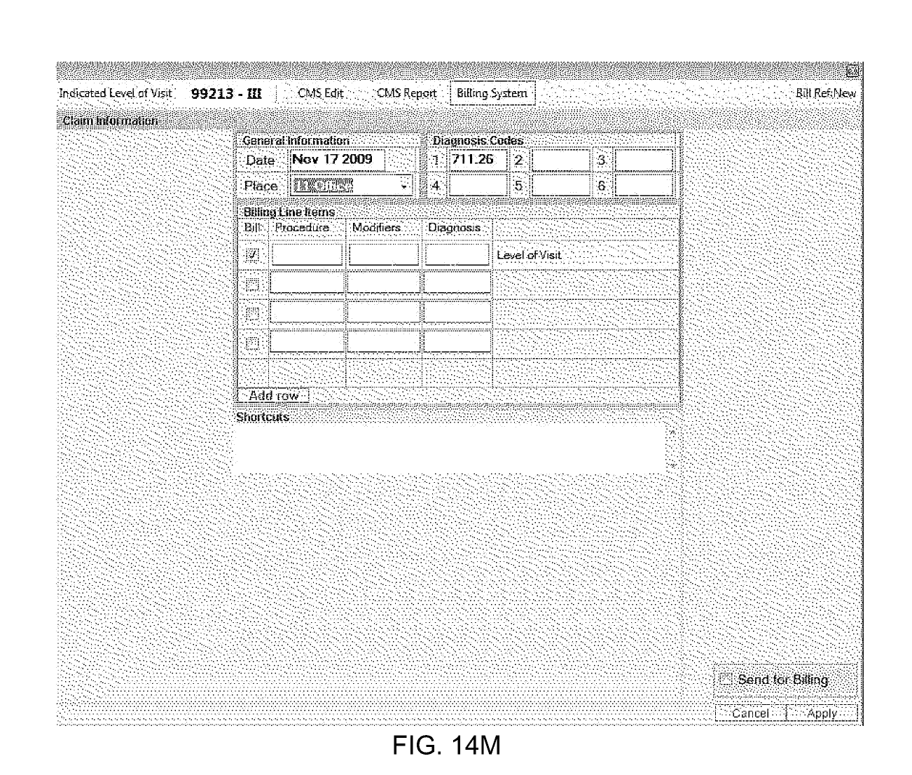

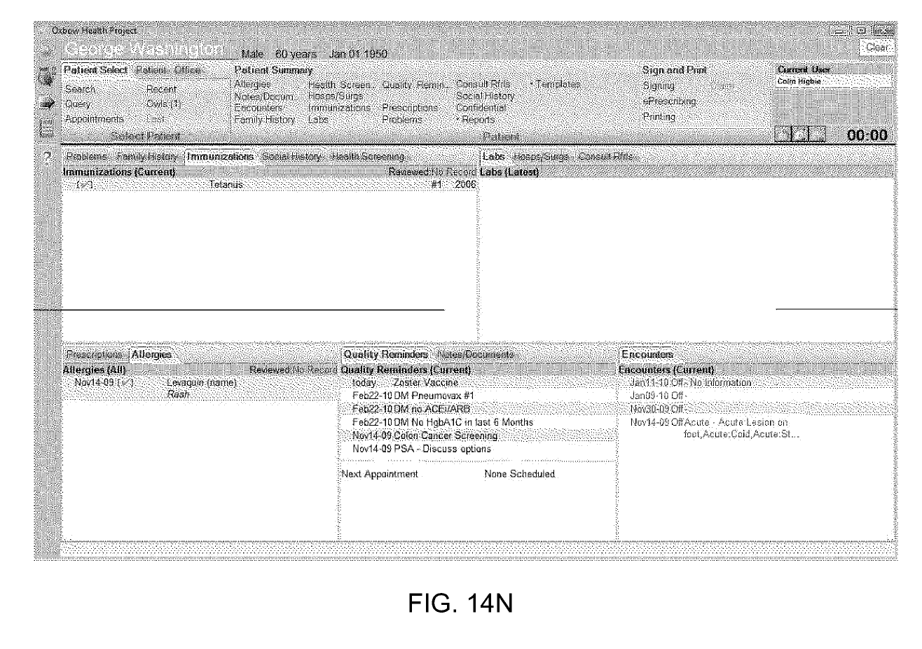

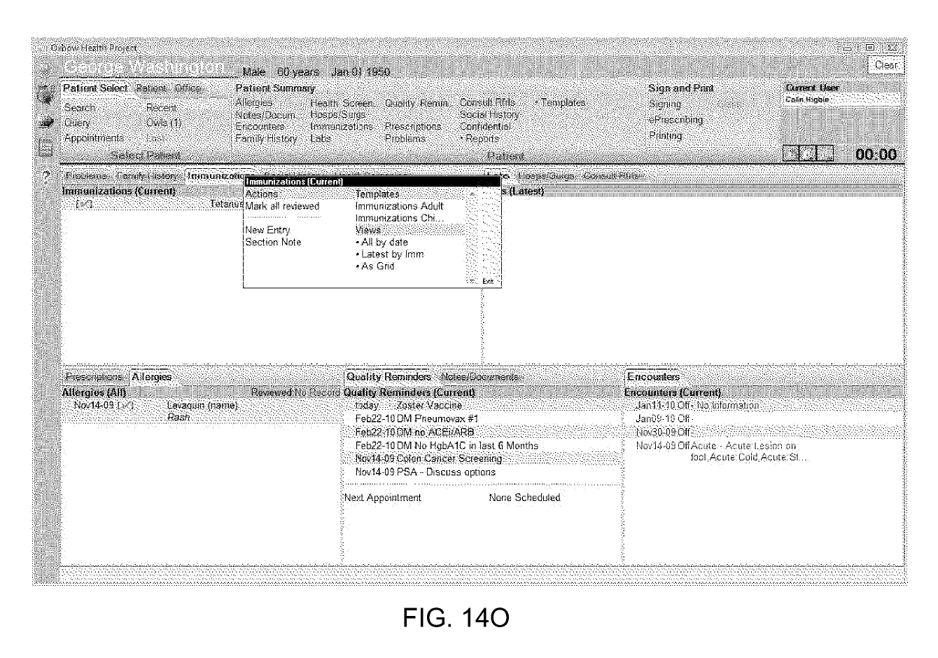

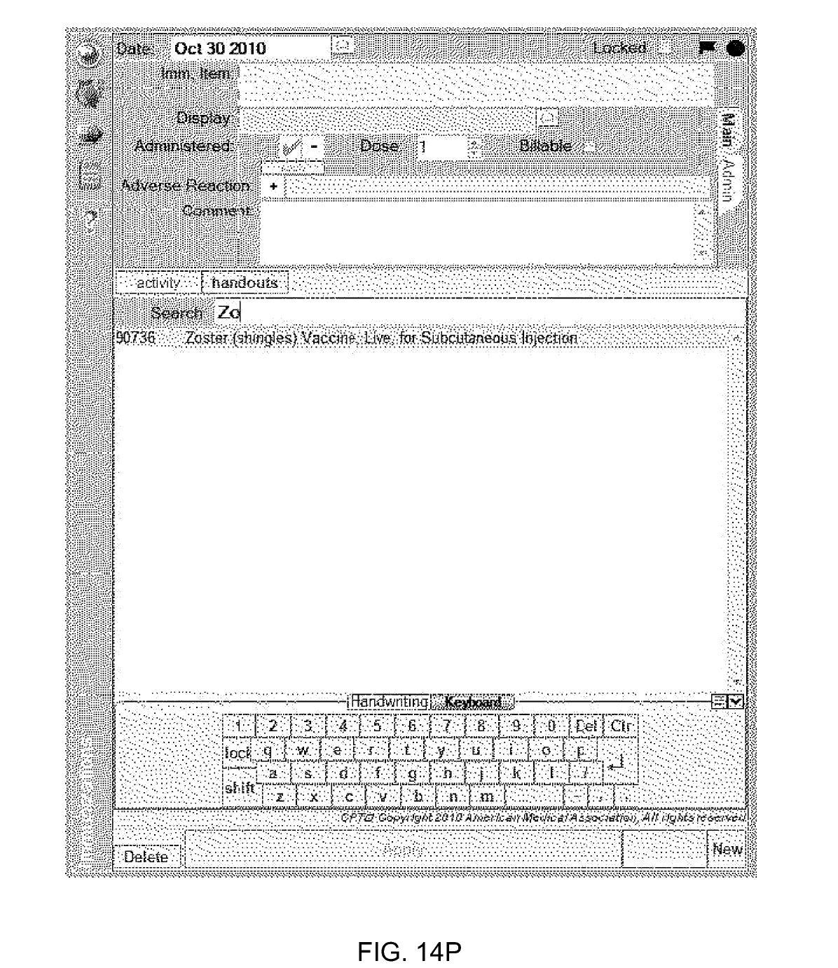

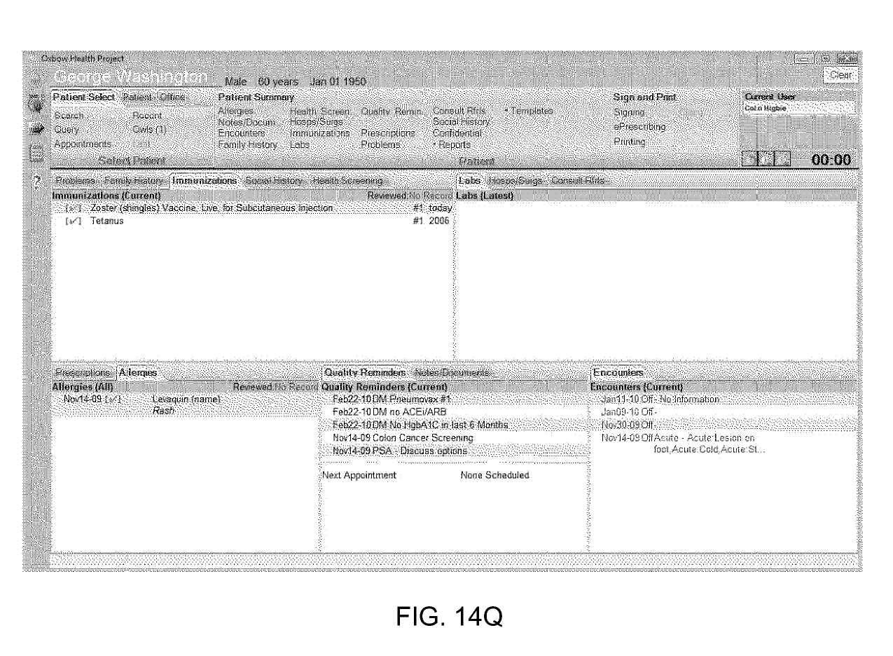

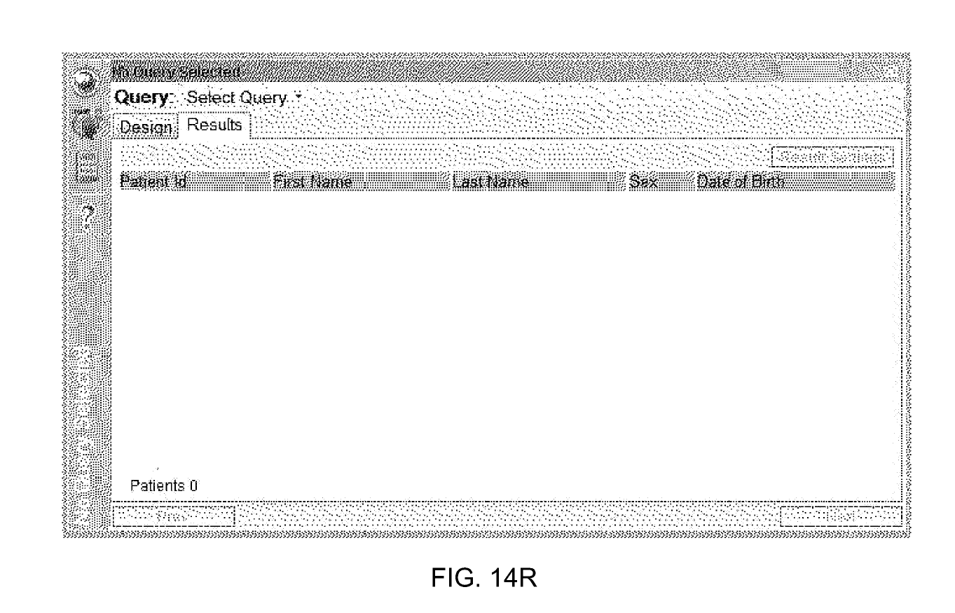

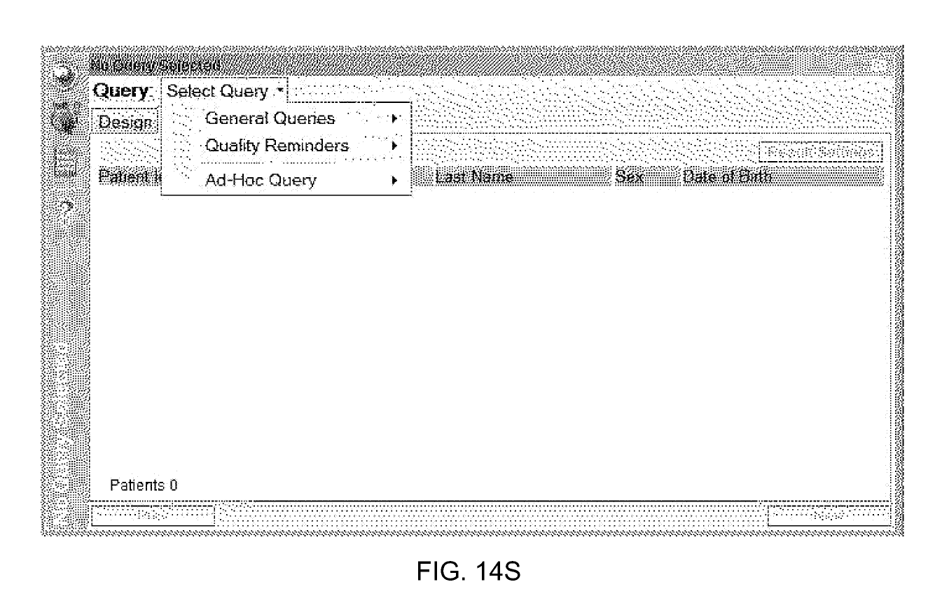

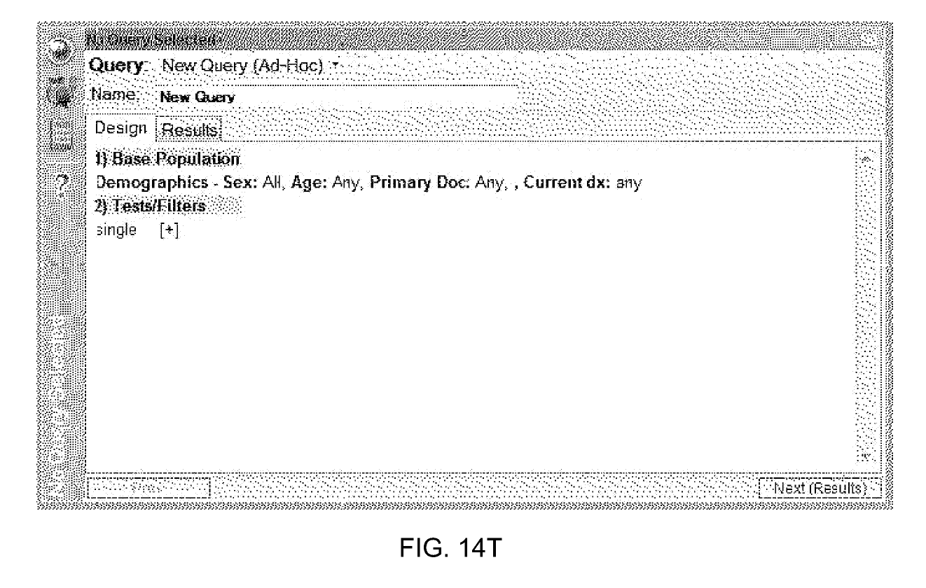

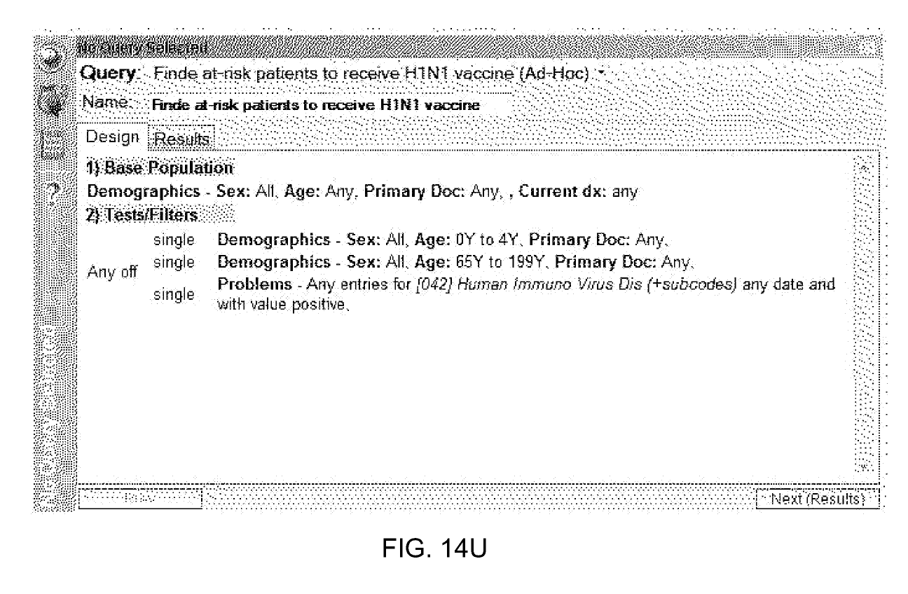

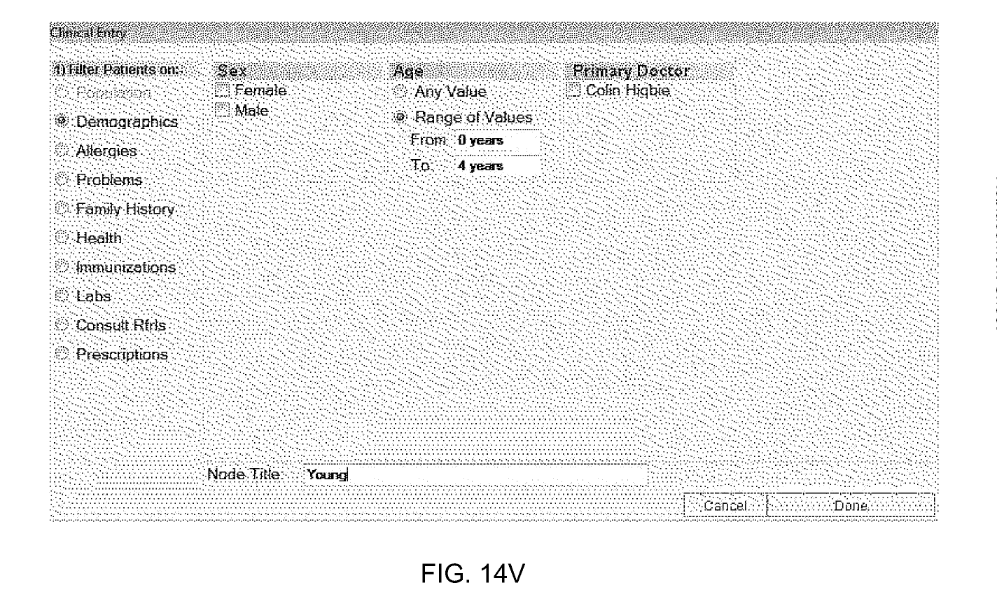

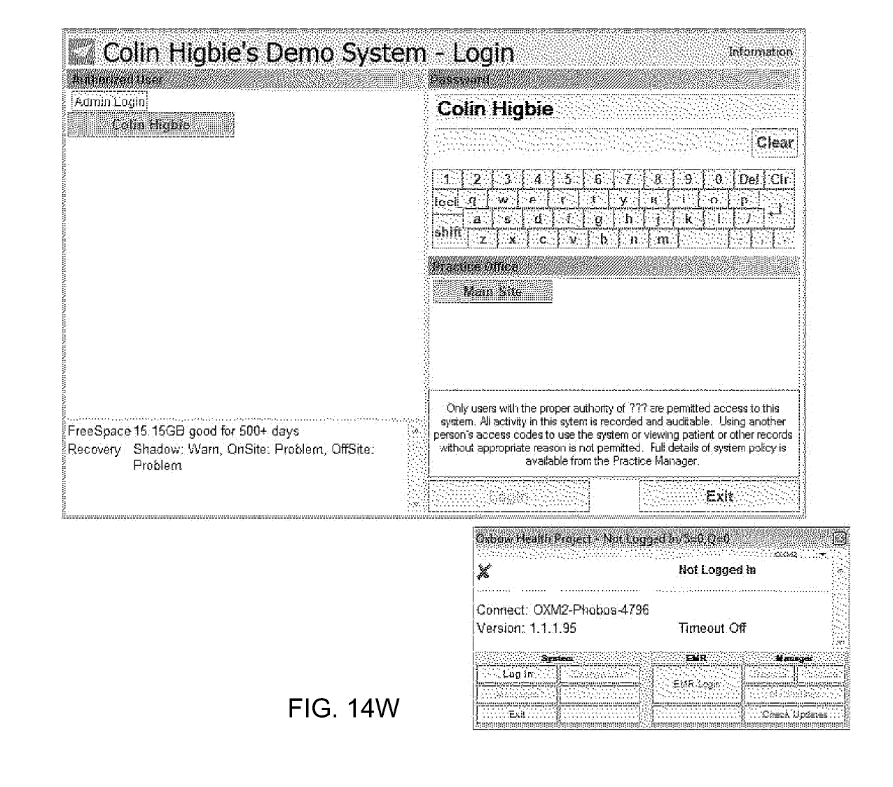

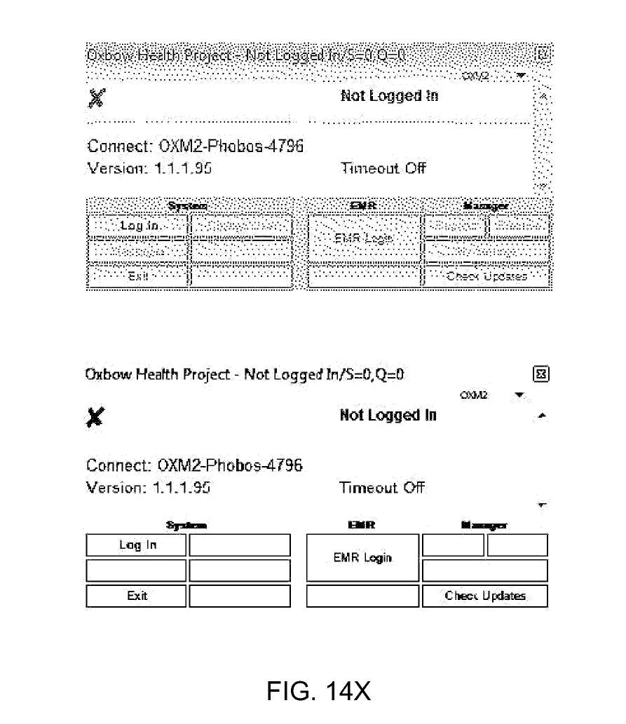

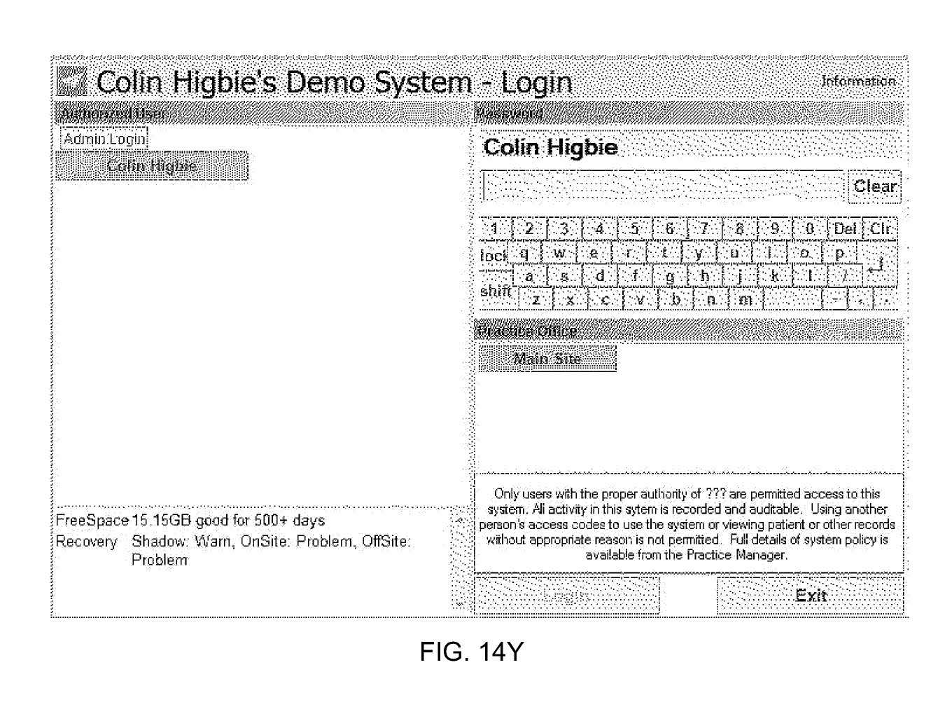

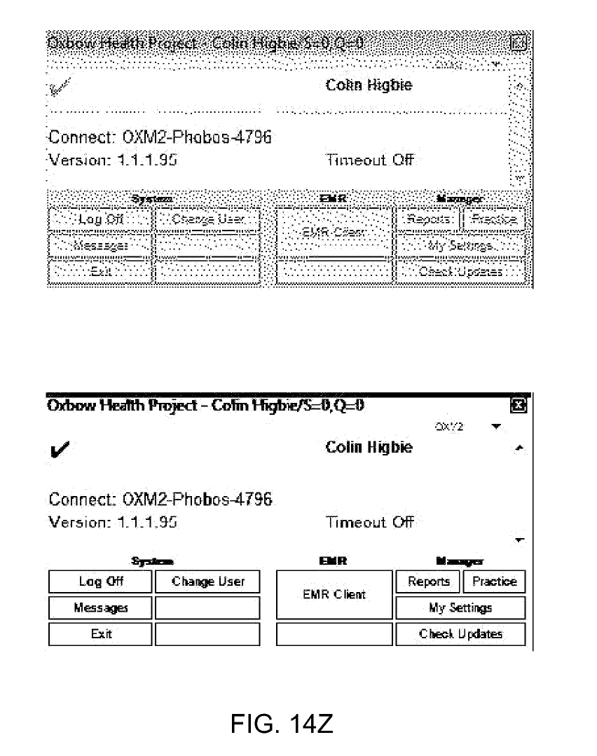

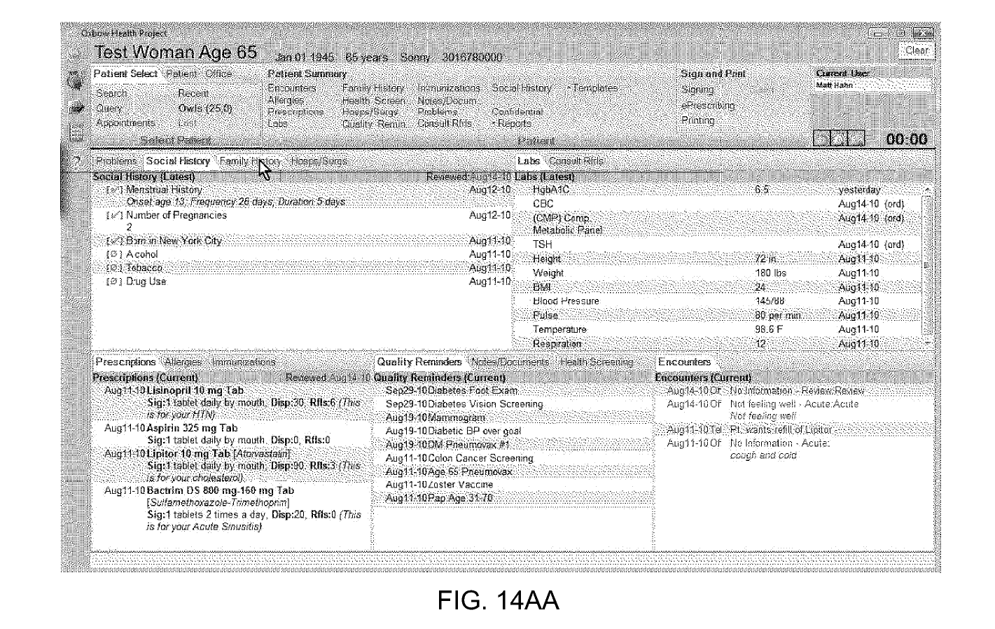

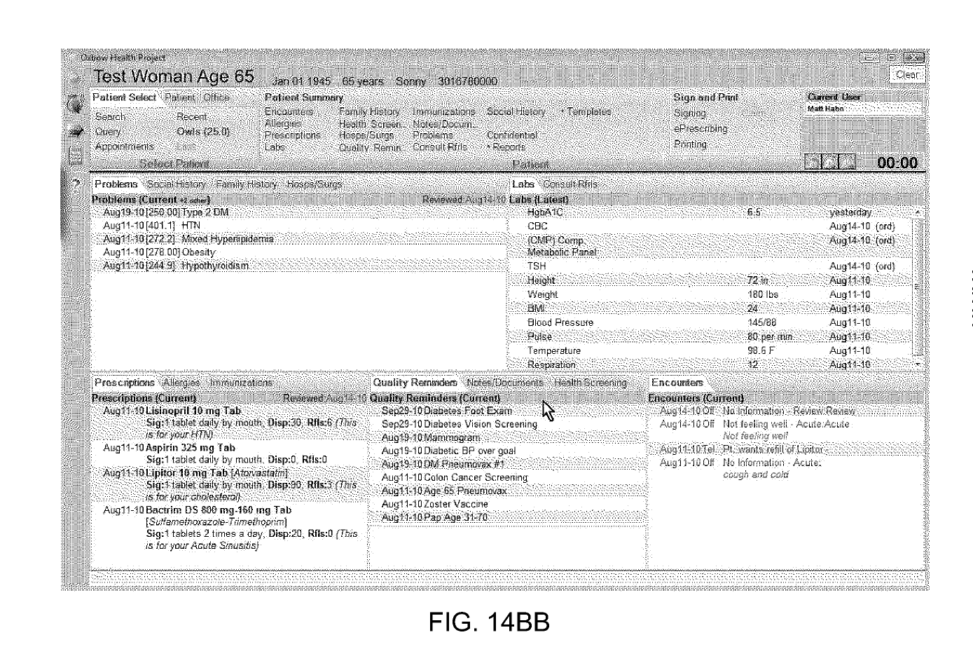

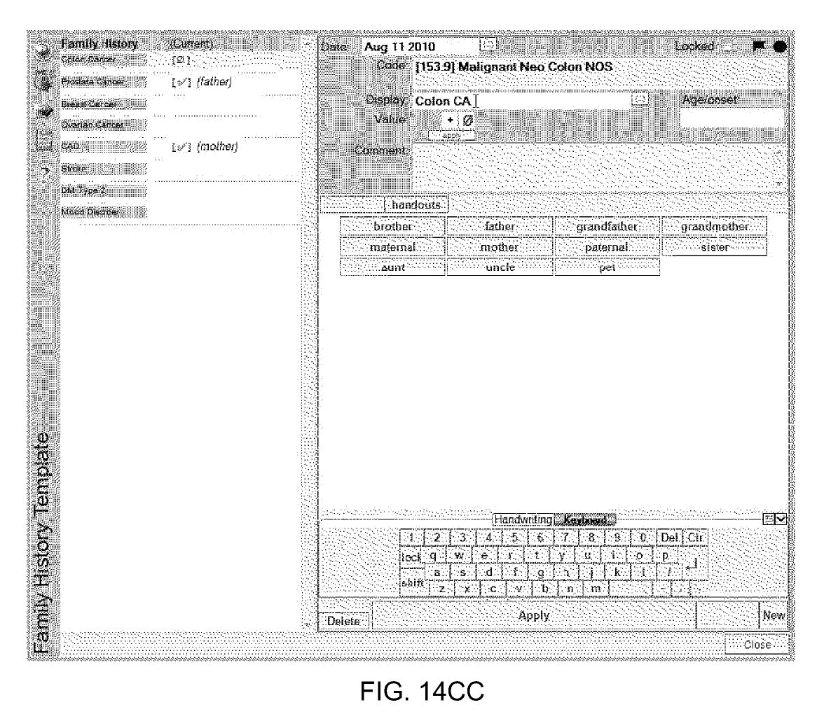

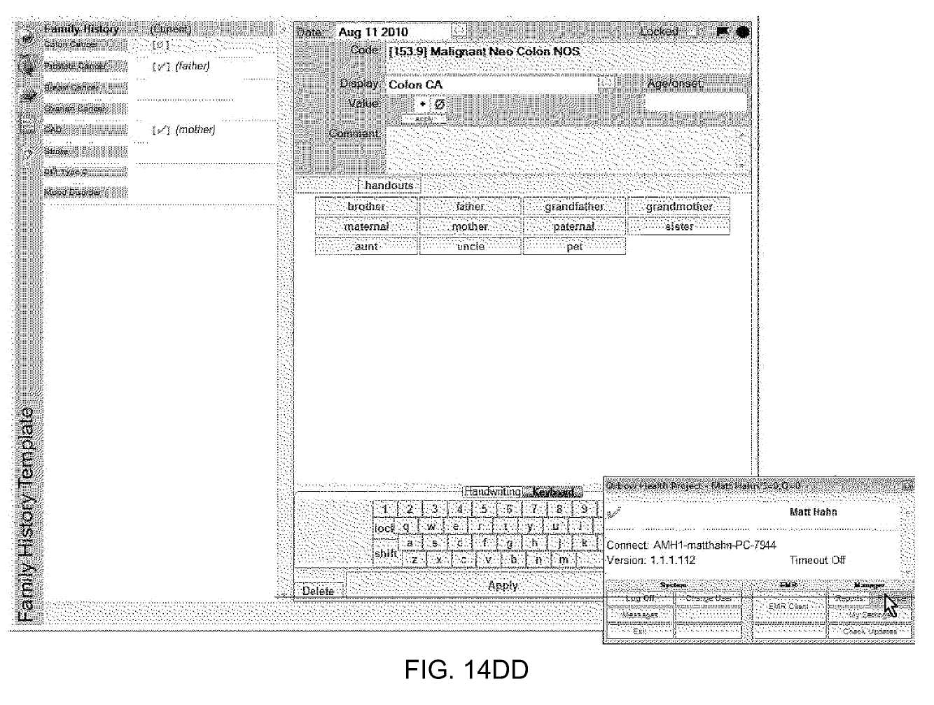

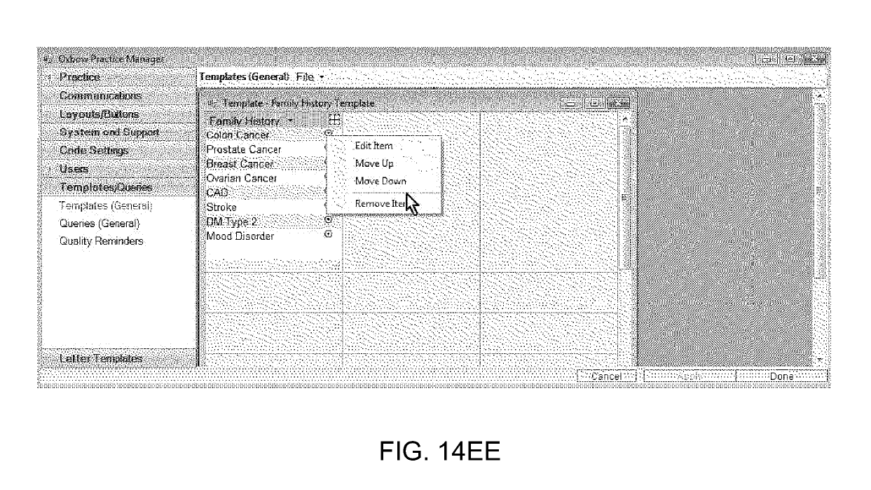

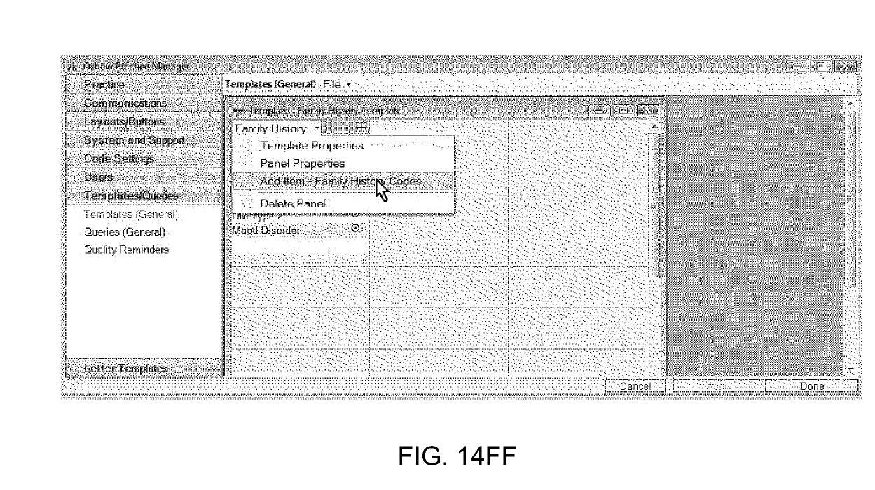

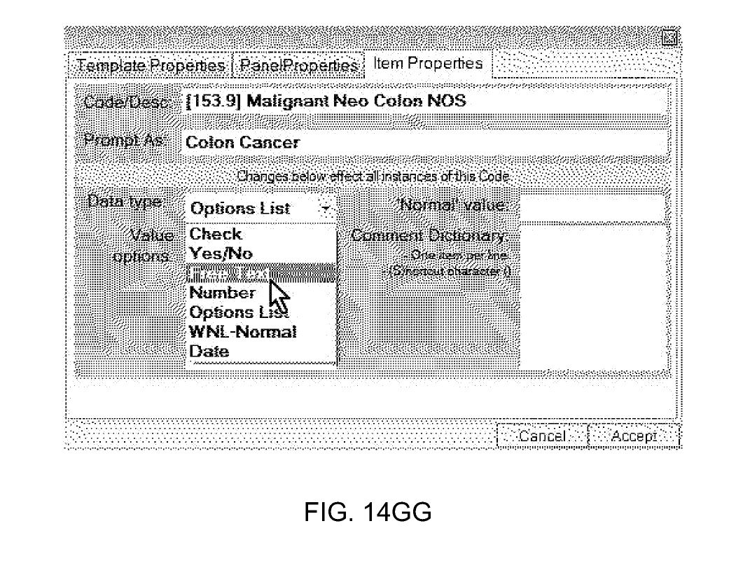

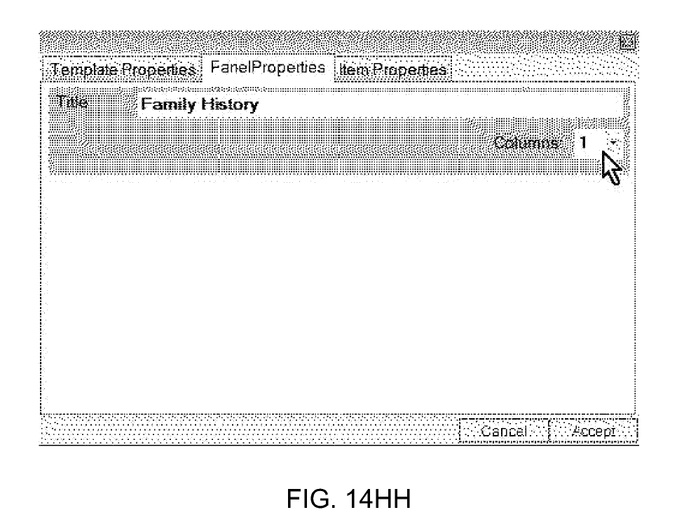

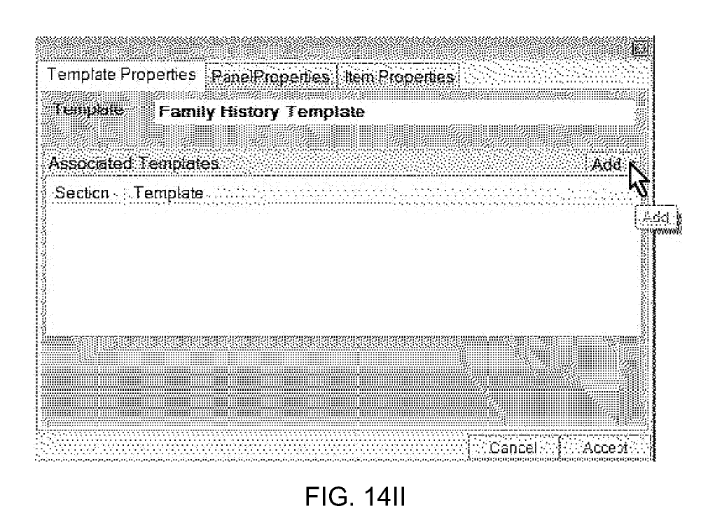

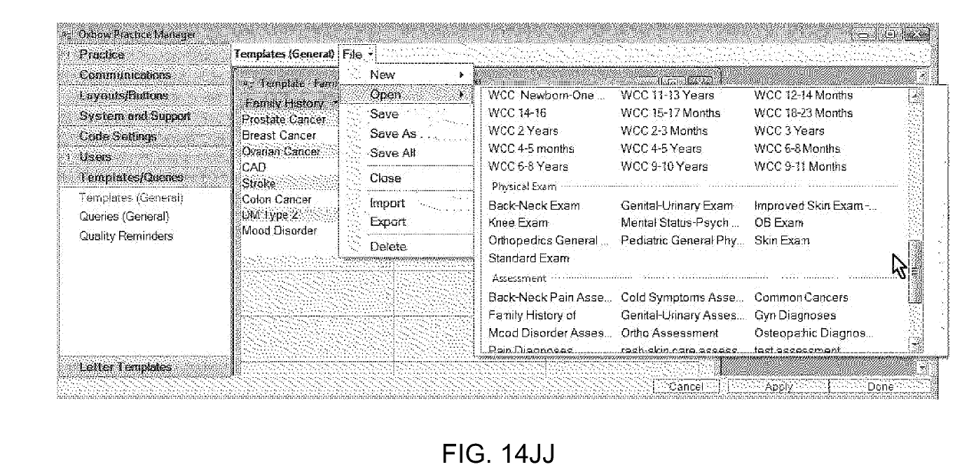

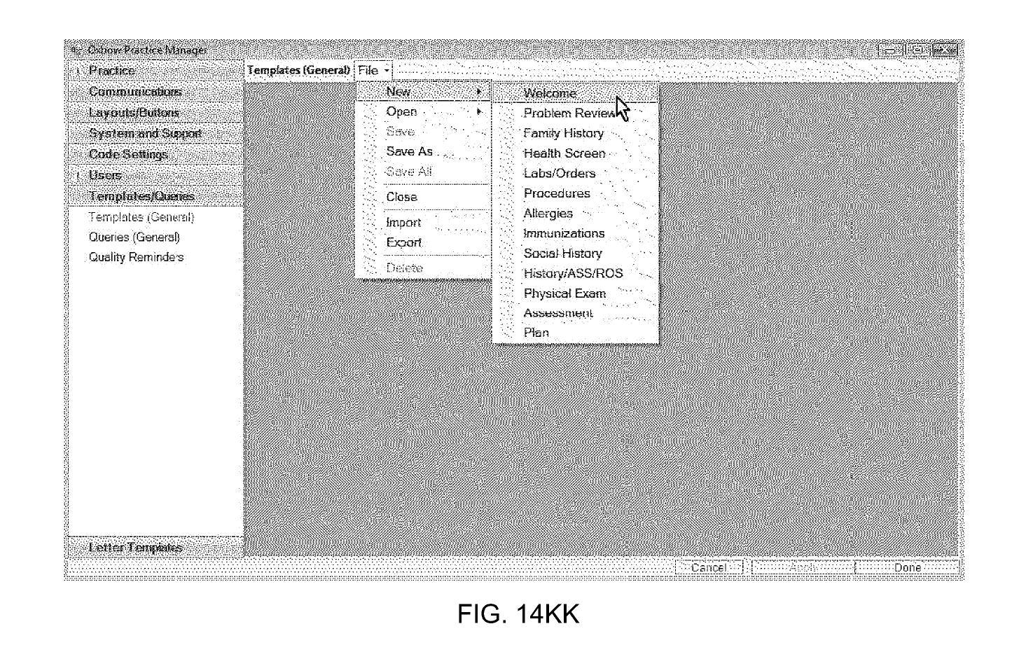

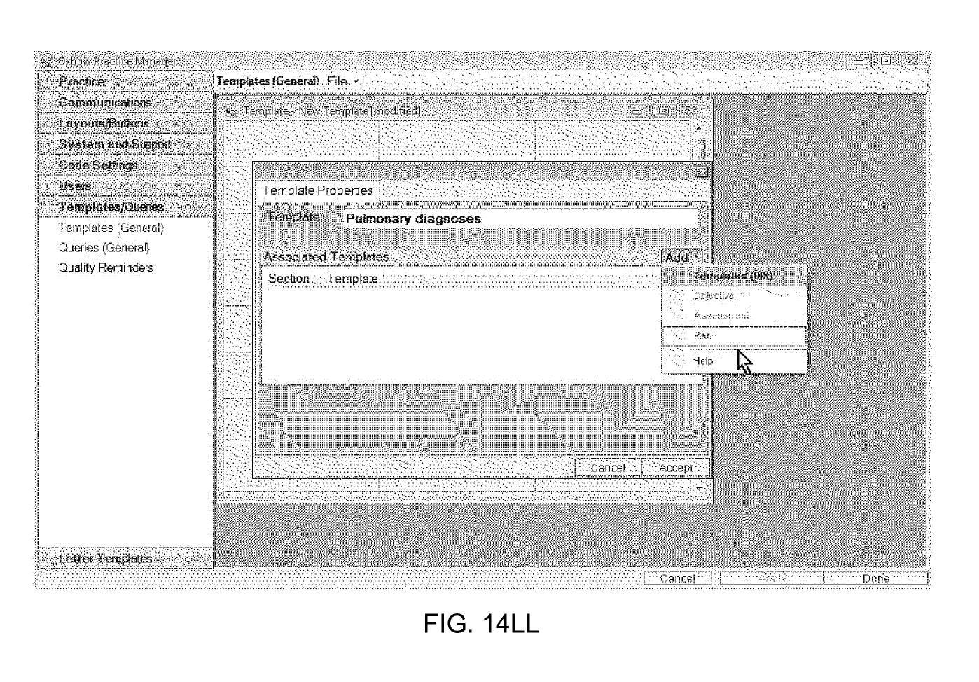

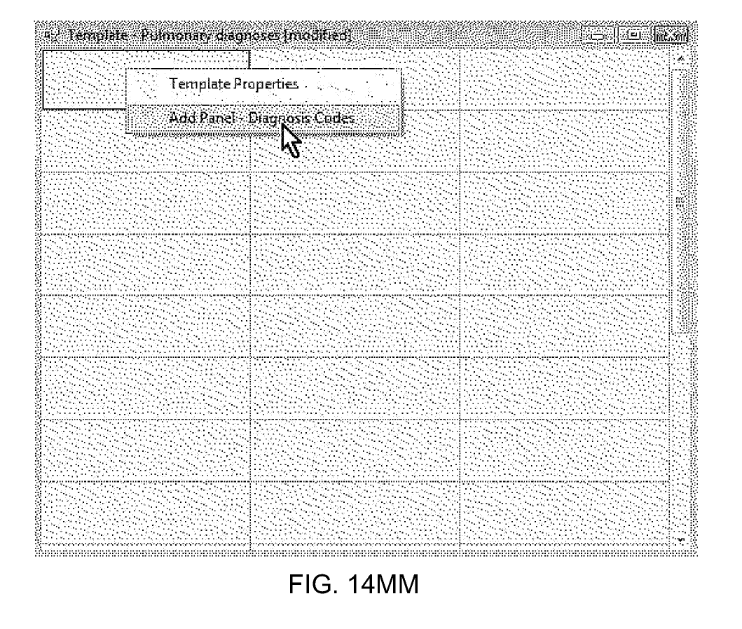

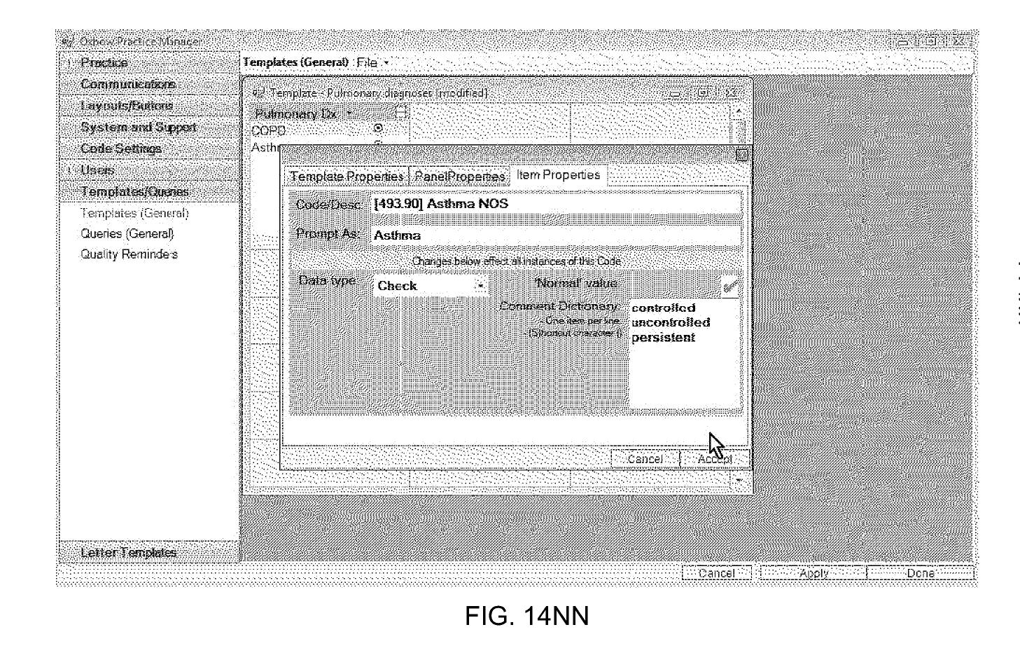

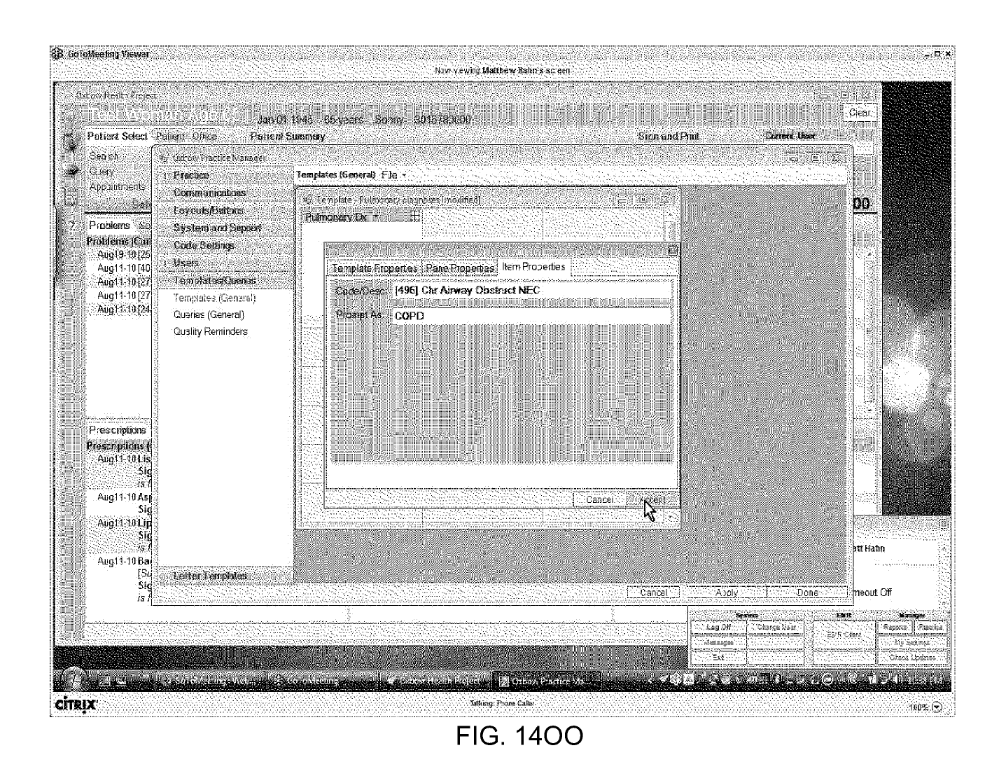

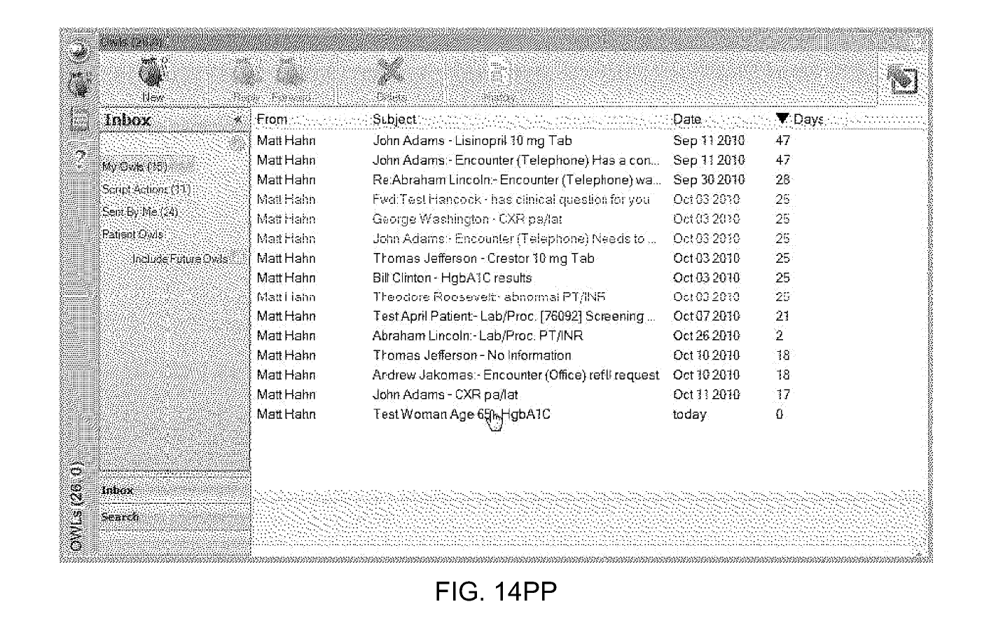

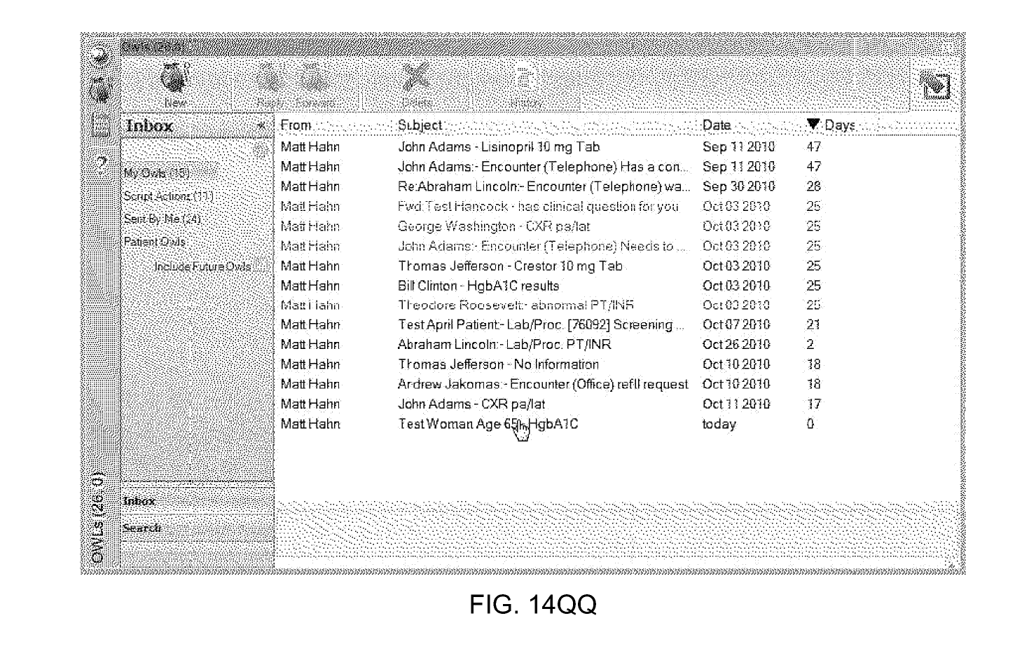

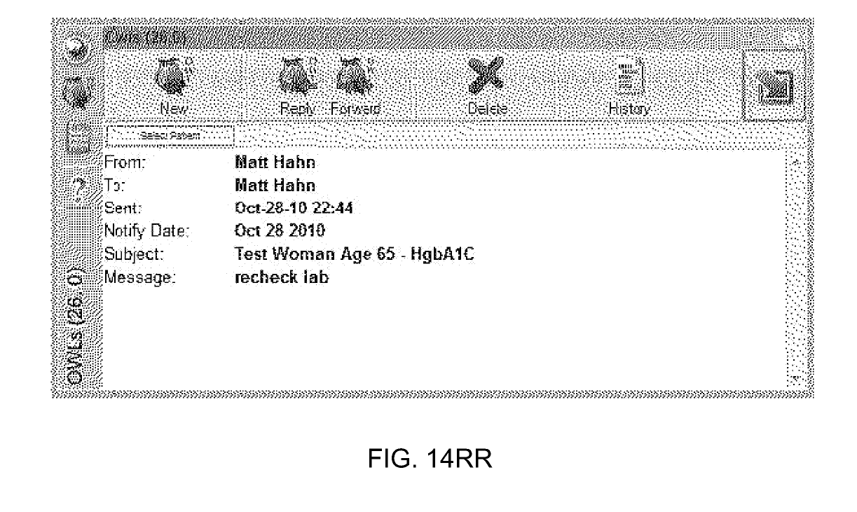

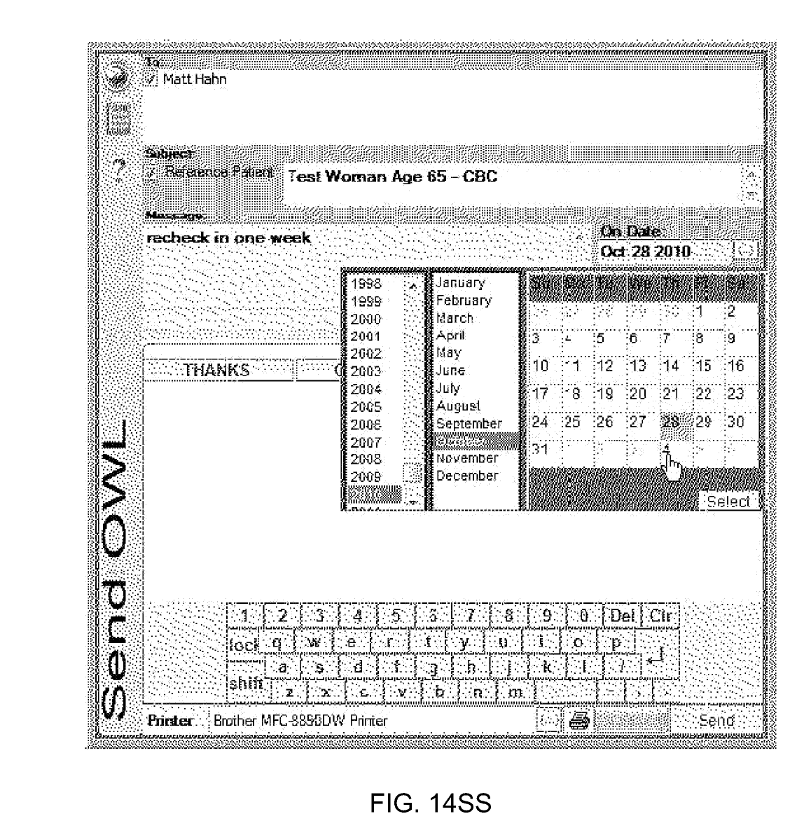

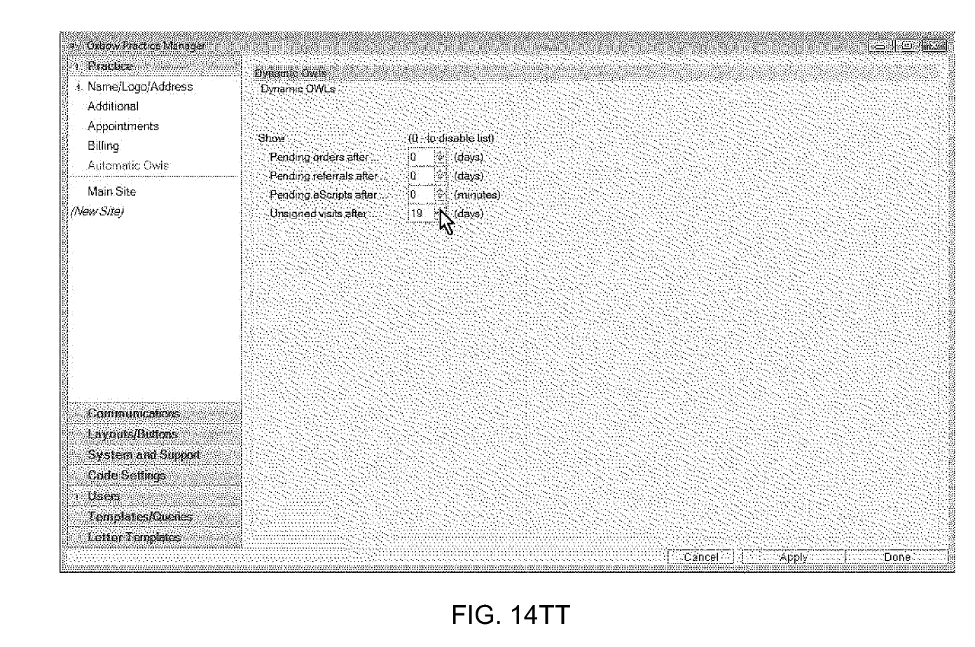

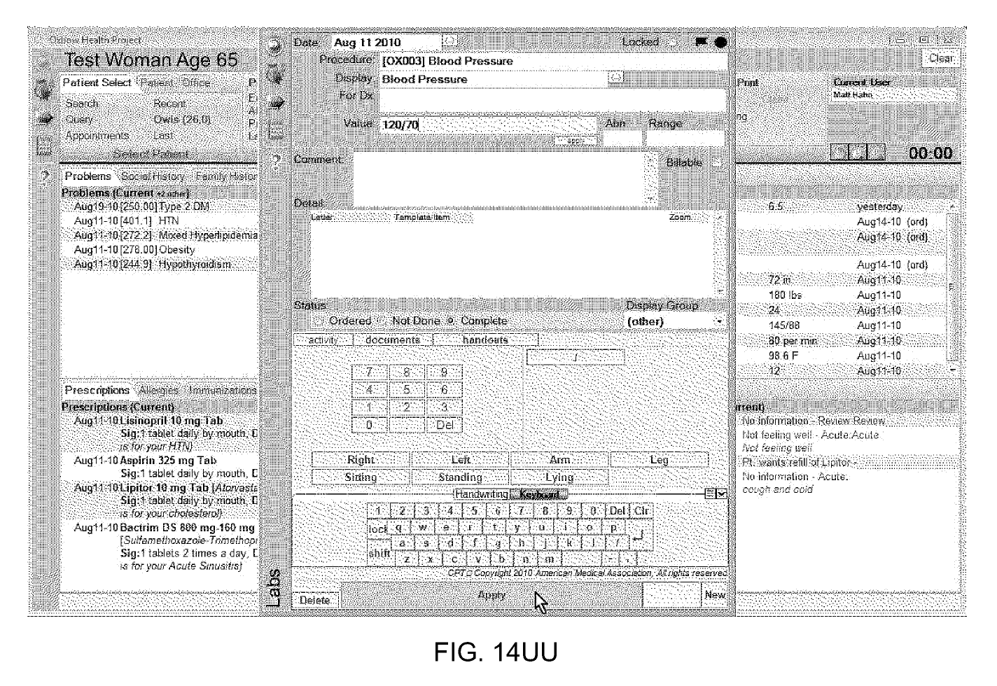

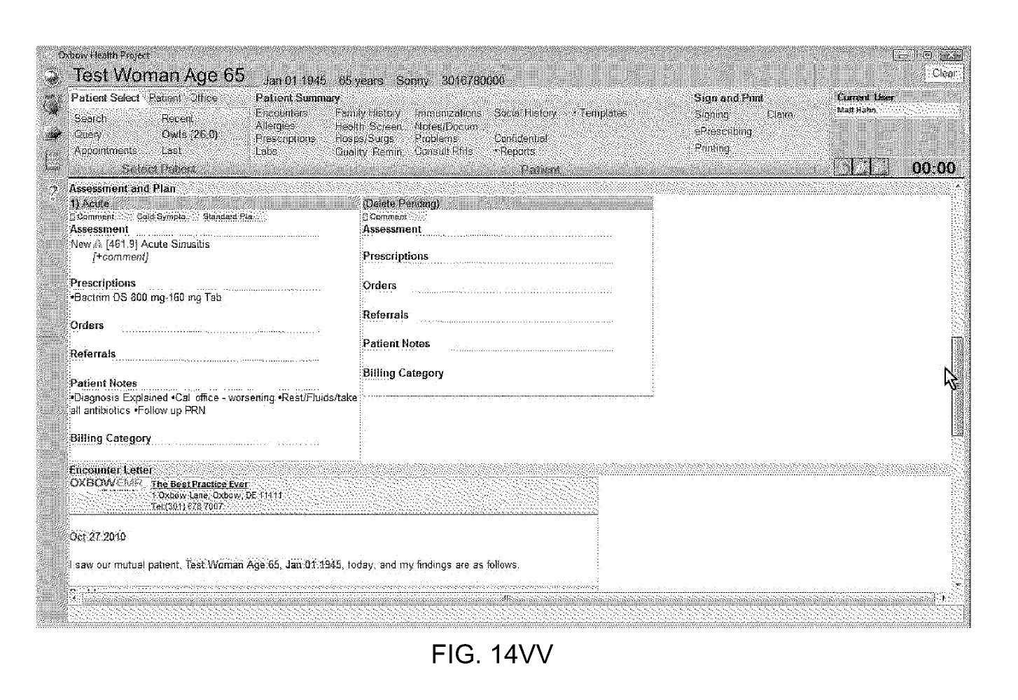

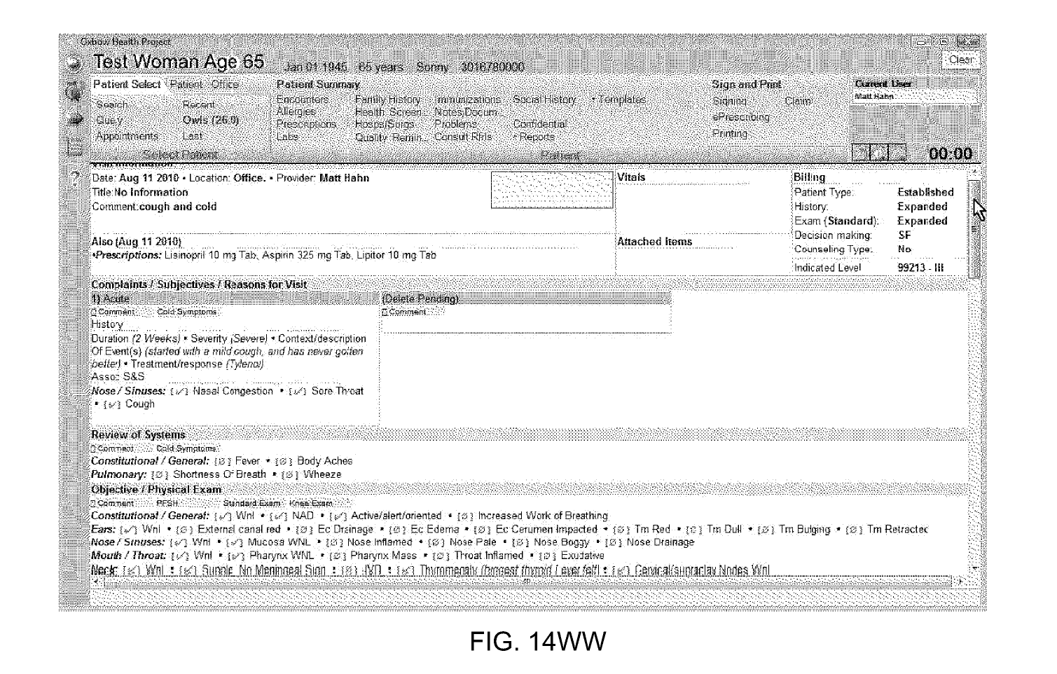

14. FIGS. 14 A-WW are computer screen snapshot photos that depict and/or capture various stages of the EMR system and method in progress. See below for description of each of the FIGS. 14 A-WW.

### FIGS. 14 A-WW

### Electronic Medical Record System and Method

A. Main window patient options
B. Main window Office options (others appear depending on configuration)
C. Main window. On Patient Summary bar at top, “Problems” highlight due to mouse or stylus hovering over, indicates this is a clickable item. All of the patient information tabs on the lower part of the page (Problems, Family History, Immunizations, Social History, Health Screening, Labs, Hosps/Surg, Consult/Referrals, Prescriptions, Allergies, Quality Reminders, Notes/Documents, and Encounters) are available here to review at any time during an encounter, such as that shown in #5 below.
D. Tapping or clicking on the Problems button brings up the Problems window. Note that it has exactly the same content as the Problems tab on the Main window.
E. Patient Encounter window. Bar at the top maintains consistent access to all information. Click on Complaints/Subjective/Reasons for Visit to see all complaints and add, modify, delete a complaint (opens window listed in #10 below).
F. Clicking on the complaint opens the associated template
G. Tap or click on the + or − to indicate objective information for the SOAP note. Clicking on any term enables entering descriptive free text to add flavor or other notes. If an item has not been noted as positive or negative, it indicates the clinician did not review that issue. This is important for subsequent review or audit.
H. Clicking on Sneezing on the cold template brings up the data entry window to enter descriptive free text or flavor.
I. After entering any descriptive free text or flavor, the note appears in parentheses after the condition. In this case, note the descriptive text after “Sneezing.”
J. To add a new complaint, click on the New tab at the top, which forces selection of the kind of new complaint (Acute, Review, or Well Visit). It is important to note that adding a new complaint requires only one additional click or tap compared with looking at an existing complaint.
K. Clicking on the Level of Visit code section on the Patient Encounter window brings up the Billing and Level of Visit Review Window. Here, the clinician can review and modify the parameters for the Level of Visit Code. These affect the billable value of the visit. In general, these do not need to change, as the system calculates the level of visit code automatically as the clinician completes the encounter note. However, in special cases, those calculations can be overridden here.
L. CMS Report.
M. Specify information for billing. Available right from the patient encounter. Enables completing and submitting billing by the physician in the seconds between patients with no need for additional personnel or a separate billing staff.

### Quality Reminders

N. Main window showing patient. In the bottom center, there is a set of Quality Reminders. These are based on all available standards of care and draw from the patient's age, gender, current medications, history (family record of cancer, smoker, immunizations, etc.), procedures, diagnoses, etc.
The results in this tab are updated in real time, meaning that if the clinician updates any of the contributing data (e.g., gives an immunization, prescribes a drug, enters results of a test or procedure) it is automatically removed from this tab.
If the physician clears this list of Quality Reminders during the patient visit, he or she has executed all of the relevant standards of care. As medical organizations such as the AMA, AAFP, etc. update or add to these standards of care (e.g., the recommended age of mammograms changes from 40 years of age to 50 years of age), these can be automatically updated from the central server, with a notice to the practice of what has changed, or they can be set manually if a given practice wishes to follow different standards.
By automating the standards of care, physicians are much less likely to make mistakes, leading to an improvement in the quality of care and reduction in malpractice incidents.
In this example, note that top item is reporting that the patient needs a Zoster vaccination. In the next 2 images, this vaccine is given, and the Quality Reminder to the physician is removed.
O. In order to clear the Quality Reminder, the physician provides a Zoster vaccination. Note that only Tetanus is listed in current vaccinations at this point.
P. Selecting Zoster vaccination. Note that it is only necessary to start typing and all matching vaccinations automatically appear.
Q. After providing the Zoster vaccination, the Quality Reminder list updates instantly and that Reminder is no longer listed. This immediate and always visible list maximizes the physician' ability to always meet all of the standards of care for all his or her patients.

### Easy Query System

R. The Query window.
S. Tapping or clicking on Select Query enables choosing existing general queries, reviewing Quality Reminders, or creating a new Ad-Hoc Query on the fly.
T. Creating a new Ad Hoc query is as simple as selecting the gender, age, physician, and current diagnoses or prescriptions. This allows for proactive care by, for example, easily finding all patients that are taking a combination of drugs where a new drug-drug interaction has been discovered. Another example is finding all high-risk patients for a virulent strain of the flu to come in for vaccinations.
U. In this example we find all children 4 or under, all adults over 65, and any HIV positive patients of any gender seeing any doctor at the practice.
V. To add or specify the query criteria, just select from the available options. No database experience or programming is required. This is important, because if it's not easy, physicians and practices won't use the feature. By making this easy and fast, it will be used, physicians will proactively contact patients, and the overall health and well-being of that practice's patients will improve.

### Logging in and the Launch Window

W. The Login window and Launch window as they appear when starting the program. The last logged-in user appears pre-selected in the upper right.
X. The Launch window as it appears before a user is logged in (shown both in native and high-contrast modes). Note that only the Log In (including the EMR Login), Exit, and Check Updates options exist before a user has logged in. EMR Login is the same as Log In, but it also automatically opens the Primary Patient Screen upon logging in. It is the same as hitting Log In and then the EMR Client button, which replaces the EMR Login button, after logging in.
Y. The Login window. The last logged-in user appears pre-selected in the upper right. A button appears in the pane on the left for every user registered on the system.
Z. The Launch window after a user has logged in. Additional buttons may become available in certain configurations, including a patient scheduling option.

### Main Window/Patient Summary Screen

AA. A view of the main window or Patient Summary Screen.
BB. A view of the main window or Patient Summary Screen.

### Templates

CC. Family history template allows setting all family history in one window. Common items on left. Display name changed from code to common name “Colin CA”. Configurable and context sensitive Dictionary Terms buttons visible on the right (“brother” “father” etc.). Similar templates available for all aspects.
DD. Using the launch window, selecting Practice will open the Practice Manager, which gives access to the template editor.
EE. From the Practice Manager, selecting Template/Queries and then opening the desired template for editing, Select which common items make up the template. Different practices may see patients with different common family history issues and so can easily add or remove items from the list. They can also be ordered for convenience based on the user's preferences.
FF. From the Practice Manager, selecting Templates/Queries on the left enables the user to edit, delete, or create new templates. Here the user is selecting the panel title to add an item to the panel or edit the panel of the currently open template.
GG. Editing or creating an individual template item includes a drop down for available data types, an option to set “Normal,” which controls what its value is set if the user selects WNL (Within Normal Limits) for this panel, and Dictionary Terms for quickly entering free text.
HH. A panel can be set to include multiple columns.
II. Subordinate templates (Objective, Assessment, or Plan templates) may be added.
JJ. Open any template to edit or use as a basis for creating a new template, using Save As after editing to save it as a new template.
KK. Create a new template from among several categories (Welcome, Problem Review, Family History, Health Screen, Labs/Orders, Procedures, Allergies, Immunizations, Social History, History/ASS/ROS, Physical Exam, Assessment, and Plan).
LL. Building a new template from scratch, in this case a Problem Review, denoted by the DIX.
MM. Building a new template from scratch, adding a new panel.
NN. Example of adding an Asthma item, with the coding and billing name of 493.90 Asthma NOS, a common name of Asthma, data type set to check, and 3 dictionary terms listed for adding free text to capture the patient's description or “flavor”.
OO. Example of adding COPD to template. Also this example shows the Launch window in the lower right and the main window behind.
   OWLs—Outstanding Work List, the internal messaging, task/To-Do, and alarm system
PP. Sending a note to self to recheck lab. If other practice employees were listed in the “To” box at the top, one or members of the staff could be selected to receive. Changing the date, sets the delivery date, making the alarm system just a dated OWL. The flag allows color selection for practices to use for their own workflow differences. The color selected here will be the color the OWL title appears to all recipients. Dictionary terms below allow for quick-click selection of common messages. As in all data entry windows, the Handwriting or Keyboard option lets the user write on the screen with the stylus or type. Newer versions of the program include a “Dictation” option which uses speech recognition in the same way.
QQ. A sample list of OWLs. The dimmer OWLs (may not be visible in B&W reproduction) are a different color, used in this case to signify urgency.
RR. Opening an individual OWL includes options to reply, forward, spawn a new OWL, or review the history of associated OWLs, effectively this OWL's conversation threads.
SS. Setting the delivery date for an OWL defaults to the current date, so if selecting for later in the month, only a single date tap is needed. Setting further in the future requires also tapping on the desired month or year.
TT. Automatic or Dynamic OWLs can be triggered by various system events. In this example the user is setting to receive an OWL if the lab results have not been added to the patient record within 19 days.

### Example Windows

UU. Lab results.

### Encounter Notes

VV. Encounter note showing Assessment, Plan, and letter or referral note.
WW. Encounter note showing Level of visit code so the physician always knows what the billable results will be for patient (in this case, 99213 or Level III), the patient complaint (just cold symptoms), and the doctor's review of systems notes, filled in from the data entry windows when examining and questioning the patient In response to each complaint.

15. My Medical Facts Report

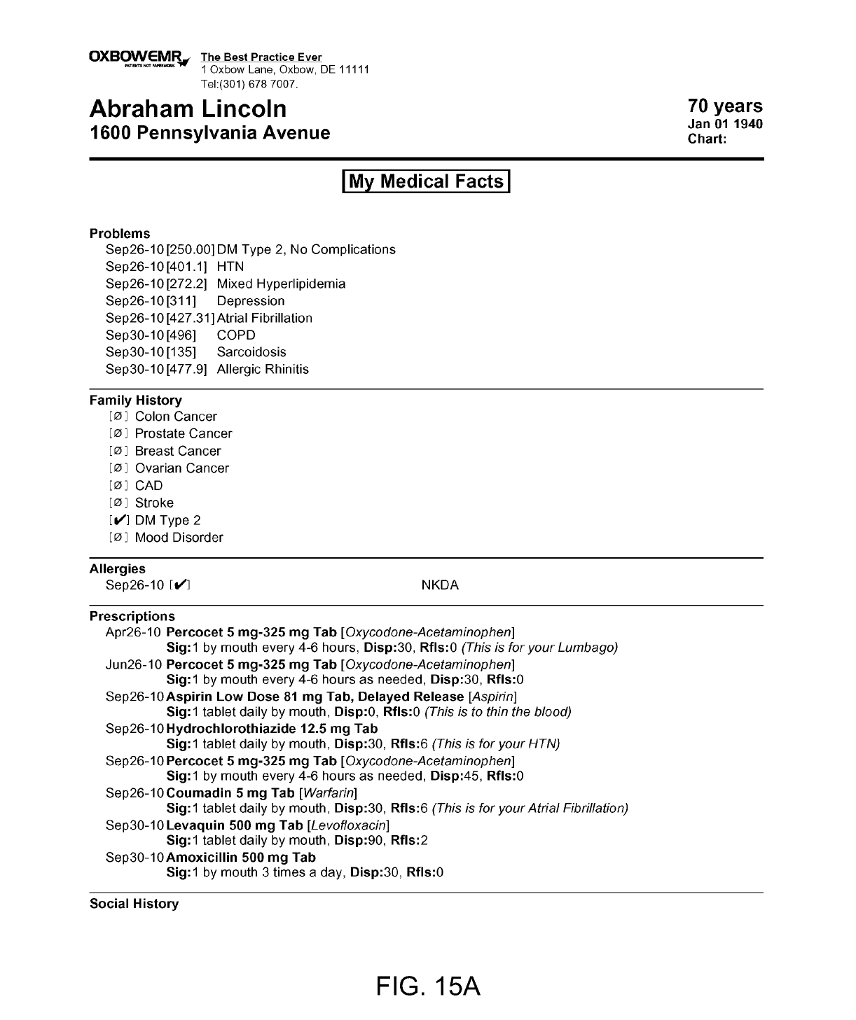

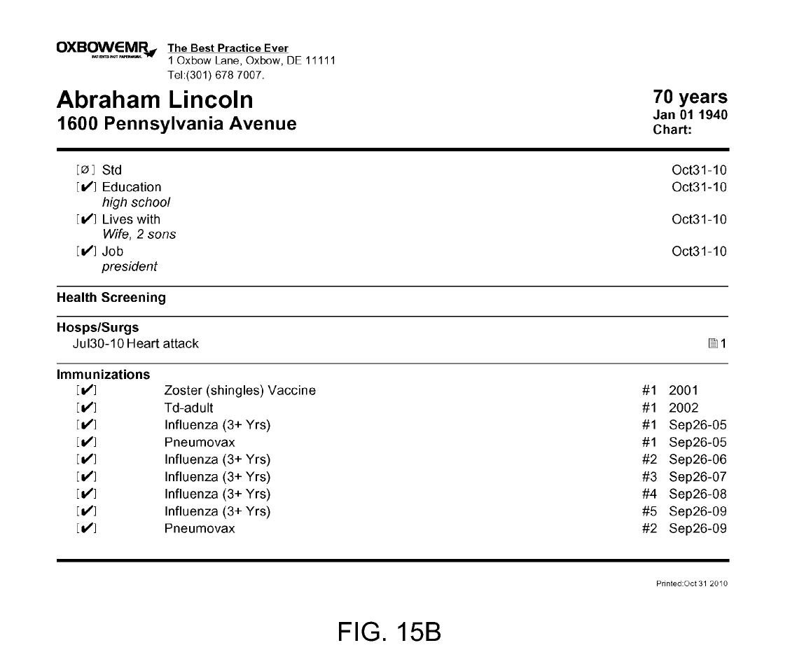

FIGS. 15A and 15B depict a “MY MEDICAL FACTS REPORT”

My Medical Facts is a real-time compilation of all of a patient's medical information, which can be printed, either for the patient or their family to have, or to send to referrals, along with consult notes, so that we never have to re-enter a patient's history. Since My Medical Facts compiles automatically, and in real time, it can give our patients updated medication lists anytime a medication is changed.

My Medical Facts can be accessed from at least two areas: first, My Medical Facts is available as a Report, so click on Reports, and then check My Medical Facts. Essentially all of the patient's pertinent information is all in this one report. It can be printed from this screen.

My Medical Facts can also be available from the Print screen. Click on Printing, then click on My Medical Facts, and then print.

Next follows some examples of the actual use of the inventive EMR system. It is noted that after inputting or modifying any information in the inventive EMR system, the user can click apply to save and update and continue or close the window, and click done to save and update and to close the window. Also, click can mean click a mouse (or mouse-like apparatus), enter into a keyboard, touch a screen, use a stylus, voice recognition, or other means for making a selection. Also, there are a number of ways to enter patient data, e.g., free text, searchable pick lists, and customizable templates, or a some combination of these.

An advantage of this EMR system is that the need for screen changes is minimized, i.e., the Patient Summary Panel can exactly mimic the content and function of the Patient Summary Screen. The purpose is to allow access to Patient Summary information even when using the Encounter Note screen, so that the need for screen changes are minimized. So there is not a lot of screen after screen after screen; all the information is pretty much set up from the patient summary screen and the user can spring from that screen to all other stuff she wants to do.

One optional feature of the screens is that any item that lights up, changes color, or alters the pointer when the cursor passes over it, is active, or has some underlying function if the item is clicked. Other items, such as the patient information at the top of the screen, can be static and unchangeable.

### 1. Starting the EMR Program

To start the EMR program of the present invention, launch the EMR client from its group on the Microsoft® Windows® Start menu, from the desktop icon, or from the Taskbar icon.

The Login screen automatically appears. To Log In, select your user name and enter your Password. Then either click Enter on the keyboard, or click the Login button.

Alternatively, the other functions that are available before logging in are exiting the program or checking for and installing updates, as denoted by their respective buttons being active on the launch window.

Once logged in, there is full access to the EMR Launch Window, from where it is possible to:
1. Log off, or Change User(s)
2. Access the EMR Manager, to customize system settings, screen appearances, templates, queries, and data entry shortcuts (referred to herein as “dictionary terms”); download software updates; or create data Reports.
3. Start the Client (or, the clinical portion of the EMR program) or check an Appointment list.

To Log Off the current user of the EMR program without exiting the EMR, re-open the Launch Window if needed by clicking on the appropriate EMR icon, which is the Paper Airplane shown in the figures, in the task bar or system tray. To log off, simply click on Log Off.

### 2 Creating a New Patient Record

This can be created by the patient or any of the medical staff or professionals.

From the EMR Client, there are three tabs in the upper left: Patient Select, Patient, and Office. Click Patient. And then click New Registration.

This is the Patient Registration screen.

In one example of data entry format:
1. Any pink field in an EMR data entry screen is a required field. So enter data into each of the pink fields.
2. Certain fields on this registration screen have a required format, and if the data entered is in an incorrect format, the field will turn pink.
   1. For instance, in the social security number field, if a letter is entered and the Tab key is clicked, the field turns pink. And, on the lower right of the screen, an error description appears.
3. Some of the fields have data entry shortcuts, or dictionary terms, available.
   1. For instance, in the “Sex” field, there are available dictionary terms, Male and Female, and if “m” is entered the word Male becomes available. The term can be clicked, or if there is only one term showing, the tab key can be clicked, and “Male” will be entered in the field.

Here is an example where the new client entry is named Abraham Lincoln:

In title, enter “Mr.” When the entry is complete, click the Tab key.

Tab to First Name, and enter “Abraham.” Then click the Tab key.

Tab past middle name, to last name, and enter, “Lincoln.”

Tab past suffix. Calling Name is a filed to enter a patient's nick name, or any other name they go by. Enter, “Honest Abe.”

In Sex, enter an “m,” and click the Tab key. “Male” automatically is entered.

Enter the Birth Date. For example, an allowable format includes the month-slash-day-slash-year, or the date can be written out.

Enter a patient identification number, such as a 9-digit social security number.

Enter a marital status. A predetermined list of available dictionary terms, or picklist can be accesses by clicking space, and then backspace. Click on “married.”

In the status field, the default entry is “current”, but a predetermined list of available dictionary terms may be useful. To list the available dictionary terms, click space, and then backspace, and a picklist of the available terms displays.

Enter the Address: “1600 Pennsylvania Avenue.”

Enter the city, “Washington.”

The format for the state is the two letter state abbreviation, so enter “DC”.

For the Zip code, the format is a 5-digit number, so enter “20015.”

For the phone number, the format can include digits and parentheses. Enter the numbers “2025556615.”

For the email address, the format requires an at sign “@” and a period. Enter “abe@washington.testpatient.”

And finally, under Ethnic group, a variety of dictionary terms can be available. Click the space and the backspace and choose “Caucasian.”

Now, before opening Abe Lincoln's patient record, click Confirm Changes, and then Select Patient.

And now, Abraham Lincoln is registered as a patient, and the screen exhibits Abraham Lincoln's patient record.
1. Some of the information entered can appear at the top of the screen, which can be quite helpful. What appears here can be easily customized.
2. To see a patient's registration information, without switching screens, and without intending to make any edits, double-click on the patient's name, and a registration information screen will display.

### 3 Editing a Patient's Registration Information

To edit a patient's registration information, or re-open the Patient Registration screen for any other reason, click the Patient tab, and then click, Edit Registration.

Then make any appropriate changes the same way data was entered to Create a New Patient record, above.

For example, add a second phone number, Abe Lincoln's cell #, 202-555-0909.

Click Confirm Changes, and then Select Patient.

### 4 Searching for a Patient Record

There are a number of convenient options to locate a patient record.

Search options are all located within the Patient Select tab. Click on that tab.

For example, here are 3 options to locate a patient record.

We have Last. When we hover over this button, what appears is the name of the most recent patient record that we accessed prior to the current one. If we click on Last, we are taken to that record.

The second option is Recent. When we click on Recent, we get a list of the most recent patient records that have been accessed. To access a patient record, we merely click on the listing.

And finally, we can Search for a patient record.

We click on Search, and in the Patient Search field, enter the patient name.

After we enter 3 characters, we begin to see a list of patient names that match our entry. We can continue to hone our search by adding more characters. One way to search is to enter a few letters from the first name, then a space, and then the first character of the last name. This almost always locates the right record.

We can also search using additional options, such an address or phone number, by clicking on Additional Options.

Click on the name of the patient whose record there is desired to be accessed.

### 5 Orientation: the Primary Work Screens of the EMR Program

The EMR program is divided into a clinical portion, the EMR Client, and an administrative portion, The Manager.

In the EMR Client, there are two primary screens where most work takes place: the Patient Summary Screen and the Encounter Note.

A patient record in the EMR program can open to the patient's Summary Screen.

The Patient Summary Screen displays all of a patient's important medical information in one screen, e.g.: diagnoses or Problems, Social History, Family History, Hospitalizations and Surgeries, Medications, Allergies, Immunizations, Labs/Procedures, Consultant's Notes, a Quality Reminders panel, and all Patient Encounters.

The location of the various tabs can be customized by each user. Similarly, the content of the Patient Identification information at the top of the screen, as well as the location of each of these buttons on the Patient Summary Panel, can be customized.

The second primary work screen of the EMR program is the Full Encounter screen which can be used to enter SOAP (Subjective, Objective, Assessment and Plan) notes.

To access a previously entered note, merely click on the entry, and the Encounter Note screen displays.

The top of the note can display general visit information, as well as the chief complaint. Also an automated level of visit calculator can be included. In one example, it is located on the right hand side.

Next, the note can display a history of present illness, associated signs and symptoms, and a review of systems, arranged by body system.

Further down can be displayed the objective section, with physical exam findings, arranged by body system.

And then, at the bottom of the note, can be displayed the assessment and plan.

To get back to the Summary Screen, just click on Patient Summary.

A number of other screens can be included:

One is a data entry screen: this screen can be used to enter information in every aspect of the Patient Summary Screen, as well as certain aspects of the Encounter Note.

Another is the E-prescribing module.

There is an OWL, or outstanding work list.

And there is a Signature Screen, and a Printing Screen.

The top panels of the Client portion can remain constant.

The Patient Summary Panel can exactly mimic the content and function of the Patient Summary Screen, down below. The purpose is to allow access to Patient Summary information even when using the Encounter Note screen, so that the need for screen changes are minimized.

A panel can include a visit timer, to time patient encounters, and a Clear button, which allows the user to clear the screen of any patient-related information, to protect sensitive patient information. This panel can be on the right, for example.

### 6 Orientation: Navigating in the EMR Program

There are a number of icons and concepts that can be useful in this regard.

There are active, or functional, items on the screen, and there are static items on the screen. In general, any item that lights up, changes color, or alters the pointer when the cursor passes over it, is active, or has some underlying function if the item is clicked, while other items, such as the patient information at the top of the screen, is static, or has no underlying function. The choice of active and static items is customizable.

So, for example, click on the patient's date of birth, nothing happens.

On the other hand, click on Quality Reminders, and a new panel opens up.

Other navigational item includes: the Back button and the exit button.

One or more screens within the Client portion can include a Back button, at the upper left corner, for example. Clicking on the Back button takes one back to the previous screen.

Many screens can also have an Exit button, at the top right, for example. Clicking on the Exit button closes the screen.

Each section on the Summary Screen is a panel, and each panel contains a number of tabs. Clicking on a Tab brings that topic to the forefront.

Each Panel has a Heading and each panel has its own panel menu. Clicking once on the panel heading, or twice on the tab itself, will open the panel menu. Close this menu either by clicking here on Exit, or by clicking anywhere outside of the menu.

Next, hovering over any line item within the panel results in a target appearing, to the left, for example. Clicking on the target opens the item's menu.

Click directly on a line item, it opens that item's data entry/edit screen, where information can be added, altered or even deleted.

Any function available on the summary screen can be exactly replicated at the Summary panel. This allows data entry on one screen and access to information on another. For example, when working on a SOAP note, the Patient Summary information can be accessed, or new information added, without having to leave the SOAP note screen.

### 1 Introduction to the Patient Summary Screen:

The Patient Summary Screen can be used to enter, view, and maintain a patient's basic medical information, including past diagnoses or Problems, their Social History, Family History, and their history of Hospitalizations and Surgeries; Medications, Allergies, and Immunizations; their Labs, Vitals, and other Procedures, create referrals and store Consultant's Notes, and important patient documents.

It can also include an automated, patient-specific, Quality Reminder.

It can also be used to create brief patient notes and list all patient encounters.

Patient data can be entered using a combination of free text, searchable pick lists, and customizable templates.

### 2 The Data Entry and Edit Screen, and Opening the Data Entry and Edit Screen:

The Data Entry and Edit Screen is a screen to enter patient data for each section of the Patient Summary screen.

It is especially helpful when the data entry screens for the different types of patient data on the Patient Summary Screen are as similar as possible.

The data entry and edit screen for the patient's Problems, or past medical diagnoses can look quite similar to the data entry and edit screen for Family History.

When the data entry screens for the different types of patient data on the Patient Summary Screen are as similar as possible, proficiency at entering one type of patient data, will enable quick proficiency at entering all aspects of the Patient Summary screen data.

To open the Data Entry and Edit Screen for Problems, or past medical diagnoses, click on the Problems Panel heading (alternatively, click twice on the tab itself), and from this panel menu, click New Entry, and now the Problems data entry and edit screen is open.

One way to close this screen is by clicking the Back button.

To open the Data Entry and Edit Screen for Family History, click on the Family History tab, and then the Family History panel heading (alternatively just click twice on the Family History tab), and from the Family History panel menu, click New Entry, and the Family History Data entry and edit screen is open.

In an advantageous embodiment, anything that can be done on the Patient Summary Screen can also be done from the Patient Summary Panel.

### 3 General Orientation to the Data Entry and Edit Screen

As in part 2 immediately above, open the Problems Data Entry and Edit Screen. Double click on the Problems tab, and from the Problems panel menu, click New Entry, and the Problems data entry and edit screen is open.

Along the top of the screen it is convenient to have the current date. The date can be changed, if appropriate.

Data entered on the screen can be locked and unlocked as necessary. Certain types of information, like an Encounter Note, will lock after the entry has been signed. Sometimes, it may be necessary to unlock an entry to edit it.

Special visual attention can be drawn to an item by flagging it, or changing its color.

The Code field is for an item's official code. So, for instance, with Problems, or diagnoses, the code used is usually an ICD-9 coded diagnosis (ICD-9 refers to the 9^{th} version of the “International Classification of Diseases” or “International statistical Classification of Diseases and related health problems” and is the standard identification system for enumerating diagnoses).

In one example, a patient suffers from chronic obstructive pulmonary disease (COPD). In Search, enter Diabetes, and it yields the official ICD-9 terminology for Diabetes Type 2. The possible matches appear in a list below the problem as you type. Click on the desired item in the list that appears, and the ICD-9 code and official ICD-9 language appears in the Code field.

The Display field is how an item will display on the Summary Screen. By default, the Display field is automatically the same as the Code field, but there is an option to change how an item will Display, or even to use non-coded information, and use this field to enter a free text entry.

For example, if the designation “DM Type 2,” is preferred, the Display can be changed accordingly. The Display is what will actually display on the Summary Screen.

In the Value field, there can be an option, if applicable, to indicate whether an item is positive or negative. For example, with Family History, you can indicate whether there is a positive or negative family history of a diagnosis, and on the Family History data entry and edit screen, there will be a positive and negative value to select.

There can also be an option to indicate whether a diagnosis is Acute or Chronic, just by clicking on one or the other. This can be helpful to view diagnoses in various ways, such as just the acute diagnoses, or just the chronic diagnoses.

In the Comment field, there can be an option to add a free text comment to our diagnosis, which can be very useful. An example entry is: “Diet controlled.”

With a Handouts button there is an option to add or access an existing patient education handout related to the specific diagnosis.

It is helpful for the templates to use data entry shortcuts, or dictionary terms, to assist in more quickly populating the fields. There can be custom and automatic dictionary terms, such as each of the words from the Code field can be entered just by clicking. The Comment field would usually have some custom dictionary terms specific to the particular doctor's practice to use as an optional data entry shortcut.

Some users may find it helpful to have the keyboard on the window to key in data by stylus when working on a tablet without a keyboard. Other tablet users may prefer to write their notes out. Click on the Handwriting button, which switches from the on-screen keyboard to handwritten entry of information.

The two small buttons to the right of the Handwriting and Keyboard buttons allow specifying the keyboard layout and other options, or closing this part of the window to expand the viewing area of the Data Entry and Edit window.

In some editions, there is also a Dictation button to enter information via speech-to-text conversion. This uses the microphone built into the tablet or an external microphone.

There can be an option to Delete an entry by clicking a Delete button, which can be located, for example, at the bottom of the screen. When we Apply an item, it will be posted to the Patient Summary Screen. There can be more than one Apply buttons having the same function. This helps to reduce the need for hand or mouse movement.

There can also be a New button, which allows you to continue entering more items without having to close the Data Entry and Edit screen. For example, click New and continue to enter diagnoses.

### 4 Orientation to the Data Entry and Edit Screen: Changing the Date, Flagging an Entry, or Coloring an Entry

This example uses the Data Entry and Edit Screen for Diabetes Type 2, which is opened by clicking over that item.

An item's date can be changed very easily. To open the calendar, either click on an ellipse, or just click within the Date field. To change the year, just click on the appropriate year. In this example, the patient was diagnosed with Diabetes in the year 2000.

The month and day can similarly be changed by clicking on the appropriate date, if known.

If only the year is known, then click Not Known for the month and day. If only the year and month are known, then click n/k for the day. When finished, click Select.

To add a colored flag to an entry, to add visual emphasis to an item, just include a flag icon, and click on it for choices, such as, No Flag, a Red Flag, or a Blue Flag.

Similarly, an item can be colored for visual emphasis. One way to do this is by clicking on a color circle, and choosing one of the color choices.

### 5 Orientation to the Data Entry and Edit Screen: Delete, Apply, and New

To re-open a Problems Data Entry and Edit screen, click on the Problems panel heading, and from the panel menu, click New Entry.

This example will focus on Apply first.

In the example, we enter that our patient has a history of hypertension. We begin to enter the diagnosis, and a pick list of ICD-9 diagnoses that match the entry appears.

Click on 401.1, Benign Hypertension, and now that information posts to the Code and Display field.

To post the information to the Problems list, click Apply. Optimally, there is a choice of where Apply can be clicked. For example, it can be clicked at the bottom, or in the middle of the screen. Click Apply, and now the diagnosis posts to the Problems list.

To edit an item, or re-open the item's data entry and edit screen, click directly on the item. In this example, click on Benign Hypertension.

The item can be deleted by clicking on Delete. A prompt can ask if we really want to do that, and, in this example, the answer is Yes.

The New function allows us to enter another diagnosis without closing and re-opening the data entry and edit screen.

In this example, re-enter a Hypertension diagnosis.

Again, click on the Problems panel heading, and then from the Panel menu, click New Entry.

Again, enter hypertension, and from the Pick list of ICD-9 diagnoses, click on 401.1, Hypertension. Click New and the current item, Hypertension, is posted to the Problems list. This permits the entry of a new diagnosis without having to close and re-open the screen.

### Lab/Testing: Entering Values, Results and Comments, and Viewing Results

An advantage of this system is that labs and other test results can be entered system directly through an electronic interface. Lab results can be easily scanned into the system.

In addition, at times, it might be desirable to hand enter certain lab values or other numeric results, which will then appear on the patient summary screen; and for multiple values entered over time, can even be viewed in tables, grids, and graphs. The ability to do this is another advantage of this system.

This system also allows you to make comments regarding labs, tests, and consult reports, indicating that the results have been viewed, to indicate the need for follow-up testing, or even to indicate a communication with a patient.

To enter values and comments to labs, the same concepts apply to the Consult and Referral section, as well.

As an example, enter the value for a diabetic patient's HgBA1C test, and then add a comment to that result, as well.

To enter the value, or to make a comment, re-open an item's data entry and edit screen.

To reopen the screen, click on the item's target, and then from the item menu, click Edit. Here, the data entry and edit screen opens. Alternatively, click directly on the item, and the data entry and edit screen opens.

Enter the item's value in the Value field. Preferably, this field accepts only numbers.

Enter 6.2. When the value is entered, the item automatically Completes.

A Comment can also be entered on this screen, in the comment field. For example, enter, “spoke with patient; recheck in 3 months.”

Then, to post these additions, click Apply, and the entries are visible on the Summary Screen.

If results have previously been entered for HgbA1C, those results can be viewed a number of ways. For example, click on the item's target, to open the item menu, and then click History Table/graph. This yields a table of the results and comments, arranged by date. Also the results can be viewed in the form of a useful grid, or even as a graph.

There can also be an option to add a comment directly to an attachment. A page icon can be used to indicate that there is an attachment to a lab result.

To add a comment directly to an attachment, first click on the attachment icon. The attachment's data entry and edit screen will open.

Just as in the other examples, a comment is made in the comment field. For example, add the comment, “Reviewed, and agree with findings.” Then, click Apply to post the comment.

### Viewing a Patient's Medical Information: Views, Tables, Graphs

The EMR system enables you to view a patient's medical information in various useful ways, and automatically compiles data into tables and graphs.

First, a look at Views. From each panel menu of the Patient Summary screen, the user can select from various views of the panel's data.

To demonstrate Views from Problems, Prescriptions, and Labs, open the Problems panel menu by clicking the Problems Panel heading.

Examples of choices of Views can include, All Current, Current Acute, Current Chronic, and Past.

If we click on Current Acute, we are now viewing current acute diagnoses. When a diagnosis is entered, there can be an option to denote that the diagnosis is acute or chronic.

There is also the option of having Views for Prescriptions.

Click on the Prescriptions panel heading, to open the panel menu. Listed under Views are options to have Active, and Inactive Scripts. Along the panel heading and the top of the panel menu, it says “Current plus # other” to let you know that there are inactive, or old prescriptions, in the Inactive List.

In this example, we are viewing the Current Prescriptions.

One option is the ability to click on Inactive Scripts from the panel menu, to see a list of old prescriptions that were taken off of the Active Scripts list.

To look at the various Views available for the Labs panel, enter an item in Labs, and we can have the option to assign the item to a Display group. Examples of available display groups are Vitals, Procedures, Chemistry, Radiology, and Other.

The History Table/Graph option allows us to View an individual item's values or history over time, which can be quite valuable, especially when trying to see the trend in some measure, or the history of a medication's use.

Access History Table/Graph from an item's menu.

For example, to see a patient's blood pressure trends, click on the target in front of blood pressure, and from this item menu, click on History Table/Graph.

In one example, all blood pressures can be listed by date.

Clicking on an individual listing will open up it's data entry/edit screen.

The date can be changed. By default, it lists the last 5 years, but that can be changed. It is helpful to have the date appear along the top of the screen.

This example also lists every item from the current Labs section. In this example, it's listed along the left hand side. Clicking on HgbA1C, provides a listing of all of this patient's HgbA1Cs, and any comments that might be made regarding the values.

It is useful to include the following tabs in the upper left of this screen: Grid and Graph.

Clicking Grid yields all of the patient's data listed in a grid format.

Clicking Graph yields the HgbA1C values compiled as a graph.

This is an example of the History Table/Graph for Prescriptions. In this example, information on Percocet is discussed.

Click on the prescription's target, and then click History Table/Graph.

This yields a listing of each time the medication was prescribed. This is especially useful when ordering a refill.

This is an example of the History Table/Graph for immunizations.

Click on the Immunizations tab, and then click on the item menu for an influenza immunization, and then click on History Table/Graph. This yields a grid display of all immunizations. This is especially helpful when viewing pediatric immunizations.

There is also an option to view the History of each individual immunization.

### Coumadin Processing

Monitoring Coumadin is a special task, involving following and tracking results, creating follow-up orders, and requiring reminders for follow-up testing. This example demonstrates the use of dated OWL reminders, and the History Table/Graph View to create a Coumadin tracking system. This same approach would apply to any regularly scheduled testing or standing order.

In this example, a patient with Atrial Fibrillation has a standing order for international normalized ratio (INR) testing, and has been having their INRs tested regularly.

Click on the target in front of PT/INR to open it's item menu, and then click on History Table/Graph.

The table displays all of the past INR results by date, as well as the commentary that went with each result.

Then, when the next INR result is received, the PT/INR order is entered, and then the value.

Click on the Labs panel heading to open the panel menu, and then click New Entry.

Enter PT/, and from the pick list, we see PT/INR, which is clicked.

Enter the value as “2.5,” and make sure the Display Type is Chemistries. Next, click Apply.

Now the History Table/Graph view includes the new PT/INR order, with the value listed in the table.

For example, enter the comment, “At goal, patient aware; repeat in one month.”

Then create a dated OWL reminder to prompt the next required PT/INR test.

From this data entry and edit screen, click on the OWL icon.

We indicate who the OWL reminder will go to, by clicking here on the User's name in the To field.

The appropriate subject of the OWL is generated automatically. Optionally, a comment can be added, “recheck INR.”

Then, advance the date. To do that, click on Date.

In this example, advance the Date one month, and then click Select. Then click Send.

That OWL reminder will show up in the user's OWL list in one month.

Finish by clicking on Apply.

### My Medical Facts Report

My Medical Facts is a real-time compilation of all of a patient's medical information, which can be printed, either for the patient or their family to have, or to send to referrals, along with consult notes, so that we never have to re-enter a patient's history. Since My Medical Facts compiles automatically, and in real time, it can give our patients updated medication lists anytime a medication is changed.

My Medical Facts can be accessed from at least two areas: first, My Medical Facts is available as a Report, so click on Reports, and then check My Medical Facts. Essentially all of the patient's pertinent information is all in this one report. It can be printed from this screen.

My Medical Facts can also be available from the Print screen. Click on Printing, then click on My Medical Facts, and then print.

### 19 Prescriptions: New Prescriptions

The EMR program offers a full spectrum of electronic and traditional prescribing options, as well as automated allergy and drug-drug interaction alerts. The ePrescribing module is a component provided by a third party pharmacy network connector. This only applies to the ePrescribing module, which includes the “Compose Rx” tab. Everything else related to prescriptions and ePrescribing is part of the inventive EMR system's interface.

To enter a new prescription, first open the Prescriptions panel menu, by clicking on the Prescriptions panel heading, and then clicking New Entry.

The Prescriptions Entry/Edit screen will display.
1. Searching/Selecting Drug/Dose: To enter a prescription product, enter the product from a database, which we search by name, and then by strength or appropriate formulation.
   1. With the cursor on Search Drug, type the name of the prescription, either the brand name or the generic will work, and after 3 characters have been entered, products that match the search will begin to display. Lisinopril is an example. Enter “lis,” and products begin to display. Add more letters, and the search results refine.
   2. Select the strength or formulation by clicking on the desired one that we want. This can be displayed on the right of the screen, for example. Select Lisinopril 10 mg by clicking on it. And now, the medication name and strength are displayed in Drug/Dose.
2. Signature: Now, to enter the signature (“Sig”), just place the cursor within the Sig field and enter the Sig using free text and/or the very nice dictionary terms (which can be added to or modified). Here are a few examples on how to do this.
   1. Enter free text, type: “take it however you want”,
   2. Or, use the dictionary terms, e.g., “enter 1 by mouth every day”,
   3. Or, select “1 t/d/m,” which is a short cut for the same thing.
3. Dispense Number, Refills: Next, we tab to Dispense number, and enter 90, by clicking on it. And then tab over to refills, and click on 3.
4. Pharmacy Comment: Pharmacy message is an optional field to create a message that will go only to the pharmacist, such as “No child safety top please.” This message can automatically display on subsequent prescriptions for this patient, or be deleted.
5. Internal Comment: Internal comment is an optional feature. Here, add a message for the patient, that will display on the prescription. When the cursor is placed in Internal Comment, automatically, below, we get dictionary terms that list each of the patient's diagnoses, and this comment here, “This is for your,” and the intention is that you can let the patient know why they use this medication, so we can enter, “This is for your,” by clicking here, and then, click on, Hypertension, so that we now have “This is for your Hypertension,” and this will display on the prescription, or any med list that we give the patient.
6. Display Group: Next, another optional feature, the Display Group. This displays the patient's medications by group, just so that a lengthy medication list is easier to view. So, if we place the cursor in Display group, this drop down menu displays, and we can select an appropriate group. Click on blood pressure. Now the medication will be listed within a grouping, which can be quite helpful for patients with long lists of medications.
7. Allergies: On the screen, e.g., in the middle for prominent viewing, is a display of any of the patient's recorded allergies, as a reminder when writing a prescription, of any issues to be careful about.
   1. There are a number of ways to be reminded about any possible interactions. For example, an icon will change to yellow/red and flash if an issue exists. The icon can be located, for example, In the upper right corner. Or, click on “Interactions,” to actively look for any allergy or drug-drug interactions.
8. Activity: we can have an Activity button. Click on Activity and a history of the prescription's activity, such as when it was last refilled, will display.
9. Monograph: A nice optional feature is the Monograph button. This provides access to a full informational monograph, that reviews dosing, indications, interactions, side effects, etc. Additionally, from this button, we can access a patient education leaflet regarding the medication.
10. Extra Tab:
   1. Expiration Date: this tab can provide the Expiration Date. With this we can set an expiration date for a temporary prescription, such as an antibiotic or pain medication. After the expiration date, the medication will automatically be removed from the Active list, to the Inactive Prescriptions list.
   2. Interactions Comment: the program can include an Interactions Comment field with an option to explain why the physician might be ignoring an interaction warning that the system provides, for instance, if an interaction is only a mild one.
11. Coming back to the main screen, after entering a prescription either click Apply, or click on NEW, if there are more medications to enter.

### 20 Prescriptions: Editing or Deleting a Prescription:

For a prescription-related function besides entering a new medication, it is helpful to access the E-prescribing module, EITHER by clicking on the Prescriptions panel heading, and then E-prescribing or access this same screen by clicking ePrescribing under Sign and Print in the top panel, which opens up the same screens.

We can edit the prescription sig, as well as the dispense and refill numbers. On the other hand, if we need to change the pill strength, then we discontinue the medication, and enter a new prescription.

Editing is straightforward. Edit from the Compose Rx screen.

Merely click EDIT next to the medication, and then you have the ability to alter the Sig, the Pharmacist's message, the dispense number, and refills.

When done, click SAVE.

Now, to discontinue a medication, all we need to do is click adjacent to the prescription we want to stop, and then click here on D/C.

So, it's very simple to EDIT and DISCONTINUE a medication.

### 21 Prescriptions: Printing a Prescription:

To print a prescription, go to the E-prescribing module by clicking on the Prescriptions panel, to open the Prescriptions Panel Menu, and then clicking E-prescribing.

Work under the Compose Rx tab.

To print or to send a prescription (or prescriptions) by Email or Fax, first Select the desired prescriptions, either by clicking directly on the medication, or by clicking the corresponding box, which can be found, for example, on the left, and then Select.

If the prescription appears as you want it, then click Take Complete Rx to Review Page. To print the prescription, click on Print Rx/Add to Current Meds.

The Prescriptions list will automatically update.

### 22 Prescriptions: E-Prescribing New Prescriptions or Refills

To E-prescribe, be in the E-prescribing module. Click on E-prescribing. Start out under the Compose Rx tab.

This process can be used for new prescriptions or refills alike, although there are a number of ways to do refills more quickly.

To E-prescribe a prescription to a pharmacy, first Select the desired prescription (or prescriptions) by clicking directly on the medication.

If the prescription appears as desired, then click Take Complete Rx to Review Page. Then click on Transmit Rx.

From this next screen, select a Pharmacy, either by selecting from an existing pharmacy list (scroll through, “these are pharmacies to which we have already sent prescriptions”), or, if the pharmacy isn't already on the list, add a pharmacy, by clicking on Add Pharmacy, and then searching for the pharmacy by filling some of the pharmacy information, e.g., by entering the pharmacy name and the city/state.

Just to note, any of the pharmacies that display a green dot are capable of E-prescribing. Select a pharmacy just by clicking on the name.

This green color indicates that this is an E-Prescription. Then click on Transmit Rx/Add to Record.

This E-record here can be printed, if a patient requests, but this is not necessary. Then Close to finish.

### 23 Prescriptions: Faxing a Prescription

Faxing a prescription to a pharmacy is almost exactly like E-prescribing.

Begin in the E-prescribing module by clicking on E-prescribing. Start out under the Compose Rx tab.

This process can be used for new prescriptions or refills alike, although there are a number of ways to do refills more quickly.

First, Select the desired prescription (or prescriptions by clicking directly on the medication.

If the prescription appears as desired, then click Take Complete Rx to Review Page. Then click on Transmit Rx.

From this next screen, select a Pharmacy, either by selecting from an existing pharmacy list, or, if the pharmacy isn't already on the list, add a pharmacy, by clicking on Add Pharmacy, and then searching for the pharmacy by filling some of the pharmacy information, e.g., entering the pharmacy name and the city/state.

Pharmacies that DO NOT display a green dot are likely incapable of E-prescribing, but typically, we can alternatively just send the prescription as a FAX, which is almost exactly the same with this program, since we still are sending the prescription electronically.

Select a pharmacy just by clicking on the name.

The gray color indicates that this is a FAX Prescription. Just to note, if necessary, you do have the option to edit this FAX number, if you ever need to. Now, to send the FAX, we click here on Transmit Rx/Add to Record.

This FAX record here can be printed, if your patient requests, but this is not necessary. We then Close, and we're finished.

### 24 Instant Refills

This next function, Instant Refills, allows a refill to be sent very quickly. Instant Refills can be used if you have already sent a Patient's prescription successfully to the pharmacy. The next time you send any prescription, to the same pharmacy, you can use the Instant Refills function.

In a preceding example, a Lisinopril prescription was sent in for a particular patient. Now, if we want to refill Lisinopril, access the E-prescribing module by clicking on it and starting out from the Compose Rx tab.

Select the prescription by clicking on it. If we have already sent prescriptions for this patient to the same pharmacy, then we can click on Select Pharmacy, and the pharmacy name will display, and we click on the name.

Then we merely click here on Instant Refill.

### 25 Un-Coded (or Non-Prescription) Medications or Supplements

It's a good idea to list a patient's supplements, or non-prescription, medications. Many non-prescription medications, such as over-the-counter pain or allergy medications, and even a great many vitamin or herbal supplements, are available in our database, and can be entered exactly the same way that we have entered prescription medications. It is a good idea to enter as many non-prescription items this way because then there can be allergy and interaction checking.

However, sometimes patients are taking things that aren't in the drug database, or they take a dose that isn't available. We can then enter it as Un-coded, which essentially allows us to enter free text.

We open up the Prescription entry/edit screen by clicking on the Prescriptions panel heading, and then New Entry. If we click this box, Uncoded, then we can enter a name using free text. For example, enter: “Something I've Never Heard of.”

Notice that the Interactions icon has turned red/yellow and is flashing. If we click on it, it will inform us that, because we are entering an Uncoded item, that there is no allergy/interaction checking.

### 26 Favorites

This segment is to demonstrate the Favorites Prescription function.

Each user can create a list of favorite prescriptions, that will be listed in alphabetic order, and can include the medication name, the sig, and the dispense and refill numbers, so that the medication can be entered from the favorite list with one click.

First, is explained how to use the function, and then it is explained how to add an item to the favorites list.

First, open the Prescriptions Entry/Edit screen by clicking on the Prescriptions panel heading, and then New Entry.

A user can access a Favorites list either by clicking on a Star, or by clicking Favorites. The personal list will then display, and we then can enter a new prescription for a medication just by clicking on the entry.

Now, let's see how we add a new prescription to the Favorites list.

Once a Prescription has been added, and is displayed on the Prescription list, it's data entry/edit screen can be re-opened, just by clicking on the entry, and then, to add it to the Favorites list, click on the Star/Plus icon (or add to Favorites icon).

Removing an item from this list is simple. Just click on the Red X, or Remove from Favorites, icon.

### 27 Section Notes

Section Notes is a Free Text comment that will display within the Prescriptions list. For example, use the Section Note to write the patient's pharmacy name, so that when a refill request is made this information is already known. Also, special Prescription-related comments, such as Avoid Controlled Substances, can be entered.

To create a Section Note, click on the Prescriptions panel heading, and then from the Panel menu, click Section Note.

Then add a comment, such as, “Has had a bad reaction to everything I've prescribed!!”

Then Apply, and the note will display in the Prescriptions panel, and will serve as a reminder of a patient's very special issues.

### Summary Screen Panel Menu Text

1. What is it: the Panel Menu is the menu that allows us to perform actions that apply to an entire panel of information. Each panel, therefore, or each tab on the summary screen, has its own panel menu.
2. Opening the Panel Menu: to open a panel's menu, click on the panel's heading. So to open the panel menu for Problems, click on the Problems panel heading. And to open the panel menu for Social History, click on the Social History tab, and then on the Social History panel heading. Any function that is available on the Summary Screen, can also be performed on the Summary Panel at the top of the screen, so we can also open the Social History panel menu by clicking on Social History, and then the panel heading opens up the exact same menu.
3. Closing the Panel Menu: we can close the panel menu either by clicking anywhere outside of the menu, or if this same panel menu is opened back up, click on Exit.
4. Functions of the Panel Menu: there are three general functions available: Actions, Templates, and Views. The functions available within each panel might be slightly different, as shown in this example: the Problems panel and the Labs/Procedures panel.
   1. Actions: from Actions, create a new entry by clicking New Entry. In a number of panels, we can also “Mark all reviewed” to note that we have reviewed the information within the panel. Noting that information from the Past/Family/Social (P/F/S) History was reviewed will factor into their level of visit coding when seeing a patient. So, within Actions, we can create a new entry, or note that we reviewed the information within a panel.
   2. Templates: under the templates section, we can select any of the templates that are available within a panel. So, here in the Problems panel, we could select either Common Cancers, or Standard Problem Review. Here in Labs/Procedures, we could select from these templates.
   3. Views: from the Panel menu, we can select various views of the panel's information, that might help us get a better picture of a patient's clinical status. Here in the Problems panel, we can look at the patient's diagnoses a number of useful ways: we can view all Current Diagnoses. We can differentiate between Acute and Chronic diagnoses. And then, we can view Past diagnoses. Here in the Labs/Procedures panel, we have a number of different types of ways that we can view our patient's data. We can view all the information, which includes vitals, and all ordered and completed labs and procedures. We can view Vitals alone. We can view Orders alone, to see what outstanding or pending orders there are for a patient. We can view Non-Vitals, which are all ordered and completed orders/procedures. And finally, we can view our information as a Grid, Table, or Graph, which can be useful to see trends in vitals, various labs, and lots of other information.

These are the functions of the panel menu. From the panel menu we have Actions, Templates, and different Views.

### Introduction to the Sign and Print Screens and Functions

For the introduction to the Sign and Print Functions, we would like you to be aware of 5 important points.

### 5 Points:

1. In the EMR program, there are at least two benefits to signing an item:
   1. To be able to print an item, it must be signed; and
   2. We sign an item to close it from further editing.
2. In the EMR program, there are 3 items that we sign off on:
   1. labs/procedures orders;
   2. consult/referral requests;
   3. encounter notes
3. We can sign off on an item from its Summary Screen item menu, or we can sign off at the Signing screen. There is one exception to this, which is Full Encounter Notes, which can be signed from the Summary Screen, from the Full Encounter note itself, or the Signing Screen.
4. We can sign off using 3 different methods;
   1. We can use a signature on file;
   2. We can sign off by hand if we have a tablet PC;
   3. Or, we can complete without signing
5. From the Print Screen, we can group items that we wish to print together. So, for instance, if a physician orders and signs requests for radiology, e.g., a CXR (chest x-ray), and at the same time, requests for a CBC (complete blood count), CMP (comprehensive metabolic panel), and TSH (thyroid stimulating hormone), after sign off on the items, the physician can go to the Print screen, and group the lab tests, so that they print together, and the patient only has to carry one lab order. And the CXR order can be printed separately.

### Signing and Printing Labs/Procedures

In this example, the patient has been diagnosed with fatigue, and needs an order for a chest xray, CBC, complete metabolic panel, and a TSH.

Order these tests, by clicking on the Labs/Procedures panel heading. For the blood tests, use, e.g., a template for common lab orders and order the CBC, and CMP.

Now, order the CXR. Click on the Labs/Procedures panel heading, and use, e.g., a radiology template. Select a CXR, and assign the diagnosis.

Here are two examples of signing off on these items:
1. Sign the item directly from the item menu. For example, with the CBC, click the target to open the item menu, and click on Sign item. The screen that opens also provides the option to sign the other items as well. The user clicks on the user's name, and then signs using, e.g., a pre-loaded signature file. Click on Sig. On File and then Apply. Now the CBC has been signed off.
2. Another way to sign an item is from the Signing Screen. Click on Signing, and from the Signing Screen, check the items we want signed, and then the process for signing is the same, but in this example use a Tablet stylus to handwrite the signature and then click Apply.

Now, to print these same items, first click here on Printing. The Print Screen opens, and here we have the items that we have signed, now awaiting printing.

Now, remember that we said that we can group the items from this screen if we want. For example, it would make sense to group the blood work orders for CBC, CMP, and TSH. Check all of those. And now, you see that we have both the orders on this one printout which prints just by clicking this Print icon.

### Signing and Printing Consult/Referral Requests

In this example, there is a consult for Endocrinology in a patient who has diabetes.

Click on the Consults/Referrals tab, and then the Panel heading to open the Panel Menu, and click on New Entry. Search for Endocrinology, and highlight the diagnosis of diabetes. It is helpful to write a note, such as: uncontrolled sugars, please evaluate and treat. Also, add the historical information desired by clicking and selecting each item to include.

Sign either from the Item itself or from the Signing screen. For example, click on the item target, opening the item menu, and the click Sign Item. Sign by using a signature file. Now click Apply, signing is finished.

In this example, go to the Printing screen to print the Consult request.

Click on the Consult; this shows the consult request with the attached history. And now click on the Printing icon.

### Signing and Printing an Encounter Note

The final topic in Signing and Printing is Encounter Notes. In this example, in the Encounters panel, three encounters are displayed in red. The red color denotes that these encounters have not yet been signed.

Sign any encounter note from one of two places:
1. Sign from the item listing, by opening the item menu and clicking on Sign Item. Use a Signature File to sign electronically. And now, the encounter color has changed to black, indicating that it is signed.
2. Sign an encounter from the Signing screen by clicking on Signing and sign, as done previously.

For full Encounters, or SOAP notes, there is a third option. There is an option to sign directly on the full encounter screen. Open up this full encounter. By clicking on the box for the signature field, we can sign, just like we have signed elsewhere.

Now, printing an encounter note is simple. Go to the Printing screen by clicking on Printing. For each encounter, there can be a number of print options; in this example, there are three:
1. Details is the full encounter note, as it appears.
2. Summary is just the Assessment and Plan portion of the note, which could be used for billing staff, or as a superbill (the complete itemized list of medical services provided by the clinicians for submission to insurance company or other payors).
3. Billing is an automated summary of a CMS (centers for Medicare and Medicaid services) level of visit worksheet.

Here, e.g., print the full encounter note, by checking on Detail, and then Printing.

### Special Functions and Accessories:

### 1 Entering Vital Signs

Vital signs are entered from the Vitals template, and the Vitals template can be found in at least one location.

First, we can enter vitals from the Patient Summary Screen, from Labs. Click the Labs panel heading, and from the Panel menu, there is a Vitals template to click on. The user can create and customize her own Vitals templates.

Another location to enter vitals is from the Full Encounter screen.

Open a new Full encounter screen. Click on the Encounters panel heading, and from this Encounters panel menu, click New Entry. Then, from this data entry and edit screen, click Open to Full Encounter.

In this example, on the upper right of the Full Encounter screen, click Vitals, and it yields the same list of templates listed in Labs displays. Click on Vitals to re-open the Vitals data entry template.

In this example, on the left is a listing of the available vital signs. By default, the template first requests a height measurement value. Hover over any other vital, click on it and advance the screen to that item. For example, click on Temperature, and notice that the screen has switched to Temperature. Let's go back to Height by clicking up here on Height.

In this example, the cursor is in the Value field to enter the height, which is entered as 66 inches, for example. When complete, there is an option to click Apply, or to click the Enter key on the keyboard. The value posts to the Height, and the template automatically advances to the next item, which is the weight.

In this example, the Weight is entered as 180 pounds. The screen can have a keyboard for entering the values, as well as optional units. By default, the weight entry is in pounds, but it could be entered in other units, such as kilograms. To post the weight, we click Apply or the enter key.

A body mass index (BMI) can be automatically calculated based on these vitals.

Next, enter the blood pressure. In this example, enter the systolic reading, and then a slash, and then the diastolic pressure, and then click Apply.

Now, enter the pulse.

Next, enter the temperature, and click Apply, and then enter the respirations, or customize the template to add other vitals.

When done entering the Vitals, close the template by clicking Close.

The Vital signs can display on the Full Encounter Note screen, or on the Summary Screen, listed within Labs, or another screen according to customization.

### 2 Adding a Second Reading and Editing/Deleting a Reading

It's common to want to repeat a vital sign. For instance, if a patient has a particularly fast pulse or elevated blood pressure when they first come in, the pulse or blood pressure check is often repeated.

In this example, add a second blood pressure, and then edit, or replace, the current pulse reading.

To add a second blood pressure, first re-open the Vitals template.

Click on Vitals, and then select the Vitals template.

Click on Blood Pressure, which is located on the left of the screen in this example, and then click on New. That Value is now blank. Enter a second blood pressure, and add in a Comment that we checked the patient's left arm. Then, click Apply and Close the Template.

The second blood pressure result will be posted.

To replace the pulse, click on the current value.

Enter another value or delete the current value, by clicking on Delete.

### 3 OWLs Overview

An OWL, which stands for Outstanding Work List, is an extremely useful, and easy to use, aspect of the EMR program.

The OWL is the EMR program's internal messaging system, as well as a dated reminder tool.

OWLs are viewed from the OWL screen.

In this example, in the upper left of the Client screen, under the Patient Select tab, there is an OWLs button. The number on the left, is the total number of current OWLs, or messages, on the list. Open the OWL screen by clicking on the OWLs button.

Along the top of the OWLs screen are the OWL functions, examples of which include:
1. creating a New OWL,
2. sending a Reply OWL to someone who sent us an OWL,
3. forwarding an OWL to another user in the system,
4. deleting the OWL,
5. viewing a history of the OWLs that have been sent if more than one OWL message followed an original message,
6. Configuring what appears on the OWL lists.

In this example, at the upper right of this screen, there is an option to shrink the screen, which allows more of the current screen to be seen, and shrinks the OWL list to just the OWL that is highlighted.

The screen can be dragged around to give a better view. In this example, clicking on the blue bar enables the user to drag around the screen.

Expand enlarges the screen to again include the entire OWL screen.

In this example, along the left of the OWL screen are different OWL lists, and various useful ways to view OWLs. These listings can be modified by clicking on Config, and checking and unchecking from the selections.

Script Actions is a listing of direct communications received from pharmacies, or in other words, E-prescribing refills and messages.

Sent by Me is a listing of all of the current OWLs this user has sent to others.

Patient OWLs are all of the OWLs for the current patient.

The user can also view past OWLs that had been deleted.

4 OWLs: Creating and Sending a message

An OWL message can be sent from literally every screen in the EMR program.

It is very useful to send an OWL to alert staff regarding, for example, a phone message, that a lab result has arrived, or that correspondence, such as a consultant's note, or hospital records, have arrived.

To create an OWL, start by clicking on the OWL icon. In this example, you can see the OWL in the upper left hand corner of your screen. Clicking on the OWL opens the Send OWL screen.

Clicking on the target in front of this medication, opens this medication's item menu. In this example, there is an OWL here. Click the OWL icon, and the Send OWL screen opens. The patient name and item is automatically displayed in the Subject field.

Click on the target in front of a lab result, then from this menu, click on the OWL, and the Send OWL screen opens, with the patient name and test name in the subject.

In this example, a patient has called, and we have entered a brief encounter note to record the phone message, and now we want to create an OWL, to alert the appropriate staff about the phone message.

Click on the target in front of the phone message encounter note, and from the item menu, click on the OWL. This is the Send OWL screen.

In the “To” field, there is a list of all of the users in your system. It is helpful to prevent an OWL from being sent until a selection has been made in the To field. In this example, the Send button is grayed out. To indicate who we are sending this OWL to, we merely click the box in front of the User's name. Now the send button is activated.

The Subject field is the text that will display in the User's OWL list. By default, it will always list the patient's name, and the item from which we generated the OWL.

Clicking this Reference patient box, clears the Subject field. Clicking it again replaces the same information.

Message is a free text field. When the OWL originates from a brief encounter note, it can automatically populate the OWL Message field with the encounter note comment, so that you don't have to do any duplicate data entry when an OWL originates from an Encounter Note. This text can be replaced, or edited, with any free text desired.

The Date field can be altered when sending a dated reminder into the future. That usually wouldn't apply for a phone note.

Send the OWL by clicking Send.

Note that the number in the OWL button increases by one. Click on the OWL button, to open the OWL list screen, to find the OWL that was just sent.

Reply to this OWL, merely by clicking Reply, and creating another OWL, with a new message.

### 5 OWLs: Dated Reminders

By changing the Date of an OWL, we can send messages into the future, which will appear on the specified date. This can be incredibly helpful.

We can use this function to create reminders regarding abnormal test results that need to be repeated in a specified amount of time.

We can use this function to track Coumadin testing.

Throw out your sticky notes. You no longer have to worry that important tests aren't being followed up.

If there is concern about a patient, and a follow up in the near future is desirable to track their progress, the physician can send herself an OWL reminder, and it prompts her, at the appropriate date. Patients find this extremely thoughtful, and valuable clinical information is obtained when checking up on them.

In this example, send a dated reminder regarding an abnormal test result.

Here, a chest xray was done, and it was suggested that a follow-up xray be done in one month.

Click on the target in front of the CXR, and from it's item menu, click the OWL.

All we need to do is change the date. Click on the date, and select the date in the future when we want a reminder. Let's advance this date one month. The user can send herself any free text message that is helpful, like, “repeat abnormal test.” Now, click send.

This OWL will appear in the user's OWL list in one month.

### #1 Encounter Note Brief Overview

1. Patient encounters are displayed in this panel.
2. In the EMR program, patient encounters can be used to record a brief note, such as a phone note, or can be opened to a larger full encounter screen, e.g., a full SOAP note, to record a SOAP note
3. Open a new encounter by clicking on the Encounters heading, and then from the panel menu, clicking on New Entry.
4. This screen is the Encounters data entry and edit screen, and it is relatively similar to other data entry and edit screens already encountered in this program, and from the upper portion, in this example, the user can record a brief note with a free text title and comment. Alternatively, clicking on Open to Full Encounter, can open a larger full encounter screen, to record a SOAP note.

### 2 Orientation to the Full Encounter Note

1. Open a full encounter note: First of all, to open a full encounter screen, we click on the Encounters panel heading, and then from the Panel menu, New Entry. From this Brief Encounters entry/edit screen, then click on Open to Full Encounters.
2. Patient Summary Panel: it remains unchanged. So, any information from the Patient Summary Screen can still be accessed, and the exact same functions can be performed, without having to leave the SOAP note below.
3. Visit Information: Visit Information can include such items as the Date of the visit, the Location of the encounter, and the clinician's name. The user can sign off on the encounter note from this field, and the signature will display. In the Also field, other work that has been performed that day, such as orders and prescription refills, will automatically display.
4. Billing: Billing is where the level of visit code is calculated and displayed. Below this level, are the elements of the SOAP note.
5. Complaints/Subjectives/Reasons for Visit: is where the user records the subjective portion of the patient visit, or the history of the present illness for one or multiple complaints.
6. Review of Systems: The review of systems displays here, organized by body system.
7. Objective/Physical Exam: In Objective/Physical Exam, the user records the vitals, physical exam findings, and any procedures done.
8. Assessment and Plan: in Assessment and Plan, the user can record diagnoses and elements of the Plan, such as prescriptions, procedures, orders, and referrals.
   1. Here, in Assessments, diagnoses can be listed, again, for single or multiple diagnoses
   2. In Prescriptions, the user can create prescriptions as described above in the section on prescriptions.
   3. In Orders, the user can create orders, just as on the Summary Screen.
   4. Referrals can be created here.
   5. In Patient Notes, the user can record Anticipatory Guidance for her patients.
   6. And finally, in this Billing field, the user can add some information regarding the complexity of the medical decision-making, which can be used to factor into the automated level of visit calculator.

To make this information more clear, the next example will look at an example of a completed full Encounter, or SOAP, note.
1. This example has the completed Visit Information and signature. Another (e.g., “Other”) Field, includes other work that the user has completed outside of the SOAP note today; it has automatically been displayed. In attached, it shows the user gave the patient a note, and it was attached here. And on the right is a completed level of visit code, calculated at a Level 3 visit or the CPT coded 99213, in this example. (CPT refers to the Current Procedural Terminology and is the set of procedural codes owned by the American Medical Association.)
2. Subjective, Complaints/Reason for Visit, includes the HPI and associated signs and symptoms. Review of Systems, includes a review of systems organized very nicely by body system.
3. Objective/Physical Exam, includes the Vitals, physical exam findings, and also a review of Past/Family/Social History.
4. It also shows the Assessment, or diagnosis, and the Plan.

### Creating New Encounters: Brief Notes or Phone Notes

1. Create a new encounter by clicking on the Encounters panel heading, and from the panel menu that displays, by clicking on New Entry.
2. This is the Encounters data entry and edit screen.
   1. Indicate the location of the encounter by clicking on it and selecting from the drop down menu of locations,
   2. Enter a free text Title to the note by placing the cursor in the Title field, e.g., “Patient needs to speak to you.”
   3. Enter the body of the note by placing the cursor in the comment field, and entering a note using free text or any dictionary terms.
   4. Complete the note by clicking Apply.
   5. The note then displays with the location, note title, and body of the note.

### 4 Editing or Deleting a Brief Note or Phone Note

Any note that has not yet been signed off on can be edited or deleted. A note that has been signed off on appears in the black text, whereas a note that has not yet been signed off appears in red.
1. Edit the note by opening the item menu, by clicking on the [symbol] target in front of the note, and then from the item menu, clicking on edit.
2. Then any aspect of the note can be altered.

Complete the edit by clicking on Apply.
3. An example of deleting a brief note includes the following steps:
   1. Re-open the item menu by clicking on the [symbol] target.
   2. Then click Edit to re-open the Encounter data entry/edit screen.
   3. Delete the note by clicking on the Delete in the lower left of the screen, and then confirming by clicking yes.

### 5 Opening the Full Encounter Screen and Deleting a Full Encounter Note

Use the Full Encounter Screen, rather than the brief encounter screen, to record SOAP notes.
1. Open the Full Encounter screen as follows.
   1. First, open a new Encounter Note by clicking on the Encounters Panel heading, and then from the Panel menu, clicking on New Entry.
   2. Then, from the Encounters edit/entry screen, click Open to Full Encounters to go to the Full Encounter screen.
2. A Full encounter note that has not yet been signed off on can be deleted. That is done by opening the brief encounter data entry/edit screen, and either clicking on Comment, or clicking on Complaints/Subjectives/Reasons for Visit. Then click Delete in the lower left, and then confirm by clicking Yes.

### 6 Using Free Text to Enter a Full Encounter, or SOAP, Note

An entire SOAP note can be entered using free text, either by handwriting, voice recognition, stylus or typing/keyboarding. While using free text isn't an optimal strategy for entering notes, because it won't create the discreet, usable data that can be used by the EMR program's automated level of visit code calculator, it is a simple and quick method to enter information.

For new users, or those who are just more comfortable with this approach, free text is quick and so easy to use, that even beginners can be functional in a matter of moments.

To enter a SOAP note in free text, open to the Full Encounter screen by Clicking on the Encounters Panel heading, and then from the Panel menu, click New Entry, and then click Open to Full Encounter.

Here is an example of entering a chief complaint using free text.

Click on the + sign adjacent to Comment in the Visit Information section of the note.

In this data entry/edit screen that has opened “the Full encounter note complaint launch Window”, text can be entered in this Comment field for the Chief Complaint.

In this example enter, “Needs to see a doctor,” and then click Apply, and now we have our chief complaint.

Free text information can be entered in any other part of the SOAP note by clicking on Comment in the appropriate part of the note.

For example, in the Subjective area, click Comment. In this data entry/edit screen, enter the history, “I am sick as a dog.”

Similarly, free text can be added within the Review of Systems area.

For example, click Comment and enter, “My nose hasn't been moist, and I′m panting uncontrollably.”

In Objective, click on Comment, and type the exam findings, “looks rough.”

In Assessment, click on Assessment, and from the data entry/edit screen, enter text in the Display field, just as in the Problems panel of the Summary Screen.

For example, enter “Kennel Cough,” as the diagnosis.

With this Comment displayed, click on this, and add free text, either as more discussion of the assessment, such as a differential diagnosis, or use it to record aspects of the plan.

For example, enter “Plan to refer patient to veterinarian.” A veterinarian is another type of physician who would benefit from this system.

### Introduction to the EMR Manager

1. One of the remarkable features of the EMR system is that performing high level practice management functions, especially those involving customizing the EMR's appearance and clinical functions, is made quite easy.
2. Users are capable of setting up and modifying basic EMR functions, as well as creating and customizing data entry shortcuts, templates, and clinical queries.

Access the EMR Practice Manager from the Start Menu (or Launch Window), by clicking on Practice, which opens the Practice Manager menu. In this example, different areas of the Practice Manager can be accessed by clicking on the individual bars located on the left side of this menu.

There are specific functions available within each of these bars.
1. In Practice, users can enter and easily modify basic practice information, such as the practice's name, address, and logo.
2. Communications can be used to create links to external partners with which the practice communicates electronically, such as labs, hospitals, and practice management systems.
3. The Layout/Buttons are quite useful. In Layouts/Buttons, users can customize the positioning of the Tabs that appear on the Patient Summary Screen and the buttons of the Patient Summary Panel;
   1. In addition, in Button Panels, create and modify data entry text shortcuts (otherwise referred to as “dictionary terms”) that will automatically appear in various data entry fields, allowing quick entry of commonly used text with one click. Liberal use of these dictionary terms minimizes the amount of typing necessary during data entry, greatly improving speed and accuracy.
   2. In Registration Options, the user can add or modify the fields of the Patient Registration screen, another very useful capability.
4. Within System and Support, practices can:
   1. Monitor Server status;
   2. Create system audit trails and system logs;
   3. In Automatic OWLs, set up automatic reminders (or OWLs) to track incomplete Orders, Referrals, Unsigned notes, and Incomplete E-prescriptions.
   4. In Licensed Connections, users can define the Internet Protocol (IP) addresses of users' different system connections (e.g., 192.168.1.12), allowing connection to the EMR system from locations other than the office.
   5. In Recycled/Undelete, users can view and recover previous and deleted queries and templates.
5. Code Settings is another extremely useful section. In Code Settings, the practice can customize how ICD-9 (ICD-9 refers to the 9^{th} version of the “International Classification of Diseases” or “International statistical Classification of Diseases and related health problems” and is the standard identification system for enumerating diagnoses) and family history diagnoses, as well as CPT (CPT refers to the Current Procedural Terminology and is the set of procedural codes owned by the American Medical Association) lab and radiology orders, display and can be searched for within the EMR system. This is extremely helpful for new EMR system users and those new to the ICD-9 and CPT coding sets, as it allows them to alter the language, which is often, shall we say, obtuse, to more commonly used medical terminology, both in how we can search for and display the information.
   6. In this section, we can also:
      7. In Provider/Specialties: Enter the user's area's specialists' names and demographic information, which will then be available to be added automatically when creating referral requests.
      8. In Practice Notes: create and modify anticipatory guidance statements, which can be placed in SOAP note plan templates, so that they can be added to SOAP notes with one click. Additionally, users can create and attach formatted form letters, to enable easy notes and letters for patients, as well as links to favorite patient education documents, which are then always on hand to review and give to patients.

Code Settings contains a number of extremely powerful tools that will enable the user to customize important EMR system functions, improve clinical performance, and increase data entry efficiency.
9. In the Users section, the practice can add and delete users, and define users' properties, settings, and permissions.
10. Templates/Queries section, is where practices can easily download, create, and customize system templates and data queries.
   A variety of templates can be created, for example:
      1. Complete New Patient Histories
      2. Problems (or Past Medical Diagnoses)
      3. Family History
      4. Health Screening
      5. Labs and Orders
      6. Procedures
      7. Medication Allergies
      8. Immunizations
      9. Social History
      10. and every element of a SOAP note for Acute, Review (or checkup), and Well appointments
11. Queries can be used in various situations, for example to:
   1. Create powerful ad-hoc clinical and demographic data reports.
   2. Create Quality Reminders, allowing practices to easily download, create, and modify real-time, patient-and-practice-specific reminders and population reports, based on chronic disease, health screening, and immunization quality standards.

### EMR Manager, Layouts/Buttons

In Layouts/Buttons, there are three functions:
1. Button Panels
2. Summary Screen
3. Registration Options

In Button Panels, the user can create and modify data entry text shortcuts (otherwise referred to as “dictionary terms”) that will automatically appear in various data entry fields, allowing quick entry of commonly used text with one click. Liberal use of these dictionary terms minimizes the amount of typing necessary during data entry, greatly improving speed and accuracy.

An example is shown with Family History—Comments. A number of dictionary terms are displayed on the right. Go to the EMR Summary Screen for a patient, and click on Family History. Use a Family History Template to enter new information. Enter that this patient's mother has a history of breast cancer. Click on the left, on breast cancer. All of those dictionary terms just viewed are also listed. To enter the comment, Mother, all the user has to do is click on its dictionary term “Mother”. Click Apply, and now, listed in Family History, is a positive family history of breast cancer, mother.

The user can create new dictionary terms for Family History. Sometimes patients mention that an aunt or an uncle was affected by a pertinent family history issue.

Go back to the Manager screen.

To add, modify, or remove a dictionary term, click on the Target or Arrow.

Then, click Add Button. Enter the text that will appear on the Button in this field, and enter “aunt.” And then, enter the text to display in the note, which can be different from what appears on the button itself. In this case, the text will be the same, so enter, “aunt.” To complete this change, we also click Apply, and then Done.

Now, the Family History Template will have the dictionary term, “aunt,” available.

The various Button Panels can be customized to best suit the user's preferences.

The user can also Modify or Remove an existing button. For example, remove the dictionary term, “aunt,” that was just added. To do that, click over the term to modify. So, click over “aunt.” Now, click the Target/Arrow, the menu that displays has other options. Click Modify, to alter the entry. Alternatively, click the Target/Arrow again, and instead, click the Remove Button. And the entry is removed. Then click Apply, and Done.

### Summary Screen:

The appearance of the EMR Summary Screen can be customized. From the EMR Manager screen, click on Layouts/Buttons, and then Summary Screen.

Return to the EMR Client, and view the Summary Screen. The content and location of the information that appears in the Patient Information Panel can be customized. In addition, the location of the Buttons on the Patient Summary Panel can be rearranged, as well as the location of the tabs on the Summary Screen. It's quite simple.

Return to the Practice Manager Summary Screen section.

It should be noted that the changes made in this section of the EMR Manager affect only the computer that is being used, not the entire practice. So, each individual may customize the Summary Screen to their own preferences.

In this example, this Screen Layout is arranged similarly to the EMR Summary Screen, with the Patient Information; the Summary Panel, and the Summary Screen Tabs in the same locations as the EMR summary screen.

To alter the location of the information on the Patient Information Panel, merely click on a content item, and drag it to a new location. For example, change the location of “Age”. Click over top of the button and drag it to a new location.

Next, to modify the content that appears on the Patient Information panel, click on the ellipse ( . . . ). From the menu that appears, the user can check and uncheck items to put them in, or take them out of the displayed Patient Information items.

Modifying the location of the Summary Panel buttons is simple. Simply click on a button, and drag it to a new location. In this example, drag Quality Reminders to the upper left.

Similarly, the user can also modify the location of the Summary Screen tabs, also by clicking on the button, and dragging it to a new location. For example, switch the location of the Social History.

When the changes are done, click Apply, and then Done.

Another function of the Layouts/Buttons section is Registration Options. This allows the practice to add custom fields to the patient Registration Screen. So, switch to the EMR Client Screen, and click Patient, and then Edit Registration. To reiterate, using Registration Options, the user can add a custom field to this screen.

Go to the Practice Manager, and click on Layout/Buttons, and then Registration Options.

To add a new field, start by clicking on the Target/Arrow, and then click New Registration Field. Enter the Field title here in Registration Prompt. In this example, also add a field to denote that a patient is participating in the practice's medical home project. So, enter “PCMH Participant.” Then, enter the maximum length of the field's entry. And finally, the user can add dictionary term prompts for the appropriate field data entry. If multiple terms are added, they should be separated by commas. Click OK when done.

To Modify a custom field, go through the above process, and choose Modify Registration Field, rather than New Registration Field.

### EMR Manager, Code Settings

Code Settings is an extremely useful section. In Code Settings (in the Practice Manager), the practice can customize how various aspects of the EMR, such as ICD-9 and family history diagnoses, and CPT lab and radiology orders, display and can be searched for within the EMR.

This is extremely helpful for new EMR users and those new to the ICD-9 and CPT coding sets, as it allows the language to be altered, from what is often obtuse, to more commonly used medical terminology, for use in how to search for and display the information.

Additionally, in this section, the user can add names and addresses of other doctors and specialists in the practice's referral network, so that the names can be added automatically to a referral note; as well as create anticipatory guidance statements that the user can then use in the EMR's SOAP note plan templates.

Here are some examples of each function to illustrate the utility of this section:

Start with ICD-9 diagnoses, for example, kidney stones. The ICD-9 terminology for kidney stones is “Calculus of kidney.” This terminology makes it difficult to search for kidney stones, to complete a SOAP note or fill out a superbill. The search would not find the term because it did not use the ICD-9 terminology, “Calculus of kidney.”

The EMR system allows the user to override the coding terminology, and to change the terminology to terms the user is more comfortable with, such as “kidney stones.” The program also allows the user to add search terms, so that he can find a diagnosis by entering various phrases, and even abbreviations.

Use Code Settings to customize how we can display and search for a Kidney Stones diagnosis. Click Code Settings, and then ICD-9 Problems. Now, in the Diagnosis Codes Search field, enter “calculus of kidney.” Displayed here is the ICD-9 code 592.0, and the official ICD-9 terminology. The user can change how this diagnosis displays throughout the EMR by entering new text here, in Override (Display) Description. In this example, enter “Kidney Stones.” The user can then create search terms that might help him find the diagnosis more easily. For example, enter in Search Words, Kidney, Stones, Nephrolithiasis. Note that each term here is set off by a comma. And finally, the user also has the option to add common terminology that might be used as a comment to attach to a diagnosis. For kidney stones, terms such as, Chronic, Right, Left, and Bilateral might be used. The user also has the option to alter the color of the diagnosis display, and to indicate whether the diagnosis will default as an acute or chronic problem. When, click Apply, and then Done.

Let's see how Kidney Stones now appears. In Problems, search “kidney stones,” and the diagnosis appears. There can be a little box to the side, which denotes that the original ICD-9 terminology was replaced, and if we hover over the box, we see the original term. Now, click here in Comments and the dictionary terms that we added are here, so that we can add text with a click.

Customizing Family History ICD-9 terms and CPT codes is exactly the same as above-described. Changing CPT code terminology is valuable because the CPT language is even more obtuse than the ICD-9 language.

Here's an example in Provider/Specialties (available under Code Settings in the Practice Manager). The user can add the names of clinicians and other practices that are in his referral networks. For example, add a gastroenterologist. First, click on Provider/Specialties. To add a new name, place the cursor in Provider Items, Search, and begin to type the name. If the system does not recognize the name, the “add new item” box will appear. Click that box and then enter the name and demographics of the practice, and select the specialty type. In this example, a new gastroenterologist is added. When done, click Apply, and then Done.

To summarize the example, now, when the user creates a referral, there is automatic access to the new doctor's information. So, go to the EMR Client, then click on Consult/Referrals, and click on New Entry, and then when searching gastroenterology as a specialty, click in the Provider field, and then whatever specialists the user entered will appear.

### Practice Notes:

In Practice Notes, the user can create and modify anticipatory guidance statements, that can be inserted into SOAP note plan templates, and then entered into SOAP notes with one click, which is quite useful.

Access the Practice Notes section merely by clicking Practice Notes under Code Settings in the Practice Manager. Listed here are all the existing Practice Notes. These are anticipatory guidance statements that physicians commonly discuss with their patients.

Let's view an example of how these are used in the EMR system. Switch over to the Client, and, in this example, the user is seeing a patient for cold and cough symptoms. The user made the diagnosis of Sinusitis, and wants to complete the SOAP note plan. Click on the plan template, and scroll down, and in these panels, are anticipatory guidance statements, arranged by category. To add them to the practice note, merely click. It can also be opened up to add a comment. This quickly documents appropriate anticipatory guidance.

Adding a new Practice Note, or anticipatory guidance statement, is done as follows. For example, add the statement, “Bring all medications to appointments.” In Search, begin to type the statement. Not recognizing this statement from the existing database, the system prompts the user to “Add New Item.” He clicks this box. He then completes the statement in the name field. Then click Apply, and it's done.

Modifying an existing Practice Note is just as easy. All the existing Practice Notes display when the user clicks on Practice Notes. To modify the statement, merely click on it, and then make the desired changes. For example, let's make a change, “Recommended—Tobacco,” could be worded better. Let's change it. Click on the statement, and then, in the Name field, alter the statement: let's change this to “Recommended—Stop tobacco.” That's a little better. Now, just Apply, and we're Done. This statement is now available to add to your plan templates.

It's also easy to attach documents to practice notes or to attach a letterhead for a more formal appearance.

### EMR Manager, Templates/Queries

### Introduction to Template and Query Building

The Template and Query Building capabilities of the EMR system are probably two of its most distinctive and powerful tools. While the system provides each practice with a complete set of templates and queries, learning how to create and modify templates allows the user to customize her practice, greatly adding to her capabilities, efficiency, and comfort with the EMR system.

The EMR system allows the user to build a variety of customizable templates, including the following:

1. Problem Review (or Past medical diagnoses)—here, the user can create lists of the most common ICD-9 coded diagnoses that she sees in her patient population.

2. Family History—like the Problems section, this gives the ability to create lists of the most common ICD-9 diagnoses, which can then be recorded as either positive or negative.

3. Health Screenings—here, the user can create templates of HEDIS recommended screenings.

4. Labs/Orders—this builds panels of your most commonly ordered lab testing. For instance, create Diabetes lab order forms, an STD panel, or a hepatitis panel. Vital signs are included in this section, as well.

5. Procedures—here, the user can create templates to record any office procedure or point-of-care testing results.

6. Allergies—here, the user can create a template to easily record the most common medication allergies that her practice encounters.

7. Immunizations—creates both pediatric and adult immunization templates across the age spectrum, making immunizations quick and easy to record.

8. Social History—here, the user can create a template to record both pediatric and adult social histories, with such items as alcohol/tobacco use, dietary history, or work history.

9. Welcome—the welcome template allows the user to combine a super template of all of the above categories, which is then quite useful when meeting a new patient.

There are also a variety of templates available for each section of the SOAP (or encounter) note, for example:

1. History/ASS/ROS (history/associated signs and system/review of systems)—this allows a practice to create complaint-specific templates for acute, review, or well visits.

2. Physical Exam—the user can create templates to record all aspects of the physical exam.

3. Assessment—here, the user can create templates of the most commonly used, complaint-related diagnoses, which can be quickly entered into the SOAP notes.

4. Plan—which allows the user to create templates of all aspects of the SOAP note plan, including orders, medications, anticipatory guidance statements, and referrals.

Another feature, in regard to the SOAP note templates, while the History/Exam/Assessment, and Plan templates can be used separately, the user can also link the Exam/Assessment, and Plan templates to the complaint-specific History templates, so that when an individual SOAP note History template is selected during a patient encounter, the other linked templates will appear automatically.

The EMR system also allows the user to create extremely powerful, but easy to use, queries and quality reminders. The ability to easily query clinical and demographic data, and to create real-time, patient-specific quality reminders, is of great benefit.

### Creating Templates in the EMR System—Introduction

In the EMR system, a data entry template includes a number of line Items grouped into a panel, or multiple panels. Typically, panels relate to a single body system, as in a review of systems or physical exam template; an aspect of the medical history, such as past medical history, or family history; or lab or procedure orders.

Individual line items are chosen from a directory of available items, and can be customized by altering the original line item text, with additional shortcut text (dictionary terms), and default “within normal limit” values.

More specifically, each template can be defined and customized at a number of different levels, for example:
1. The Template level: where the template can be named, and for Encounter Note templates, linked to other Encounter Note templates.
2. At the Panel level: where the panel can be named, and the width of the panel can be set;
3. And at the Line Item level: where an Item can be chosen from a database, or in some instances, created de novo, and optionally, its displayed terminology can be customized. And then, once a Panel Item has been added or created, the user has the option to move its position within the panel; to determine the Item's data type; to add additional free text terminology, or dictionary terms, to the Item; and to determine the items default “within normal limits” value.
4. Additionally, there are a number of possible data types for a Line Item, for example:
   1. Check: where the item value, or data, is to be checked, or not checked. This is the appropriate data type for a Problem Review, or past medical history, template.
   2. Yes/No: for noting pertinent positives and negatives. The Yes/No line item can be listed with a + and − listed in front. This is an optimal data type for a review of systems or physical exam item.
   3. Free Text: for data items, such as History of present illness content items, where free text will be added.
   4. Number: for numeric data, such as vital signs.
   5. Options List: where an item's value, or data, is one of a list of options.
   6. WNL (within normal limits)—Normal: this data type is for the “WNL” line item, which, when checked, will trigger a panel's default within normal limits values.

### EMR Manager, Creating Problem Review (or Past Medical History) Templates

To begin, access the EMR Manager from the Launch Window, by clicking Practice, and then from the Manager tool bar, clicking Templates/Queries, then Templates, and then File, and then New. This brings down the New Template menu, where the user can select the type of template that he wants to create, and then click Problem Review.

This Template properties window first appears, and here, the Template is named. For example, type “Past Medical History,” and click Accept. Within any of these panels, the user can create a list, or lists, of the most commonly encountered ICD-9 diagnoses.

Click inside the panel to begin, and there is an option to define the Template, or to Add a Panel, which can be done by clicking on Add Panel—Diagnosis Codes. From this menu, the user can define the Panel, by naming the panel, and determining the Panel's width, which can be one or more columns. This example has one column. The title given to the panel is “PMH,” and then click Accept. We can now add line items, or ICD-9 diagnoses, to the panel, by choosing diagnoses from our directory, (or database).

Click here, at the top of the panel, and from the menu, click Add Item—Diagnosis Codes.

From this window, the user can search for a diagnosis, either by entering the ICD-9 code, or text. For example, add Hypertension. Type “401.1,” the ICD-9 code, or merely type “hypertension,” and database items display. Select the appropriate diagnosis code by clicking on the desired item. For example, click on 401.1. In “Prompt As,” there is an option to customize how the text will display within the template. For example, the user wants “Hypertension” to read as “HTN.” Edit the text to “HTN,” and click Apply.

Sometimes “Apply” will close the window, other times it does not. “Done” can be used to close a window after clicking “apply”.

The user then has the option to edit the item. Click the target, and the menu that displays gives the option to move the item, remove the item, or to edit the item.

The appropriate Data Type for past medical history is Check. Click on Data Type to display the available Data Types, and click on Check. There is then the option to add comment dictionary terms, that will display as optional comment shortcuts any time we use this diagnosis.

For hypertension, some practitioners like to add the comment, “Refractory,” for especially difficult cases. So, type “Refractory” in Comment Dictionary. Additional dictionary comments could be added one per line.

As an example, add two more diagnoses to the template in the same fashion. Add Type 2 Diabetes and Hyperlipidemia.

To add another item to the panel, click at the top of the panel, and click Add Item. In Code/Description, type Diabetes, and select 250.00. Then, customize how the text of this diagnosis will display, to Type 2 DM, and click Accept. Then, change the data type to Check, and add the dictionary comments, “Diet Controlled,” and “Insulin Requiring.” Then, click Apply, and then Done.

To Edit the template that was just created, again access the Practice Manager. Click Practice from the launch window. Then click Template/Queries, and then click Templates, then File, and from this menu, click Open. The template is then displayed within the Problem Review template list. The new template displays as “PMH.” Click, and then edit what was created, or continue to add items.

This process can be used to CREATE TEMPLATES FOR various issues USING THE EXACT SAME TECHNIQUE, but different DATA TYPEs.

### EMR Manager, Creating Family History Templates

To begin, access the EMR Manager from the Launch Window, by clicking Practice, and then from the Manager tool bar, clicking Templates/Queries, then Templates, and then File, and then New. This brings down the New Template menu, where the user can select the type of template to create, and then click Family History.

This Template properties window first appears, and here, name the Template. For example, type “Family History” and click Accept. Within any of these panels, the user can create a list, or lists, of the most commonly encountered Family History diagnoses. The directory, or database of diagnoses, is the ICD-9 diagnosis code set, just as in the Problem Review template.

Click inside the panel to begin, and there is an option to define the Template, or to Add a Panel, which is done by clicking on Add Panel—Family History Codes. From this menu, the user can define the Panel, by naming the panel, and determining the Panel's width, which can be 1 or more columns, e.g., 3. This example has 1 column. Title this panel, “Family History,” and then click Accept. The user can now add line items, or ICD-9 diagnoses, to the panel, by choosing diagnoses from the directory, (or database).

Click at the top of the panel, and from the menu, click Add Item—Family History Codes.

From this window, the user can search for a diagnosis, either by entering the ICD-9 code, or text. As an example, add an entry for a family history of diabetes. The user can type “250.00,” the ICD-9 code, or merely type “diabetes,” and database items display below. Select the appropriate diagnosis code by clicking on the desired item, e.g., click on 250.00. In “Prompt As,” there is an option to customize how the text will display within the template. For example, choose this text to read as “Diabetes Type 2.” Edit the text to, “Diabetes Type 2,” and click Apply.

The user then has the option to edit the item. Click the target, and the menu that displays gives the option to move the item, remove the item, or to edit the item. As an example, choose to edit the item by clicking edit.

The appropriate Data Type for past medical history is Yes/No, in order to indicate a positive or negative family history of the disease. Click on Data Type to display the available Data Types, and click on Yes/No.

The user then has the option to indicate the “normal,” or default value. In this example, it is set to negative.

And then there is an option to add comment dictionary terms, that will display as optional comment shortcuts any time this family history diagnosis is used. For family history, it helps to indicate the affected family member, so add the dictionary terms, “Father, Mother, Brother, Sister.” Dictionary comments can be entered one per line.

As an example, add one more diagnosis to the template in the same fashion. Add a family history of Depression.

To add another item to the panel, click at the top of the panel, and click Add Item—Family History Codes. In Code/Description, type Depression, and select 311. The user can customize how the text of this diagnosis will display, to “Depression,” and click Accept.

As an example, the user can edit this Item. Change the data type to Yes/No, and again set the Normal value as negative, and add the dictionary comments, “Father, Mother, Brother, Sister.” When finished with this template, click Apply, and then Done.

To Edit the template just created, again access the Practice Manager. Click Practice from the launch window. Then click Template/Queries, and then click Templates, then File, and from this menu, click Open. The template is displayed within the Family History template list. The user can click on the template to edit what has been created, or continue to add items.

### Procedure Templates

Procedure templates can help record any office-based medical procedure or point of care testing, and therefore, can be quite useful.

Exemplary templates record skin procedures, EKGs, audiometry, urinalysis, wet preps, and quick strep, flu, and pregnancy testing.

In the EMR system, Procedure Templates can be entirely custom-built with no original database of items. The user can create each item from scratch. Once an item is added for the first time, it is available to use again.

Once added, each data item can be further customized, as in other types of EMR system templates, by adjusting the data type, giving the item a “within normal limits” value, and by creating a comment dictionary (or shortcut data entry text).

To demonstrate how this functions, create a short Procedure Template for office vision screening. The line items will be right eye, left eye, and the comment dictionary will be the numeric results.

Of course, to enter the EMR Manager, go to the Launch Window, and click Practice. Then click

Templates/Queries, and then click Templates. Then click File, New, and Procedures.

This Template properties window first appears, and here, name the Template. For example, type “Vision Screening” and click Accept.

Then, click inside the panel to begin, and have the option to define the Template (which can be done by naming it), or to Add a Panel, by clicking on Add Panel—Custom. From this menu, the user can define the Panel, by naming the panel, and determining the Panel's width, which can be 1 or more columns, such as 2 or 3. This example has 1. Title this panel, “Vision Screening,” and then click Accept. Now add custom line items, or add items from any previously created procedure templates.

Click on Vision Screening, and from this menu, click Add Items—Custom Codes. Within Code/Desc, the user can type a custom line item, “Right Eye.” The previously created custom line items begin to display, but as the system recognizes that this is a new item, an “add new item” button appears, which is clicked. In “Prompt As,” type how we want our item to display within the template, which will typically be exactly the same, as in this case, so type Right Eye, and then Accept.

To Edit this item, to select a Data Type, and create a comment dictionary, click on the target, and then Edit Item. For data type, try Free Text (though Number would be appropriate, as well). And for our Comment Dictionary, remember that our results, for a Vision Screen, are numeric, and a panel of digits can be added by adding the comment, “*num”, as well as a forward slash “/” and then Accept.

The same process is used to add the item, “Left Eye.”

Click on Vision Screening, and from this menu, click Add Items—Custom Codes. Within Code/Desc, type the custom line item, “Left Eye,” and as the system recognizes that this is a new item, this “add new item” button appears, which we click. In “Prompt As,” type “Left Eye,” and then Accept.

To Edit this item, just as we did for the right eye item, click on the target, and then Edit Item. For data type, Free Text can be used (though Number would be appropriate, as well). And for the Comment Dictionary, remember that the results, for a Vision Screen, are numeric, and we can add a panel of digits by adding the comment, “*num”, as well as a forward slash “/”, and then Accept.

### Soap Note Templates: Subjective, or History/ASS/ROS Templates

In the EMR system, there are a number of available types of subjective templates, for example:
Acute: to record acute complaints;
Review: to record check-ups for existing diagnoses, such as hypertension, diabetes, etc; and
Well Visit: to record physicals and well child checks.

Additionally, each subjective template can be linked to existing objective, assessment, and plan templates, so that when the specific subjective template is selected in an encounter note, the linked templates will automatically display.

The EMR system allows the creation of complex queries and quality reminders based on a variety of patient data, for example:

1. Demographics

2. Allergies

3. Problems

4. Family History

5. Health Screenings

6. Immunizations

7. Labs

8. Consults and Referrals

9. Prescriptions

The software used in the inventive EMR system is designed to help a user record patient information easily and efficiently. Steps: compile past med history; dependent: receive lab, radiology and consultant and hospital data; record type patient visit/encounter, evaluating data during visits, planning future labs, prescriptions—create patient assessments and plan of care (includes prescribing med, order tests and other procedures, referrals to specialists, anticipatory guidance); discuss complaints, record phys exam, assess problems, provide plan of care; process prescriptions (refills, cancellations, new meds, discontinued med, comparing prescriptions) and immunizations; automatic quality reminders outstanding, unfulfilled quality related issues; send internal messages and date reminders (OWLS); generating written prescription—print, fax, email

Data can be encrypted when stored in local server, stays encrypted going to central server (can encrypt in transmission too from client to local server)

What is claimed:

1. An electronic medical record system and method comprising the following steps:
a. inputting patient information into an EMR system utilizing standard and/or customizable templates;
b. cross-referencing the information input in step (a) with databases of information; and
c. generating information from cross-referencing step (b) to provide a user with a recommendation for the patient.

2. The electronic medical record system and method of claim 1, further comprising repeating steps (a), (b) and (c) one or more times.

3. The electronic medical record system and method of claim 1, wherein the patient information includes past, present and family medical history and additional patient information, including social history.

4. The electronic medical record system and method of claim 1, wherein at least one template is newly created by the user.

5. The electronic medical record system and method of claim 1, wherein the recommendation is selected from one or more of the following: prescriptions, orders, referrals, and patient anticipatory guidance instructions.

6. The electronic medical record system and method of claim 1, wherein data in databases are publicly available.

7. An electronic medical record system and method comprising the following steps:
a. inputting patient information into an EMR system utilizing standard and/or customizable templates;
b. cross-referencing the information input in step (a) with databases of information;
c. generating standards of care information from cross-referencing step (b) to provide a user with a reminder of the standards of care for the patient; and
d. using the information from cross-referencing step (b) to automatically generate real-time drug-drug interactions and drug-allergy alerts based on the information in the EMR system at the time of generation.

8. The electronic medical record system and method of claim 7, wherein the patient information includes past, present and family medical history and additional patient information, including social history, and further comprising a step of highlighting patient information with a color and/or flag for ease of reference.

9. The electronic medical record system and method of claim 7, wherein at least one template is newly created by the user.

10. The electronic medical record system and method of claim 7, wherein at least one reminder is newly created by the user.

11. The electronic medical record system and method of claim 7, wherein the standards of care is selected from one or more of the following: prescriptions, orders, referrals, and patient anticipatory guidance instructions; and further comprising a step of adding comments to the patient information.

12. The electronic medical record system and method of claim 7, wherein the data in databases are publicly available; and further comprising a step of attaching patient reports to the patient information and a step of adding comments to the attachments.

13. The electronic medical record system and method of claim 7, wherein the reminder is generated in real-time so that it is based on the information in the EMR system at the time of generation.

14. An electronic medical record system and method comprising the following steps:
a. inputting patient information into an EMR system utilizing standard and customizable templates;
b. cross-referencing the information input in step (a) with databases of information; and
c. obtaining information from cross-referencing step (b) to automatically generate patient-specific reminders based on the patient information and the database information at that time.

15. An electronic medical record system and method comprising the following steps:
a. inputting patient information into an EMR system utilizing standard and/or customizable templates;
b. cross-referencing the information input in step (a) with databases of information, such databases including information on other patients; and
c. obtaining information from cross-referencing step (b) to generate aggregate patient reporting information about select groups of the patient population based on the information in the EMR system at the time of generation.

16. The electronic medical record system and method of claim 15, further comprising step (d) automatically generating aggregate patient reporting information.

17. The electronic medical record system and method of claim 16, further comprising step (e) automatically sending the information generated in step (d) to a third party recipient at a time interval designated by the user.

18. The electronic medical record system and method of claim 15, wherein the aggregate patient reporting information is used to measure performance against a set of information.

19. The electronic medical record system and method of claim 18, wherein the set of information includes publicly available data, data from physicians and/or other users of the system.

20. An electronic medical record system and method comprising the following steps:
a. inputting primary patient information into an EMR system utilizing standard and/or customizable templates;
b. inputting secondary patient information into an EMR system utilizing standard and/or customizable templates, said secondary patient information being at least initially medically unrelated to said primary information, said secondary information appearing on the same screen as said primary information to permit comparison and ease of reference of said primary and secondary information;
c. cross-referencing the information input in step (a) with databases of information; and
d. generating information from cross-referencing step (b) to provide a reminder for the user of the recommended standards of care for the patient.

21. The electronic medical record system and method of claim 20, wherein any objective information on the template having the primary information is automatically populated in the template having the secondary information.

22. An electronic medical record system and method comprising the following steps:
a. inputting patient information into an EMR system utilizing standard and/or customizable templates;
b. cross-referencing the information input in step (a) with databases of information;
c. obtaining information from cross-referencing step (b);
d. searching the information obtained in step (c) based on clinical or demographic data to generate, respectively, clinical or demographic information; and
e. providing a user with the search results from step (d) to remind the user of the recommended standards of care for the patient.

23. The electronic medical record system and method of claim 22, wherein the inputting of additional patient information operates to update the search results from step (d) in real-time based on the information in the EMR system at the time of updating.

24. An electronic medical record system and method comprising the following steps:
a. inputting patient information into an EMR system utilizing standard and/or customizable templates;
b. cross-referencing the information input in step (a) with databases of information;
c. generating information from cross-referencing step (b) to provide a reminder for the user of the recommended standards of care for the patient; and
d. creating a reminder by the user to be sent to the user or another at a future date.

25. The electronic medical record system and method of claim 24, wherein the reminder is for the user to administer the standards of care to the patient.

26. An electronic medical record system and method comprising the following steps:
a. inputting patient information into an EMR system utilizing standard and/or customizable templates;
b. cross-referencing the information input in step (a) with databases of information;
c. generating information from cross-referencing step (b) to provide a reminder for the user of the recommended standards of care for the patient; and
d. automatically creating a reminder to be sent to the user or another at a future date.

27. An electronic medical record system and method comprising at least one computer, the computer having a display and access to software for an EMR system for entering and using patient information, the computer being capable of obtaining information from at least one database to cross-reference with patient information to compare with the information on the at least one database and to generate a display including a simultaneous view of at least one screen from each of groups A, B, C, D and E, group A including the following different screens: problems, family history, immunizations, social history, and health screenings, group B including the following different screens: labs, hospitalizations/surgeries, consultations and referrals, group C including the following different screens: prescriptions and allergies, group D including the following different screens: notes/documents and reminders, and group E including the following screen: list of encounters/visits.

28. The electronic medical record system and method of claim 27, further comprising at least one server, the at least one server being physically or wireless ly connected to the computer to enable communication between the computer and the server.

29. The electronic medical record system and method of claim 28, wherein the computer communicates information to the server for safe keeping and the server keeps the information encrypted.

30. The electronic medical record system and method of claim 27, wherein data are entered by one or more of keyboard, hand writing, finger, stylus and voice recognition.

31. An electronic medical record system and method comprises the following steps:
a. inputting patient information into an EMR system utilizing standard and/or customizable templates;
b. cross-referencing the information input in step (a) with databases of information;
c. generating information from cross-referencing step (b) to provide a reminder for the user of the recommended standards of care for the patient; and
d. creating a new customizable template having the following steps:
i. setting template properties including providing a name for the template and linking the template with other templates;
ii. defining a template panel by providing a name for the template panel and a number of columns for the template; and
iii. defining fields or line items in the template by adding, modifying or deleting items; defining the type of data in the fields or items, and adding dictionary terms to select for one or more items.

32. The electronic medical record system and method of claim 31, wherein the field or line item added is searchable.
